(19) United States
(12) Patent Application Publication
(10) Pub. No.: US 2025/0243098 A1
(43) Pub. Date: Jul. 31, 2025

(54) COMPACT SYSTEM AND METHOD FOR TREATING URINE AND OTHER WASTEWATER

(71) Applicants: UNIVERSITY OF SOUTH FLORIDA, Tampa, FL (US); UNITED STATES OF AMERICA AS REPRESENTED BY THE ADMINISTRATOR OF NASA, Washington, DC (US)

(72) Inventors: Daniel YEH, Tampa, FL (US); Talon BULLARD, Tampa, FL (US); Luke ROBERSON, Tampa, FL (US); Daniella SAETTA, Tampa, FL (US); Alexandra SMITH, Tampa, FL (US); Jason A. Fischer, Tampa, FL (US)

(21) Appl. No.: 19/090,336

(22) Filed: Mar. 25, 2025

Related U.S. Application Data
(63) Continuation-in-part of application No. PCT/US2024/037087, filed on Jul. 8, 2024.
(60) Provisional application No. 63/212,084, filed on Jun. 17, 2021.

(51) Int. Cl. C02F 9/20; C02F 1/44; C02F 1/66; C02F 3/30; C02F 3/34; C02F 101/30; C02F 103/00

(52) U.S. Cl. CPC C02F 9/20; C02F 1/444; C02F 1/66; C02F 3/301; C02F 3/302; C02F 3/342; C02F 2101/301; C02F 2103/005; C02F 2301/046

(57) ABSTRACT

Systems and methods are disclosed for the treatment and recovery of resources in waste, such as water and nitrogen. The system includes a bioreactor and a membrane filter. The bioreactor is configured to receive a waste stream and includes at least one anoxic treatment zone and at least one oxic treatment zone. The membrane filter is fluidly coupled to the bioreactor and is downstream of the at least one anoxic treatment zone and the at least one oxic treatment zone.

### CROSS-REFERENCE TO RELATED APPLICATIONS

This application is a continuation-in-part of PCT International Application No. PCT/US2024/037087, filed Jul. 8, 2024, which claims priority to U.S. Provisional Patent Application No. 63/512,084, filed Jul. 6, 2023; and claims priority to U.S. Provisional Patent Application No. 63/569,246, filed Mar. 25, 2024, the contents of all of which are incorporated herein by reference in their entireties.

### STATEMENT REGARDING FEDERALLY SPONSORED RESEARCH

This invention was made with government support under 80NSSC18K1692 awarded by the National Aeronautics and Space Administration (NASA). The Government has certain rights in the invention.

### FIELD OF THE INVENTION

The disclosed technology is generally directed to biological treatment of wastewater. More particularly, the technology is directed to regenerative biological treatment of urine and other wastewater using membranes.

### BACKGROUND

With little to no resources readily available to support human life outside of Earth, planetary bases in environments such as, for example, space, the Moon, and Mars must be robust, independent, and provide all the basic requirements to support life that are naturally granted on Earth. In the case of a thirty-month mission, a single Crew Member will require 2250 kg of drinking water, 6525 kg of hygiene water (oral, handwash, shower, shave, etc.), and produce over 2000 kg of metabolic waste. The resulting cost of just water for a single astronaut is an incredible amount. Additionally, existing Environmental Control and Life Support Systems (ECLSS) technologies used in space are generally not optimized for Early Planetary Base (EPB) scenarios.

Looking to one consideration, urine is notoriously difficult to treat, primarily due to its high nutrient and ion content. For example, in municipal wastewater, urine accounts for 80% of nitrogen while constituting only a small fraction of the total volume. While the formulations and compositions of EPB waste streams (e.g., humidity, hygiene, urine/flush, and laundry) are still under investigation, it is estimated that urine will account for approximately 97% of the nitrogen in such waste streams.

Some existing treatment systems only extract water from urine, utilize multiple consumable inputs, and need improved efficiency to reach a future water recovery goal of 98%. Consequently, such systems are highly dependent on a harsh chemical pretreatment method that must be constantly resupplied in order to recover water from the urine. These current challenges highlight the need for the development of alternative treatment technologies which can operate with minimum external inputs.

Waste treatment technologies can be broadly categorized into physical, chemical, and biological. In space, treatment technologies have been strictly physical-chemical as they provide rapid and consistent treatment. For example, in some current systems, urine is pretreated with hexavalent chromium and phosphoric acid to prevent the precipitation of uric acid and inhibit biological growth before Vapor Compression Distillation (VCD) is used to separate the water from a brine solution. VCD can recover approximately 85% of the water from urine. Additionally, a Brine Processor Assembly (BPA) can recover 85% to >90% water from urine by treating concentrated brine utilizing forced convection from ambient air coupled with membrane distillation to separate water from brine as vapor. This water is recovered from the existing condensate system while the concentrated brine is stored for disposal.

However, these existing systems are still being investigated for improved recovery, broader treatment capabilities, reduced odor, and reduced consumable inputs to achieve a near closed-loop architecture. For example, the hazardous pretreatment chemical for urine creates safety concerns and prevents any possibility of recovery of additional resources. Further, constant use of consumable inputs (i.e., chemical pretreatment, disposable filters, etc.) take up valuable cargo space, require expensive resupply missions, and create waste that requires disposal. Furthermore, to date, no flight-ready biological system has been developed.

The goals for waste treatment technologies include 98% water recovery and the capability of treating all forms of waste for recovery in sustainable approaches. Furthermore, while recovery of water and nutrients as a potential fertilizer are considerable, treatment systems should be able to handle scaling, corrosion, fouling, eutrophication, and inhibition caused by urine. Alternative treatment technologies need to be explored to reduce consumable inputs, expand resource recovery beyond water, and maintain efficiency and reliability.

### SUMMARY

In one aspect, the present disclosure provides a system including a bioreactor and a membrane filter. The bioreactor is configured to receive a waste stream and includes at least one anoxic treatment zone and at least one oxic treatment zone. The membrane filter is fluidly coupled to the bioreactor and is downstream of the at least one anoxic treatment zone and the at least one oxic treatment zone. In some embodiments, the system further comprises a carbonation unit fluidly coupled to the bioreactor upstream of the at least one anoxic treatment zone and the at least one oxic treatment zone, The carbonation unit can comprise a source of CO₂ and a column where a stream of CO₂ from the source of CO₂ mixes with the waste stream before the waste stream enters the bioreactor. In some embodiments, the system further comprises a treatment unit coupled to the bioreactor upstream of the at least one anoxic treatment zone and the at least one oxic treatment zone. The treatment unit can comprise a filtration unit, a sonication unit, or a combination thereof.

In another aspect, the present disclosure provides a method of waste processing. The method includes flowing a waste stream through a bioreactor comprising at least one anoxic treatment zone and at least one oxic treatment zone. The at least one anoxic treatment zone and the at least one oxic treatment zone comprise microorganisms. The method also includes flowing the waste stream from an outlet of the bioreactor through a membrane filter. The waste stream can comprise a first waste stream and a second waste stream. In some embodiments, the method further comprises pretreating the first waste stream by carbonation before the first waste stream enters the bioreactor, wherein the first waste stream is carbonated by mixing with CO₂. In some embodiments, the method further comprises conditioning the second waste stream by flowing the waste stream through a treatment unit before the second waste stream enters the bioreactor. The treatment unit can comprise a filtration unit, a sonication unit, or a combination thereof. In some embodiments, the first waste stream comprises urine and the second waste stream comprises a surfactant. In some embodiments, the filtration unit of the treatment unit removes more than 20% of a surfactant in the second waste stream.

In yet another aspect, the present disclosure provides a method of waste processing, which includes: flowing a waste stream through a carbonation unit that mixes the waste stream with carbon dioxide; flowing the waste stream from the carbonation unit through a first anoxic treatment zone in a bioreactor; flowing the waste stream from the first anoxic treatment zone through an oxic treatment zone in the bioreactor; flowing the waste stream from the oxic treatment zone through a second anoxic treatment zone in the bioreactor; and flowing the waste stream from the second anoxic treatment zone through a membrane filter. In some embodiments, the waste stream comprises urine.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates a schematic view of an example bioregenerative system, according to some embodiments.

FIG. 2A illustrates a schematic view of an example of a side stream membrane bioreactor configuration.

FIG. 2B illustrates a schematic view of an example immersed membrane bioreactor configuration.

FIG. 3 illustrates a perspective view of an example bioregenerative system assembled on a racking system, according to some embodiments.

FIG. 4A illustrates a schematic view of another example bioregenerative system, according to some embodiments.

FIG. 4B illustrates a schematic view of another example bioregenerative system, according to some embodiments.

FIG. 5A illustrates a schematic view of an example system, according to some embodiments, comprising a bioregenerative system and a carbonation unit.

FIG. 5B illustrates a schematic view of an example system, according to some embodiments, comprising a bioregenerative system and a carbonation unit.

FIG. 6 illustrates a schematic view of another example system, according to some embodiments, comprising a bioregenerative system, a treatment unit, and a carbonation unit.

FIG. 7 illustrates an example process for treating wastewater including urine, according to some embodiments.

FIG. 8 illustrates a plot showing experimental data of pH of a carbonated urine solution over time.

FIG. 9 illustrates a plot showing experimental data of a chemical oxygen demand profile of a bioregenerative system over time.

FIG. 10 illustrates a plot showing experimental data of a total nitrogen profile of a bioregenerative system over time.

FIG. 11 illustrates a plot showing experimental data of an ammonia profile of a bioregenerative system over time.

FIG. 12 illustrates a plot showing experimental data of a nitrate profile of a bioregenerative system over time.

FIG. 13 illustrates a plot showing experimental data of a turbidity profile of a bioregenerative system over time.

FIG. 14 illustrates a plot showing experimental data of a dissolved oxygen profile of a bioregenerative system over time.

FIG. 15 illustrates a plot showing experimental data of a pH profile of a bioregenerative system over time.

FIG. 16 illustrates a plot showing experimental data of a chemical oxygen demand and nitrogen removal profile of a bioregenerative system over time.

FIG. 17 illustrates a diagram of a benchtop urine carbonation setup, according to an aspect of the disclosure herein.

FIG. 18 illustrates a plot showing experimental data of a benchtop urine carbonation pH profile.

FIG. 19 illustrates a plot showing experimental data of a benchtop urine carbonation detailed pH profile at 1 LPM.

FIG. 20A illustrates a plot showing experimental data of a benchtop urine carbonation chemical oxygen demand (COD) profile.

FIG. 20B illustrates a plot showing experimental data of a benchtop urine carbonation ammonia nitrogen (AN) profile.

FIG. 21 illustrates a plot showing experimental data of a benchtop urine carbonation alkalinity profile.

FIG. 22 shows photographs of (a) an assembled carbonation module, and (b) a close up of fine diffusion stone for carbon dioxide delivery, according to an aspect of the disclosure.

FIG. 23 shows a photograph of an experimental setup for surfactant foaming rate, according to an aspect of the disclosure.

FIG. 24 illustrates a plot showing a linear calibration graph of experimental data and trendline between surfactant concentration and foaming rate.

FIG. 25 illustrates a plot showing a linear calibration graph of experimental data and trendline between surfactant concentration and COD.

FIG. 26 illustrates a diagram of a typical ultrasonic bath system.

FIG. 27 illustrates a diagram comparison of surfactant monomer and surfactant micelles with respect to the surfactant concentration and critical micelle concentration (CMC). (Lin, 2009)

FIG. 28 illustrates a scheme for the ultrasonic inactivation of a surfactant monomer.

FIG. 29 illustrates a plot showing experimental data of a COD profile during ultrasonication of ISS No-Rinse, surfactant formulation.

FIG. 30 illustrates a plot showing experimental data of a surfactant profile estimated from COD during ultrasonication of ISS No-Rinse.

FIG. 31 illustrates a plot showing experimental data of a foaming rate profile during ultrasonication of ISS No-Rinse.

FIG. 32A illustrates a plot showing experimental data of a surfactant profile estimated from foaming rate during ultrasonication of ISS No-Rinse.

FIG. 32B illustrates a plot showing experimental data of a pH profile during ultrasonication of ISS No-Rinse.

FIG. 32C illustrates a plot showing experimental data of a temperature profile during ultrasonication of ISS No-Rinse.

FIG. 33 illustrates a diagram of membrane filtration types and particle size rejection range.

FIG. 34 illustrates a diagram of batch filtration testing, according to an aspect of the disclosure. V=voltage measured by pressure transducer; Q=flow rate (L/d)

FIG. 35 illustrates a plot showing estimated surfactant concentration in permeate and concentrate at various concentration factors.

FIG. 36 illustrates a photograph of an ultrafiltration (UF) membrane setup for batch testing, according to an aspect of the disclosure.

FIG. 37 illustrates a plot showing experimental data of an ultrafiltration COD and rejection profile. (CF=concentration factor).

FIG. 38 illustrates a plot showing experimental data of an ultrafiltration surfactant (from COD calibration) and rejection profile.

FIG. 39 illustrates a plot showing experimental data of an ultrafiltration surfactant foaming profile.

FIG. 40 illustrates a plot showing experimental data of an ultrafiltration surfactant (from foaming calibration) and rejection profile.

FIG. 41 illustrates a plot showing experimental data of an ultrafiltration pH profile.

FIG. 42 illustrates a plot showing experimental data of an ultrafiltration transmembrane pressure (TMP) profile.

FIG. 43 illustrates (a) a diagram of a nanofiltration (NF) setup, according to an aspect of the disclosure, V=voltage measured by pressure transducer; Q=flow rate (L/d); and (b) a photograph of an exemplary NF setup.

FIG. 44 illustrates a plot showing experimental data of a nanofiltration COD and rejection profile.

FIG. 45 illustrates a plot showing experimental data of a nanofiltration surfactant (from COD calibration) and rejection profile.

FIG. 46 illustrates a plot showing experimental data of a nanofiltration surfactant foaming profile.

FIG. 47 illustrates a plot showing experimental data of a nanofiltration surfactant (from foaming calibration) and rejection profile.

FIG. 48 illustrates a plot showing experimental data of a nanofiltration pH profile.

FIG. 49 illustrates a plot showing experimental data of a nanofiltration TMP profile.

FIG. 50 illustrates an example of an EXPRESS rack (a) occupied with quad lockers and empty drawers at the bottom (b) occupied with WRS components and empty drawers at the bottom. (Carter et al., 2018; Roy, 2001)

FIG. 51 illustrates two views of a baffled bioreactor design, according to an aspect of the disclosure. The arrows depict direction of bulk liquid flow. (a) (plan view) shows the direction of liquid flow from left to right through the near compartments, then right to left through the far compartments. (b) (elevation view) The liquid follows a flow pattern that is successively upward, downward, upward, and so on through the baffles.

FIG. 52 illustrates diagrams for membrane maintenance operations (a) relaxation (b) backwash.

FIG. 53 illustrates photographs of an assembled SAMBR system, according to an aspect of the disclosure.

FIG. 54 illustrates a plot showing experimental data of a COD profile of a bioregenerative system over time at (a) stages A-1 to C (b) stages D to F of testing (c) stages G to H-1. In=influent, Pr-Ax=pre-anoxic zone, Ox=oxic zone, Po-Ax=post-anoxic zone, Perm=permeate.

FIG. 55 illustrates a plot showing experimental data of a TN profile of a bioregenerative system over time at (a) stages A-1 to C (b) stages D to F of testing (c) stages G to H-1. In=influent, Pr-Ax=preanoxic zone, Ox=oxic zone, Po-Ax=post-anoxic zone, Perm=permeate.

FIG. 56 illustrates a plot showing experimental data of an AN profile of a bioregenerative system over time at (a) stages A-1 to C (b) stages D to F of testing (c) stages G to H-1. In=influent, Pr-Ax=preanoxic zone, Ox=oxic zone, Po-Ax=post-anoxic zone, Perm=permeate.

FIG. 57 illustrates a plot showing experimental data of a NN profile of a bioregenerative system over time at (a) stages A-1 to C (b) stages D to F of testing (c) stages G to H-1. In=influent, Pr-Ax=preanoxic zone, Ox=oxic zone, Po-Ax=post-anoxic zone, Perm=permeate.

FIG. 58 illustrates a plot showing experimental data of a pH profile of a bioregenerative system over time at (a) stages A-1 to C (b) stages D to F of testing (c) stages G to H-1. In=influent, Pr-Ax=preanoxic zone, Ox=oxic zone, Po-Ax=post-anoxic zone, Perm=permeate.

FIG. 59 illustrates a plot showing experimental data of a dissolved oxygen (DO) profile of a bioregenerative system over time at (a) stages A-1 to C (b) stages D to F of testing (c) stages G to H-1. In=influent, Pr-Ax=preanoxic zone, Ox=oxic zone, Po-Ax=post-anoxic zone, Perm=permeate.

FIG. 60 illustrates a plot showing experimental data of an ORP profile of a bioregenerative system over time at (a) stages A-1 to C (b) stages D to F of testing (c) stages G to H-1. In-influent, Pr-Ax=preanoxic zone, Ox=oxic zone, Po-Ax=post-anoxic zone, Perm=permeate.

FIG. 61 illustrates a plot showing experimental data of a turbidity profile of a bioregenerative system over time at (a) stages A-1 to C (b) stages D to F of testing (c) stages G to H-1. In-influent, Pr-Ax=preanoxic zone, Ox=oxic zone, Po-Ax=post-anoxic zone, Perm=permeate.

FIG. 62 illustrates a plot showing experimental data of a EC profile of a bioregenerative system over time during stages G to H-2. In=influent, Pr-Ax=preanoxic zone, Ox=oxic zone, Po-Ax=post-anoxic zone, Perm=permeate.

FIG. 63 illustrates a plot showing experimental data of a transmembrane pressure profile of a bioregenerative system over time. In=influent, Pr-Ax=preanoxic zone, Ox=oxic zone, Po-Ax=post-anoxic zone, Perm=permeate.

### DETAILED DESCRIPTION

Due to its concentrated and variable profile, the treatment of urine presents a unique set of challenges and rewards. For example, a plethora of components including ions and nutrients found in urine contribute to its dynamic profile, such as urea, phosphate, potassium, sulfate, calcium, magnesium, as well as biological constituents. As such, urine can cause issues in all sorts of systems.

The extreme concentrations of total nitrogen (TN), chemical oxygen demand (COD), alkalinity, electrical conductivity, and pH in source separated urine compared to what municipal water treatment technologies on Earth are designed to treat make such technologies impractical for urine treatment. In physical and chemical treatment systems, precipitation and scaling can cause blockages and fouling. In biological systems, the high nitrogen content often results in inhibition of treatment. For example, the high level of nutrients (e.g., nitrogen (N), phosphorous (P), and potassium (K)) can cause eutrophication in biological systems and fouling in membrane filtration systems. Additionally, the highly basic pH (>9) of hydrolyzed urine presents challenges for biological treatment systems, which typically prefer a neutral pH.

In light of the above, some embodiments provide a bioregenerative system for the treatment and recovery of resources in urine, such as water and nitrogen. The bioregenerative system can be a hybrid system that uses carbonation, biological processing, and membrane filtration to treat waste and separate valuable components, e.g., capable of nitrogen conversion and removal for water purification and resource recovery. To reduce mass and volume constraints, this technology can be designed with a small footprint. Thus, the technology disclosed herein addresses the challenges of reducing the size, scale, and consumable inputs, and is a progressive step towards a sustainable architecture to achieve a near closed-loop architecture. These systems can be used for water treatment in space exploration as well as urban and rural settings.

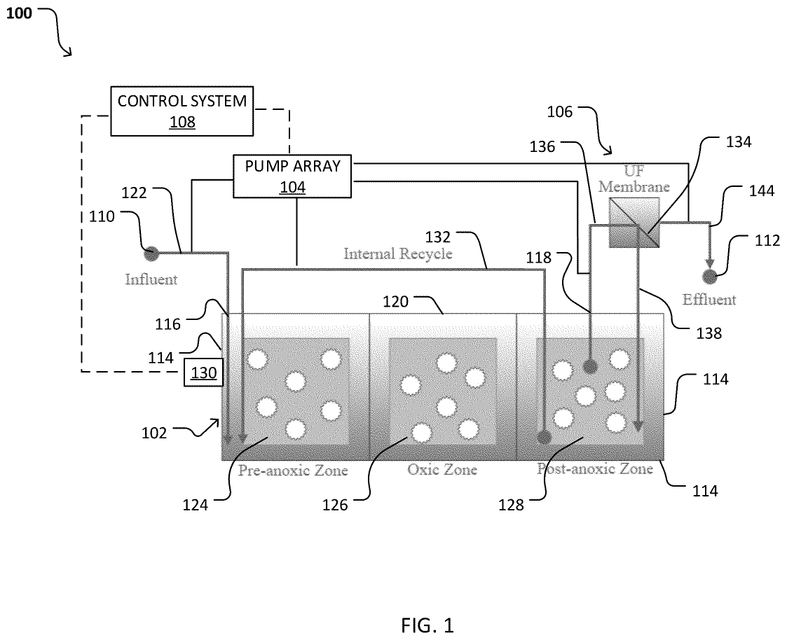

Accordingly, FIG. 1 illustrates a bioregenerative system 100 according to some embodiments. As shown in FIG. 1, the bioregenerative system 100 can include a bioreactor 102, a pump array 104, a membrane filter unit 106, and a control system 108. In some applications, the bioregenerative system 100 can be considered a Suspended Aerobic Membrane Bioreactor (SAMBR). The bioregenerative system 100 further includes a system inlet 110 that allows the introduction of fluids or influent, such as wastewater, urine, and/or fluids from other waste streams such as humidity/condensation, hygiene, urine/flush, and laundry, and a system outlet 112 that releases water or effluent from the bioregenerative system 100. Generally, influent is pumped, via the pump array 104, in through the inlet 110 into the bioreactor 102, where it is treated, then into the membrane filter 106 for filtration, and resulting effluent exits the system 100 through the system outlet 112. The influent can include multiple waste streams from different sources (e.g., a urine/flush waste stream, a hand wash/shower/hygiene stream, a laundry stream). Some waste streams may contain surfactants from soaps or detergents while other waste streams may contain little or no surfactant. A waste stream that is substantially free of surfactant has less than 20 mg/L of surfactant. Various components within the system 100 can be monitored and/or controlled via the control system 108.

Referring specifically to the bioreactor 102, according to some aspects, the bioreactor 102 can include a plurality of walls 114, an inlet 116, an outlet 118, and a cover 120. The walls 114 can include five walls, such as four sidewalls and a floor (though only three walls 114 are shown in FIG. 1), suitably configured to house microorganisms (e.g., autotrophs and heterotrophs) selected for biological processing. Each of the inlet 116 and the outlet 118 can be located within a respective wall 114 or the cover 120. In some implementations, the inlet 116 can be coupled to the inlet 110 of the bioregenerative system 100 via an influent line 122. In other implementations, the inlet 116 of the bioreactor 102 can be the same as the inlet 110 of the bioregenerative system 100. Additionally, the cover 120 can extend over an opening formed by the four sidewalls 114 and can allow gaseous byproducts such as O₂, N₂, and/or CO₂ to escape (e.g., through openings) or to otherwise be directed away from the bioreactor 102 (e.g., through one or more valve-controlled openings).

As used herein, biological processing within the bioreactor 102 can include biological nutrient removal (BNR), which, generally, is the conversion of nitrogen within the nitrogen cycle by microorganisms and/or enzymes. With select microorganisms and environmental conditions, nitrogen can be converted to various forms to achieve a desired form, typically dinitrogen, which can be off gassed into the atmosphere. For example, in the nitrogen cycle, (1) dinitrogen gas is fixed as ammonium, commonly referred to as nitrogen fixation; (2) ammonium is oxidized by microorganisms; (3) nitrite is oxidized to nitrate; (4) nitrate is denitrified to dinitrogen gas; (5) anaerobic ammonium oxidation (anammox) converts ammonia directly to dinitrogen; and (6) nitrate/nitrite is reduced to ammonium. These conversions can be achieved by enzymes such as nitrate reductase, nitrite reductase, nitric oxide reductase, nitrous oxide reductase. These enzymes can be expressed by bacteria within the bioreactor, e.g., nitrite oxidizing bacteria (NOB) and ammonia oxidizing bacteria (AOB). Additionally, or alternatively, isolated enzymes can be added to the bioreactor. For example, in some instances, these microorganisms can be obtained from a municipal wastewater treatment plant and used to inoculate the bioreactor 102. That is, in some applications, activated sludge can be collected from a municipal wastewater treatment plant and be used to inoculate the bioreactor 102. Additionally, or alternatively, the bioreactor 102 can be configured to maintain an enzymatic solution for biological processing.

In some embodiments, the bioreactor 102 can include at least one anoxic treatment zone and at least one oxic treatment zone, where the anoxic treatment zone and the oxic treatment zone are in separate compartments. For example, AOB nitrify ammonium into nitrate under oxic conditions in the oxic treatment zone, and an anoxic treatment zone, containing NOB, denitrify the nitrate into diatomic nitrogen that then off-gasses into the atmosphere. By adjusting the active oxic and anoxic treatment zones, a blend of nitrogen conversion and removal can be tailored to suit the application. Furthermore, in some embodiments, the bioreactor 102 can include a first anoxic treatment zone, an oxic treatment zone, and a second anoxic treatment zone, where the three zones are in separate compartments. The treatment process through the three compartments can be designed as a median of a Modified-Ludzack Ettinger (MLE) process and a 4-stage Bardenpho process, as further described below.

Accordingly, in the example shown in FIG. 1, the bioreactor 102 can include three compartments 124, 126, 128, where each of the compartments 124, 126, 128 can be configured to maintain treatment zone conditions that promote the conversion of waste products and recovery of nutrients. For example, the oxidation reduction potential (ORP) can be regulated in each compartment. Additionally, the dissolved oxygen (DO) can be maintained within a specific range. For example, one or more sensors 130 in communication with the control system 108, such as an oxygen sensor, can be used to measure the dissolved oxygen. If the oxygen level is too low for aerobic conditions, e.g., according to a preset value, the control system 108 can signal a gas valve to open to allow oxygen to flow to the compartment in need of oxygen. Additional sensors 130 (e.g., pH, turbidity, conductivity, oxygen reduction potential, liquid level, overflow, etc.) can be included in the bioreactor 102 in contact with the waste fluid and in communication with the control system 108.

Referring still to FIG. 1, in some embodiments, the first compartment 124 of the bioreactor 102 can be a first anoxic compartment (e.g., a pre-anoxic zone); the second compartment 126 can be an oxic compartment (e.g., an oxic zone); and the third compartment 128 can be a second anoxic compartment (e.g., a post-anoxic zone). Table 1 below summarizes the characteristics and functions of each compartment 124, 126, 128.

TABLE 1
Characteristics of each compartment in the bioreactor 102

| | Pre-Anoxic Zone | Oxic Zone | Post-Anoxic Zone |
|---|---|---|---|
| Zone | 124 | 126 | 128 |
| Condition | Anoxic | Aerobic | Anoxic |
| Ant. ORP range (mV) | −50 to +50 mV | +100 to +350 mV | −50 to +50 mV |
| Ant. DO range (mg/L) | 0-1 | 1-15 | 0-1 |
| Fate of Nitrogen | Reduction via | Oxidation via | Reduction via |
| | denitrification and | nitrification and | denitrification and |
| | assimilation | assimilation | assimilation |
| Fate of Carbon | Chemical Oxygen Demand (COD) oxidation and assimilation | | |
| Gaseous output | N₂ and CO₂ | CO₂ | N₂ and CO₂ |
| Primary function | Denitrification and | Nitrification | Denitrification (polishing) |
| | COD removal | | and |
| | | | COD removal (polishing) |
| Organisms | Heterotrophs | Autotrophs | Heterotrophs |
| Electron donor | COD | Ammonium | COD |
| Electron acceptor | Nitrate | Oxygen | Nitrate |
| Secondary function | NA | COD removal | NA |
| Organisms | NA | Heterotrophs | NA |
| Electron donor | NA | COD | NA |
| Electron acceptor | NA | Oxygen | NA |

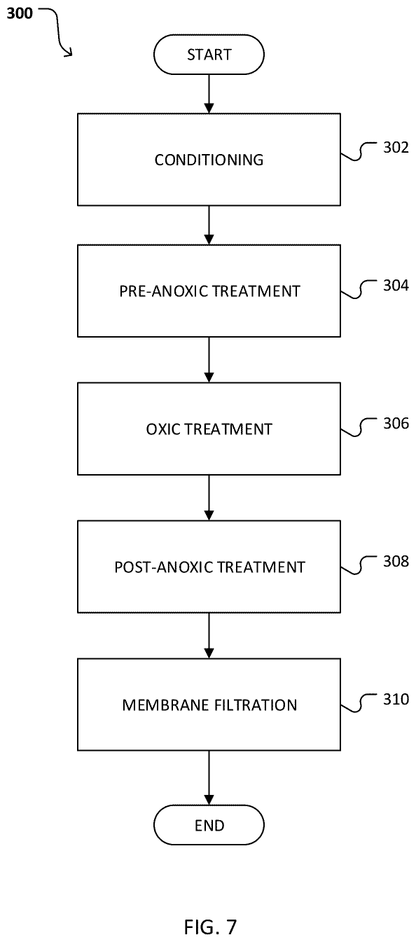

While specific processes through each compartment as describe further below with respect to FIG. 7, generally, the first compartment 124 can be a first anoxic treatment zone where the oxygen level is kept low, for example 0 to 1.0 mg/L or preferably 0 to 0.2 mg/L DO. That is, the first compartment 124 can be capable of maintaining conditions (e.g., ORP and DO) to support heterotrophic microorganisms. The first anoxic zone of the first compartment 124 can allow for some of the organic nitrogen in the influent to ammonify. More specifically, as noted above, a primary function of the first anoxic zone can be denitrification and COD removal, where nitrogen is reduced via denitrification and assimilation.

The second compartment 126 can provide an oxic zone, or an aerobic zone where oxygen is present. For example the oxic zone can have 1.5 to 8 mg/L DO, preferably 2 to 4 mg/L DO. For example, in some embodiments, a gas inlet (not shown) can be used to provide gas (e.g., oxygen) to specific zones within the bioreactor 102, such as the second compartment 126, to maintain the oxic conditions. The oxic zone of second compartment 126 can house autotrophic microorganisms and can support nitrification. That is, as noted above, a primary function of the oxic zone can be nitrification, e.g., where nitrogen is oxidized via nitrification and assimilation.

The third compartment 128 can provide a second anoxic zone and house heterotrophic microorganisms. The third compartment 128 can allow for excess oxygen to expire and supports increased nitrification. More specifically, as noted above, a primary function of the second anoxic zone can be denitrification and COD removal, where nitrogen is reduced via denitrification and assimilation. Thus, the third compartment 128 can provide continued denitrification that was incomplete in the first compartment 124. Furthermore, the third compartment 128 can be fluidly coupled to the first compartment 124 by an internal recycle line 132. For example, the internal recycle line 132 can conduct a waste stream with unconverted nitrogen compounds (e.g., ammonia and nitrate) from the third compartment 128 back to the first compartment 124 for continued treatment. In some embodiments, the third compartment 128 can be larger than the first compartment 124 and/or the second compartment 126.

The compartments 124, 126, 128 can each be fluidly connected to one another to allow for influent flow from the first compartment 124, to the second compartment 126, to the third compartment 128, and either back to the first compartment 124 or out through the outlet 118. In some embodiments, the compartments 124, 126, 128 can be fluidly connected by tubes such that fluid movement between the compartments can be controlled by the pump array 104 and/or valves (not shown). As noted above, the composition of the compartments 124, 126, 128 can utilize the fundamental principles of BNR, e.g., a process coupling AOB and NOB to nitrify ammonium to nitrate and denitrify nitrate to diatomic nitrogen, respectively, for maximum nitrogen conversion and removal. The designated nitrification and denitrification zones can be modified by expanding or reducing the zones that are aerated, allowing for controlled conversion to nitrate and nitrogen gas.

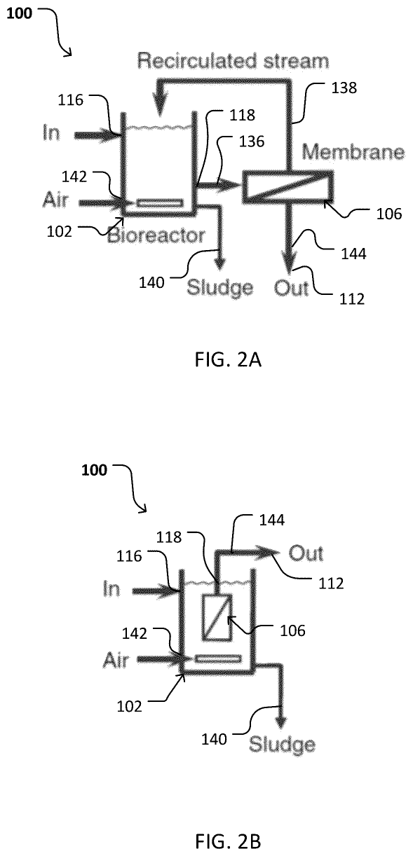

Referring now to the membrane filter 106, in some embodiments, the membrane filter 106 can include an ultrafiltration membrane 134 that separates clarified water (e.g., from the third compartment 128) from waste components such as solids, dissolved materials, and microorganisms. In some embodiments, the ultrafiltration membrane 134 can comprise ultrafiltration tubular membranes. In one embodiment, the ultrafiltration membrane 134 can include a pore size of about 0.03 micrometers (μm). In some embodiments, as shown in FIGS. 1 and 2A, the membrane filter 106 can be positioned outside the bioreactor 102, e.g., as a side stream MBR (sMBR). In this configuration, one of the pumps of the pump array 104 can move fluid from the outlet 118 of bioreactor 102 through an outlet line 136 into the membrane filter 106, through the ultrafiltration membrane 134, and out the membrane filter 106 to the system outlet 112. That is, clarified water can exit the membrane 134 to the system outlet 112, while remaining solids, dissolved materials, and microorganisms can be returned to the bioreactor 102 via a return line 138. This external configuration permits the ultrafiltration membrane 134 to be cleaned in place, is much easier maintain, and mitigates fouling.

Additionally, or alternatively, as shown in FIG. 2B, the ultrafiltration membrane 134 can be incorporated within the bioreactor 102 in an internal configuration, e.g., as an immersed MBR (iMBR). In the internal configuration, the ultrafiltration membrane 134 can be submerged in the liquid of the bioreactor 102. In this configuration, an outlet of the ultrafiltration membrane can be considered the outlet 118 of the bioreactor 102. In some implementations, this configuration requires less volume for the membrane 134, allowing the system 100 to be more compact and have a lower energy demand as the pumping requirements are lowered.

Referring still to FIGS. 2A and 2B, though not shown in FIG. 1, the bioreactor 102 can also include a sludge outlet 140. The sludge outlet 140 can be located in one of the walls 114, e.g., near or at the floor of the bioreactor 102, to allow for the removal of solids, precipitation, debris, or sludge that may collect on the bottom of the bioreactor 102 during use. FIGS. 2A and 2B also show an air inlet 142, for example, for the introduction of oxygen into the bioreactor 102 (e.g., to the second compartment 126, as described above).

Referring back to FIG. 1 and, specifically, to the pump array 104 of the system 100, in some embodiments, the pump array 104 can include one or more pumps that can conduct the waste stream or influent into and through the bioreactor 102 to the system outlet 112. As described above, the membrane filter 106 can be fluidly coupled with the bioreactor 102 such that the waste stream can be conducted through the ultrafiltration membrane 134 to produce clarified water that exits the bioregenerative system 100, and reject fluid and other waste that is returned to the bioreactor 102 for further processing. In some embodiments, as shown in FIG. 1, the pump array 104 can be fluidly connected to the influent line 122, the internal recycle line 132, the outlet line 136, and/or a system outlet line 144.

Still referring to FIG. 1, the bioregenerative system 100 can further include the control system 108. The control system 108 can be coupled to, configured to receive data from, and/or configured to control the pump array 104 and the bioreactor 102. For example, as discussed above, the bioreactor 102 can include one or more sensors 130 configured to sense a condition within the bioreactor (e.g., pH, turbidity, dissolved oxygen, oxygen reduction potential), wherein the control system 108 can obtain such information from the sensors 130 to control the pump array 104, air inlet 142, other inlet or outlet valves of the bioreactor 102, or other system components.

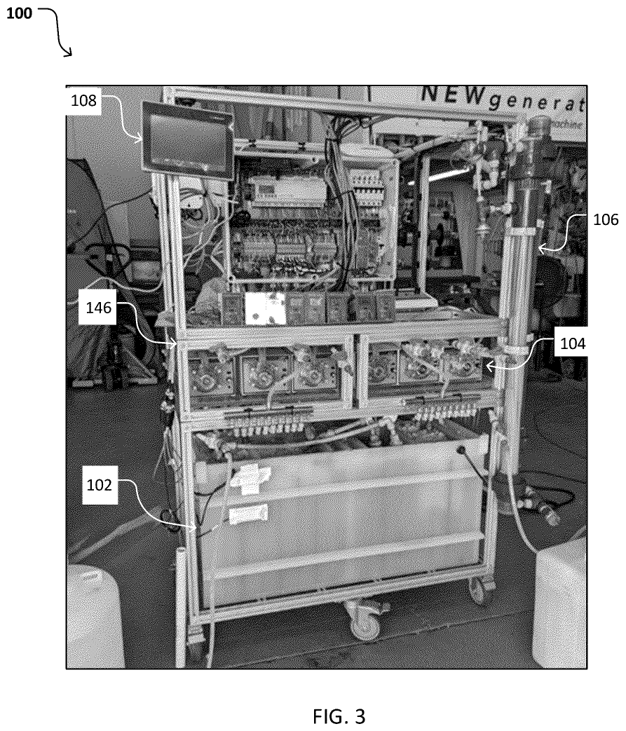

In some embodiments, the system 100 can be configured to sit within a small footprint. For example, as shown in FIG. 3, the system 100 can be housed within a racking system 146. In some embodiments, the racking system 146 can include metal framing within similar dimensions of racking systems already in use in the International Space Station, allowing for the system 100 to be easily integrated into existing racking systems 100 and allow for easy visualization of the bioregenerative system 100. More specifically, the racking system 146 of some embodiments can take on a form factor known as Expedite the PRocessing of Experiments to Space Station (EXPRESS) racks. Even though the EXPRESS racks pertain to the International Space Station, this design is a current NASA standard, is compact, easily accessible, and modular for easy integration for possible flight demonstration. Furthermore, any future form factor may likely be derivative of the EXPRESS rack to ease hardware transition. While intricately comprised of many fragments, the active volume of the EXPRESS rack may generally be composed of two shelves and powered drawers.

As shown in FIG. 3, the racking system 146 can house the bioreactor 102, the pump array 104, the membrane filter 106, and the control system 108. Associated hardware for the system 100, such as plumbing, can also be integrated into racking system 146. In some embodiments, as shown in FIG. 3, the bioreactor 102 can be located at a base of the racking system 146, the pump array 104 can be located within drawers, and the control system 108 can be located at a top portion. Components that are meant to be installed during operation and outside of the racking system frame dimensions, such as the membrane filter unit 106, can be detachable to ensure that the system 100 meets requirements for transport. According to some embodiments, in this configuration, the bioreactor 102 can be sized for active reactor volume ranges between 100-110 liters.

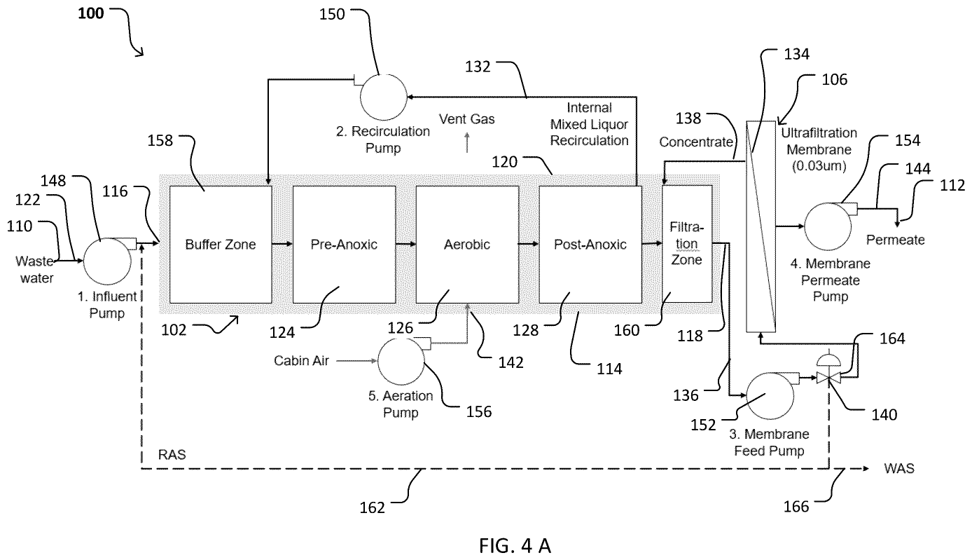

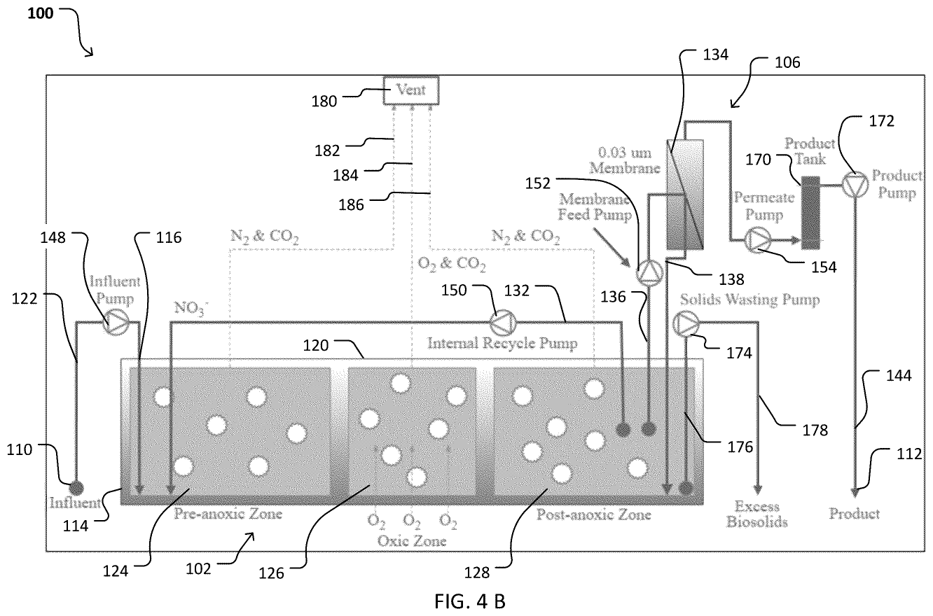

Turning now to FIG. 4A, another bioregenerative system 100, according to some embodiments, is illustrated. The system 100 of FIG. 4 may be similar to the system 100 of FIGS. 1 and 3 and, thus, the above description directed toward the system 100 of FIGS. 1 and 3 may be applicable to the system 100 of FIG. 4A, while the below description directed toward the system 100 of FIG. 4 may be applicable to the system of FIGS. 1 and 3. As such, while some components of the system 100 may not be specifically shown in FIGS. 1 and 3 but in FIG. 4A, or vice versa, such components may still be included in the system 100 in some implementations.

For example, as shown in FIG. 4A, the system 100 can include a bioreactor 102, a membrane filter unit 106, and a control system 108 (though not shown in FIG. 4). The pump array 104 can include a first pump, such as an influent pump 148, a second pump, such as a recirculation pump 150, a third pump, such as a membrane feed pump 152, a fourth pump, such as a membrane permeate pump 154, and/or a fifth pump, such as an aeration pump 156. Each of the pumps 148, 150, 152, 154, 156 can be in communication with and controlled by the control system 108.

Furthermore, as shown in FIG. 4, in addition to the first compartment 124 (pre-anoxic zone), second compartment 126 (oxic zone), and third compartment 128 (post-anoxic zone), the bioreactor 102 can further include a buffer zone 158 and a filtration zone 160. In some embodiments, the buffer zone 158 can be positioned before the first compartment 124 to increase retention time and, thus, allow for increased treatment. The filtration zone 160 can be positioned after the third compartment 128, in fluid communication with the reactor outlet 118, and concentrate filtered from the membrane filter unit 106 can be returned back to the filtration zone 160.

Regarding the pump array 104, the influent pump 148 can be positioned and controlled to pump influent from the system inlet 110 to the reactor inlet 116 and may also pump return activated sludge (RAS) from an RAS line 162 to the reactor inlet 116. The recirculation pump 150 can be positioned and controlled to pump recirculation fluid from the third compartment 128 back to the buffer zone 158 via the internal recycle line 132. The membrane feed pump 152 can be positioned and controlled to feed the outlet line 136 between the bioreactor outlet 118 and the membrane filter unit 106. As shown in FIG. 4, the outlet line 136 can also include a valve 164 that can be switched to either allow treated water to the membrane filter unit 106, or biomass or other material out of the bioreactor 102, either to be returned to the bioreactor 102 as RAS via the RAS line 162 or to be expelled as Waste Activated Sludge (WAS) via a WAS line 166. This can help prevent build-up at the bioreactor outlet 118. The membrane permeate pump 154 can be positioned and controlled to pump effluent (permeate) from the membrane filter unit 106 through the system outlet line 144 to the system outlet 112. The aeration pump 156 can be positioned and controlled to pump air, such as cabin air, into the second compartment 126, such as through diffusion stones (not shown). In one embodiment, the aeration pump 156 can operate at approximately 10 liters per minute (LPM).

Additionally, in some embodiments, the pumps 148-156 can serve as sampling and monitoring points throughout the system 100. For example, sensors 130 in communication with the control system 108 (not shown in FIG. 4) can be located near pump inlets or outlets to sense various characteristics of the system 100. Furthermore, in some embodiments, one or more sensors 130, such as liquid level sensors or overflow sensors, can be located in or adjacent one or more of the compartments 124, 126, 128, 158, 160. The control system 108 can obtain and use such sensor data to control the pump array 104 in order to maintain system stasis, e.g., in the event that liquid levels become too high.

For example, as shown in FIG. 4B, the system 100 can include a bioreactor 102, a membrane filter unit 106, and a control system 108 (though not shown in FIG. 4B). The pump array 104 can include a first pump, such as an influent pump 148, a second pump, such as a recirculation pump 150, a third pump, such as a membrane feed pump 152, a fourth pump, such as a membrane permeate pump 154, a fifth pump, such as an aeration pump 156 (though not shown in FIG. 4B), and/or a sixth pump, such as a product pump 172, and/or a seventh pump, such as solids pump 174. Each of the pumps 148, 150, 152, 154, 156, 172, 174 can be in communication with and controlled by the control system 108.

Regarding the pump array 104, the permeate pump 154 can be positioned and controlled to pump permeate from the ultrafiltration membrane 134 to a product tank 170. The permeate pump 154 on the permeate side of the membrane can create a pressure differential to help relieve pressure and drive the filtration process. The product pump 172 can be positioned and controlled to remove the permeate from the product tank 170 and feed the permeate through the system outlet line 144 to the system outlet 112.

Additionally, in some embodiments, the solids pump 174 can be positioned and controlled to pump solids from the post-anoxic zone 128. The solids pump 174 can operate to pump excess biosolids through a solids line 176 and out of the bioreactor 102 through a solids outlet line 178.

Gases formed in the bioreactor can be off gassed through a vent 180. Vent lines 182, 184, and 186 can direct the gases away from the bioreactor 102 (e.g., O₂ and CO₂ from the oxic zone in compartment 126, N₂ and CO₂ from the pre-anoxic zone in compartment 124 and the post anoxic zone in compartment 128). The gases can be combined at the vent 180 or directed separately for separation and/or reuse.

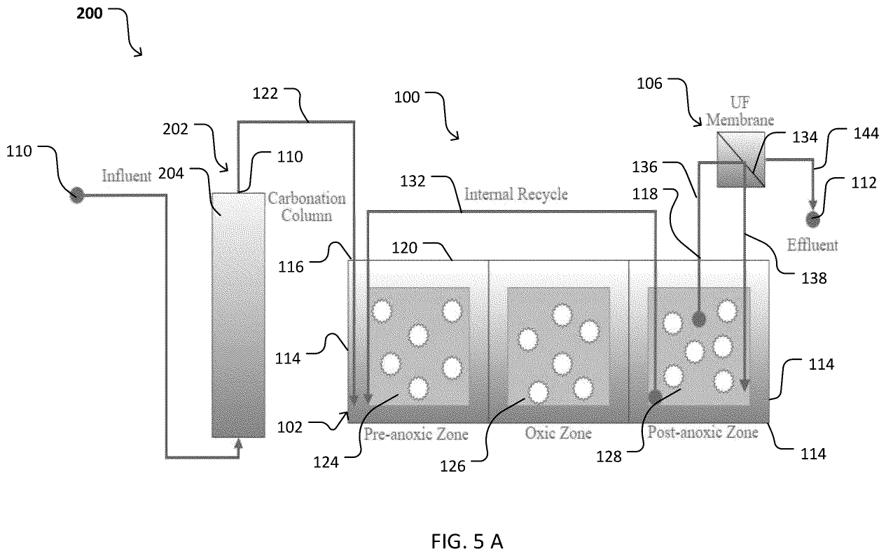

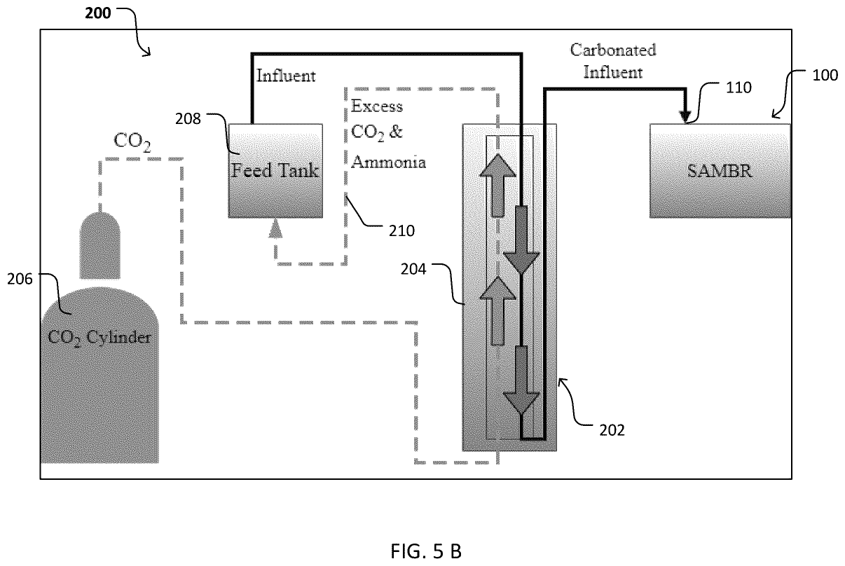

Turning now to FIG. 5A, a system 200, according to some embodiments, is illustrated. The system 200 of FIG. 5A incorporates the bioregenerative system 100 described above with respect to FIGS. 1-4 and may further include a carbonation unit 202.

For example, a consideration in urine treatment is the increase in pH when urea, the main form of nitrogen in urine, hydrolyzes. As shown in Reaction 1 below, urea hydrolyses with water in the presence of the enzyme, urease, to create ammonium, bicarbonate, and hydroxide. The creation of hydroxide results in a rise in pH, while the ammonium and bicarbonate increase ion concentration (electrical conductivity) and alkalinity.

Urea Hydrolysis: (NH₂)₂CO+3H₂O [symbol] 2NH₄⁺HCO₃⁻+OH⁻ (1)

Generally, a desired pH range for AOB and NOB in the bioreactor 102 is 6-7.5. When pH is increased due to urine hydrolysis (often to a pH>9), inhibition within the bioreactor 102 is a risk. Traditionally, acid addition is used when pH reduction is necessary; however, if a solution has a high alkalinity, like hydrolyzed urine, it can require large amounts of acid. In the case of space application, the need for large volumes of acid would reduce the sustainability of a bioregenerative treatment technology.

Accordingly, in some embodiments, the carbonation unit 202 can be introduced into the system 200 to help counteract this increase in pH. For example, as used herein, carbonation means the addition of carbon dioxide, CO₂, to a solution for the purpose of reducing the pH. More specifically, as shown in Reaction 2, gaseous CO₂ dissolves and becomes aqueous, then reacts with water to form carbonic acid (Reaction 3). The carbonic acid then dissociates to form bicarbonate and releases a hydrogen ion (Reaction 4). The bicarbonate also dissociates to produce carbonate and release another hydrogen ion (Reaction 5). The release of these hydrogen ions contributes to the reduction of pH.

Carbon Dioxide Dissolution: CO_{2(g)}⇔CO_{2(aq)} (2)

Carbonic Acid Formation: CO₂+H₂O⇔H₂CO₃ (3)

Bicarbonate Formation: H₂CO₃⇔H⁺+HCO₃⁻ (4)

Carbonate Formation: HCO₃⁻⇔H⁺+CO₃²⁻ (5)

For the carbonation process, CO₂ can be added to an influent by bubbling gaseous CO₂ through the solution. Alternatively, solid CO₂ can be added to a solution to provide gaseous CO₂. For example, referring to FIG. 5A, the carbonation unit 202 can include a carbonation column 204 located along the influent line 122. Thus, the outlet of the carbonation unit 202 may be considered the system inlet 110. As such, the pH of influent can be reduced before reaching the bioreactor inlet 116 of the system 100.

As another example, FIG. 5B illustrates a system 200 including the bioregenerative system 100 with a carbonation unit 202, according to some embodiments. As shown in FIG. 5B, the carbonation unit 202 is upstream of the system 100. The carbonation unit 202 and, more specifically, the carbonation column 204, is fluidly coupled with a CO₂ source 206, a waste stream source 208 (e.g., a feed tank), and the system inlet 110. The CO₂ source 206 can be a cylinder supplying CO₂ gas to the carbonation column 204. Excess CO₂ and ammonia can be directed back to the feed tank 208 via a waste return line 210.

Accordingly, influent can be directed through the carbonation column 204 to contact carbonic acid before entering the bioreactor 102 of the system 100. More specifically, in the carbonation column 204, the gaseous CO₂ mixes with the influent to form H₂CO₃ (carbonic acid), which provides hydrogen ions that contribute to lowering the pH of the influent (e.g., to below 8) before it enters the system 100. As shown by the arrows in FIG. 5B, influent is fed through the top of an inner tube and flows down, counter-current to CO₂ introduced at the bottom of the inner tube through an air stone, allowing for sufficient mass transfer of CO₂ to the influent. The carbonated influent then flows up to the top of the outer tube and into the system 100. Furthermore, in some applications, the carbonation unit 202 can be used as a carbon dioxide trap to remove carbon dioxide from a gaseous stream, such as biogas from anaerobic digestion, by using an alkaline liquid such as NaOH or urine.

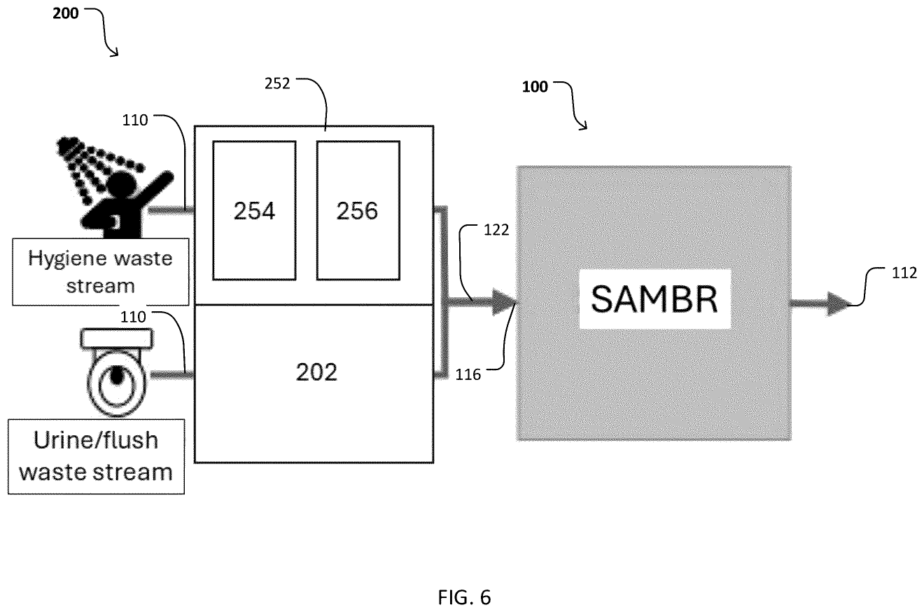

Turning now to FIG. 6, a system 200, according to some embodiments, is illustrated. The system 200 of FIG. 6 incorporates the bioregenerative system 100 described above with respect to FIGS. 1-5 and may further include a hygiene waste stream (e.g., graywater) including wastewater from hygienic process (e.g., showers, hand washing) and a treatment unit 252 fluidly coupled with the bioreactor 102. The hygiene waste stream can be introduced to the system 200 by the inlet 110 separately from the urine/flush waste stream. The hygiene waste stream and urine/flush waste stream can be combined within the treatment unit 252 and directed into the bioreactor 102 at the reactor inlet 116 as shown in FIG. 6. Additionally, and alternatively, the waste streams can remain separate, where each waste stream enters the bioreactor 102 at reactor inlet 116.

A particular consideration of incorporating a hygiene waste stream is the presence of surfactants in the graywater. Surfactants can cause undesired foaming or biological inhibition within the bioreactor 102. To mitigate effects from surfactants, the treatment unit 252 can be positioned along the hygiene waste stream, upstream of the bioreactor 102, to condition the waste stream before it enters the bioreactor 102. The treatment unit 252 conditions the hygiene waste stream to reduce the concentration of surfactants.

Surfactants that can be found in a hygiene waste stream can include non-ionic surfactants such as polysorbates or sorbitans, anionic surfactants (e.g., sulfates and isethionates), cationic surfactants (e.g., benzalkonium, stearalkonium, trimethyl ammonium), fatty acids, zwitterionic surfactants (e.g., cocamidopropyl betaine, phospholipids), and amphoteric surfactants that can act as either anionic or cationic detergents depending on the pH of the solution, (e.g., cocamidopropyl betaine, cocoamphoacetate). In certain examples, the hygiene waste stream surfactants can include coco glucoside, cocamidopropyl betaine (CAPB), sodium laureth sulfate (SLES), sodium lauryl sulfate (SLS), sodium C₁₄-C₁₆ olefin sulfonate, disodium laureth sulfosuccinate, sodium cocoyl isethionate (SCI), sodium lauroyl sarcosinate, capryl glucoside, alcohol ethoxylate, disodium lauroampho diacetate, and sodium trideceth sulfate (STS).

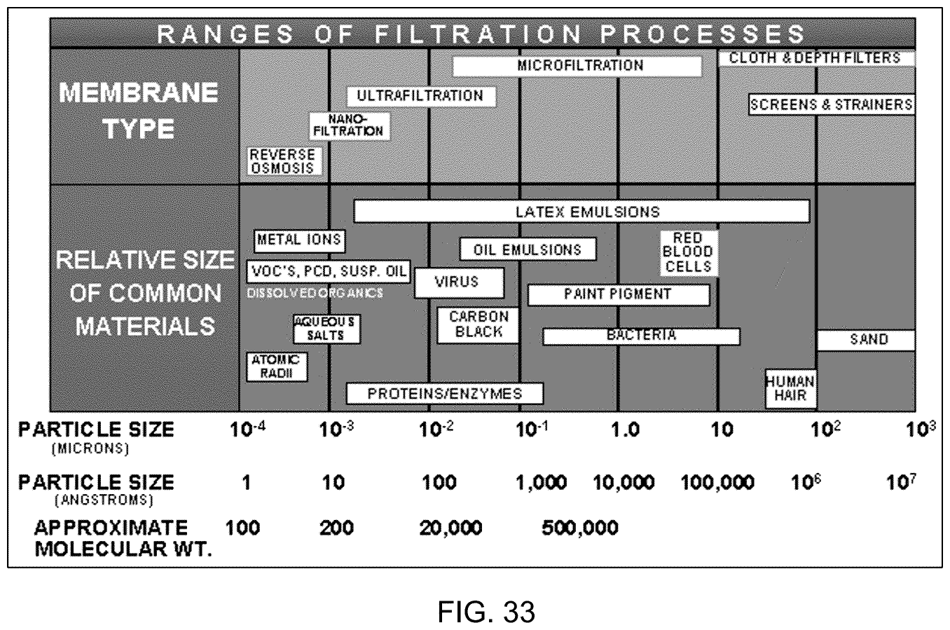

Accordingly, in some embodiments, the treatment unit 252 can include a filtration unit 254 through which the hygiene waste stream passes, and which rejects the surfactants. The filtration unit 254 can include a membrane of a type shown in FIG. 33. In some embodiments, the filtration unit 254 includes a membrane for microfiltration that rejects particles that are between about 10⁻¹ microns and about 10 microns in size. In other embodiments, the filtration unit 254 can include a membrane for ultrafiltration (UF), where the UF membrane can reject particles that are between about 10⁻² microns and about 10⁻¹ microns in size. In further embodiments, the filtration unit 254 can include a membrane for nanofiltration, where the nanofiltration membrane can reject particles that are between about 10⁻³ microns and about 10⁻² microns in size. In some embodiments the filtration unit 254 rejects surfactants based on molecular weight. For example, the filtration unit 254 can include a membrane that rejects surfactants having a molecular weight greater than 200 kDa, 300 kDa, 400 kDa, 500 kDa, 600 kDa, 700 kDa, 800 kDa, 900 kDa, 1000 kDa, or 1200 kDa. The filtration unit 254 can reduce the concentration of surfactant in the hygiene waste stream by about 10%, about 20%, about 30%, about 40%, about 50%, about 60%, about 70%, about 80%, about 90%, about 95%, about 98%, or about 99%. For example, the filtration unit 254 can reduce the concentration of surfactant to less than 200 mg/L, less than 150 mg/L, less than 100 mg/L, or less than 50 mg/L.

It is contemplated that the filtration unit 254 can include any combination of membranes organized to reject surfactants from the graywater waste stream. The filtration unit 254 can include membranes that are combined and/or sized in order to achieve a flux of between 1 LMHs and 50 (LMH is L/m²/h).

In some embodiments, the treatment unit 252 can include a sonication unit 256 through which the hygiene waste stream passes, and which degrades the surfactants. Ultrasonication of aqueous solutions can produce highly reactive radicals by influencing the dissociation of water into a hydrogen radical and a hydroxyl radical (Reaction 6):

Water Dissociation: H₂O⇔H·+OH· (6)

The hydrogen and hydroxide radicals can react with surfactant molecules, changing their molecular structure, and thereby reducing their ability to induce foaming in the reactor.

The sonication unit 256 can provide ultrasonic frequencies greater than 20 kHz and up to 10 MHz. In some examples, the ultrasonic frequency can be between 20 kHz and 100 kHz, between 25 and 75 kHz, or between 30 and 50 kHz. The waste stream can be subjected to continuous sonication by the sonication unit 256. Additionally, and alternatively, the waste stream can be collected and subjected to sonication in batches for a set amount of time (e.g., 10 min, 30 min, 1 h, 2 h, 3 h, or more) before entering the bioreactor 102.

As sonication can increase the temperature of the waste stream, the sonication unit 256 can include a temperature sensor or a cooling device for controlling the temperature. For example, the sonication unit can be configured to increase the temperature to no more than 35° C., 40° C., 45° C., 50° C., or 65° C. The sonication unit 256 can be configured to generate a noise level of less than 90 dB, less than 80 dB, less than 70 dB, or less than 60 dB while in operation. For example, the sonication unit 256 can include noise insulation.

The treatment unit 252 can include any combination of filtration unit 254 and sonication unit 256. The filtration unit 254 can be modular in design, allowing for removal and replacement during operation.

In light of the above, FIG. 7 illustrates a process 300, according to some embodiments, to treat waste using the above-described systems 100, 200. Generally, the process 300 can include a conditioning step 302, a pre-anoxic treatment step 304, an oxic treatment step 306, a post-anoxic treatment step 308, and a membrane filtration step 310.

In the conditioning step 302, the waste stream is treated, or conditioned, to bring the waste stream to a desired state. The conditioning step 302 can include carbonation, where a waste stream from a source (e.g., a waste system or a feed tank 208) can pass through a carbonation unit 202, where CO₂ contacts the waste stream to lower the pH. In some implementations, the conditioning step 302 may be considered an optional step, e.g., only when necessary. As such, in some implementations, the control system 108 can monitor a pH of the influent, e.g., via a sensor 130. If the pH is below a threshold level, e.g., within the ideal range for treatment in the bioreactor 102, the control system 108 can operate one or more valves so that the influent bypasses the carbonation unit 202 and is delivered straight to the system 100. If the pH is above the threshold level, e.g., where pH is outside the ideal range, the control system 108 can operate the valves so that the influent enters the carbonation unit 202 prior to reaching the system 100.

In some cases, where a hygiene waste stream is included, the conditioning step 302 can include treatment to reduce the concentration of surfactants in the waste stream. The conditioning step 302 includes subjecting the waste stream to at least one of filtration by a filtration unit 254 or sonication by a sonication unit 256. The conditioning step 302 can independently include carbonation, filtration, and sonication of one or more waste streams.

At the pre-anoxic treatment step 304, the output from the carbonation unit 202, considered carbonated influent, is introduced to the bioreactor 102 of the system 100, where it enters the first anoxic treatment zone in the first compartment 124. Additionally, and alternatively, at the pre-anoxic treatment step 304, the output from the treatment unit 252 is introduced to the bioreactor 102 of the system 100, where it enters the first anoxic treatment zone in the first compartment 124. In other words, the influent can include one or both of the output of the carbonation unit 202 or the treatment unit 252. For example, the influent enters the first anoxic zone with nitrogen predominantly in the form of organic nitrogen and ammonia. Additionally, a downstream is recycled back to the first compartment 124 that introduces nitrates for nitrogen removal via denitrification, as further described below. In the first compartment 124, at least some of the organic nitrogen in the influent is ammonified. That is, the heterotrophic microorganisms break down nitrogen-containing chemicals from the waste organic matter into ammonia or ammonium salts. These heterotrophic bacteria use organic carbon as electron donors and nitrate as the acceptor. A relatively small fraction of nitrogen may be used in biomass uptake.

At the oxic treatment step 306, the waste stream flows into an the oxic treatment zone, e.g., an aerobic stage, in the second compartment 126. As described above, the second compartment 126 is maintained with aerobic conditions and autotrophic microorganisms. Nitrogen in ammonia form enters this aerobic stage, where nitrification converts ammonia to nitrate. That is, ammonia oxidizing bacteria (AOB) oxidize ammonia to nitrite, plus hydrogen and water (Reaction 7 below) and nitrite oxidizing bacteria (NOB) oxidize the nitrite into nitrate (Reaction 8) in the oxic treatment zone. The overall process can be depicted as a general nitrification process shown in Reaction 9. These autotrophic bacteria use ammonia and nitrite as their non-organic electron donor and oxygen as the acceptor. Consequently, heterotrophic microorganisms oxidize organic constituents, resulting in COD reduction.

Nitritation Reaction: NH₄⁺1.50₂↔NO₂⁻+2H⁺+H₂O (7)

Nitrification Reaction: NO₂⁻+0.50₂↔NO₃ (8)

Overall Nitrification Reaction: NH₄⁺+2O₂↔NO₃⁻+2H⁺+H₂O (9)

At the post-anoxic treatment step 308, the waste flows into the second anoxic treatment zone in the third compartment 128. The anoxic zone in the third compartment 128 allows for any excess oxygen to expire and supports increased denitrification. In the third compartment 128 under anoxic conditions, such as in the first compartment 124, denitrifying microorganisms convert nitrate into diatomic nitrogen through a series of reduction reactions listed as Reactions 10, 11, 12, and 13 below, with the overall denitrification reaction listed in Reaction 14. Organic carbon is utilized as the electron donor in these reactions. In some examples, additional carbon sources can be used to promote the denitrification process, e.g., from excess biomass or an external source such as methanol.

Nitrate Reduction Reaction: NO₃⁻+2H⁺+2e⁻ [symbol] NO₂⁻+H₂O (10)

Nitrite Reduction Reaction: NO₂⁻+2H⁺+e⁻ [symbol] NO+H₂O (11)

Nitric Oxide Reduction Reaction: 2NO+2H⁺+2e⁻ [symbol] N₂O+H₂O (12)

Nitrous Oxide Reduction Reaction N₂O+2H⁺+2e⁻ [symbol] N₂+H₂O (13)

Overall Denitrification Reaction: 2NO₃⁻+12H⁺+10e⁻↔N₂+6H₂O (14)

Still referring to the post-anoxic treatment step 308, the recently converted nitrogen can be off-gassed into the atmosphere or collected for re-use, the reactor contents can flow back to the first compartment 124 (or the buffer zone 158) via the internal recycle line 132, and the treated water can exit the bioreactor 102 via the reactor outlet 118. Additionally, as noted above, the designated nitrification and denitrification zones in the compartments can be modified by expanding or reducing the zones that are aerated, allowing for controlled conversion to nitrate and nitrogen gas. Such monitoring and modification can be completed by the control system 108.

At the membrane filtration step 310, the treated waste stream is conducted to the membrane filter unit 106, where the waste stream is filtered via the ultrafiltration membrane 134 to produce clarified water and reject material. The reject material (e.g., solids and micro-organisms retained by the ultrafiltration membrane 134) is returned to the third compartment 128 (or the filtration zone 160), while the clarified water exits the system 100 via the system outlet 112. The control system 108 can control the pump array 104 to maintain a desired transmembrane pressure (TMP) across the ultrafiltration membrane 134.

The membrane permeate produced from the membrane filtration step 310 can be a high-quality, particulate-free effluent that is rich in nutrients for, e.g., fertigation applications. Additionally or alternatively, the membrane permeate can be further treated downstream to produce drinking water.

As noted above, this treatment process 300 can be designed as a median of a Modified-Ludzack Ettinger (MLE) process and a 4-stage Bardenpho process. For example, in contrast to a traditional MLE process, the present treatment process 300 contains both pre- and post-anoxic zones. Further, in contrast to a more complicated 4-stage Bardenpho process, a secondary aerobic zone is not included.

In light of the above, the present systems 100, 200, incorporating a Suspended Aerobic Membrane Bioreactor (SAMBR), use BNR principles in a scaled-down application with a membrane bioreactor and provides a bio generative alternative for urine treatment in locations such as space and planetary bases. The systems 100, 200 can be capable of a compact design, appropriate for such locations, can reduce the pH of hydrolyzed urine substantially to create a more ideal treatment environment, and can execute substantial nitrogen and carbon treatment of urine with hygiene dilution. Testing of components of some embodiments has been completed and the results are described in the following paragraphs.

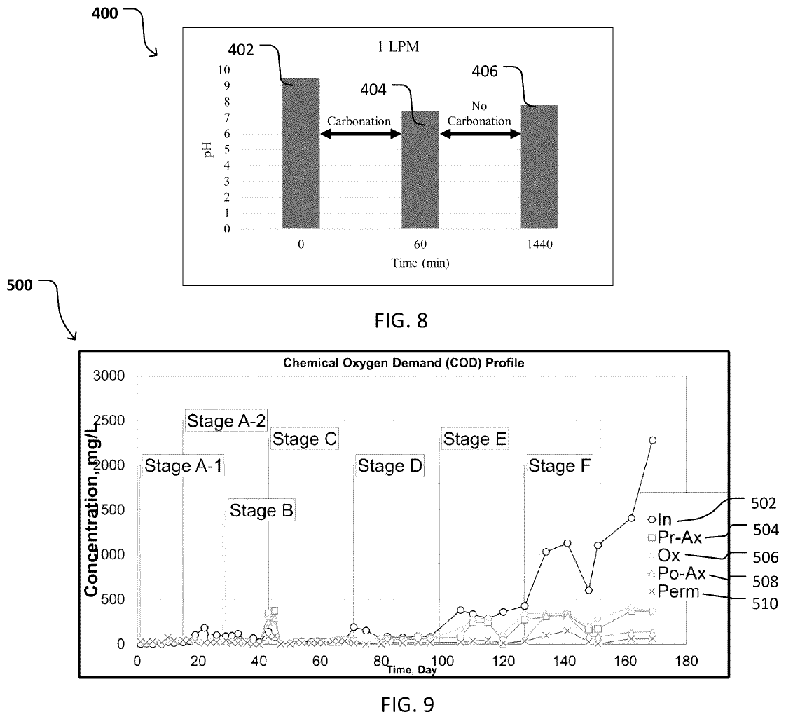

An investigation of urine carbonation at the benchtop was completed to determine the feasibility of bubbling CO₂ into urine and its ability to reduce the pH. The carbonation of urine was initially investigated by bubbling CO2 at a rate of 1 liter per minute (LPM) into 500 milliliters (mL) of hydrolyzed urine for one hour and then ceased. Samples were taken before carbonation, the hour that carbonation ceased, and 24 hours later. FIG. 8 illustrates a graph showing pH levels at time zero, i.e., pre-carbonation (bar 402), at 60 minutes when carbonation ceased (bar 404), and at 1440 minutes, i.e., 24 hours post-carbonation (bar 406). As shown in FIG. 8, the CO₂ addition lowered the pH from 9.5 to 7.4 after one hour of carbonation, indicating that the CO₂ dissolved into bicarbonate and a significant portion was retained as the pH stayed below 8 a day after carbonation had stopped.

Further testing was conducted to evaluate the capability of the system 100 to treat synthetic and real urine waste. Generally, one core objective of some embodiments is to convert and remove the high levels of nitrogen found in urine. Looking to space applications, with an estimated urine and flush generation of 2 and 0.3 kg/CM-day, respectively, the estimated nominal hydraulic loading for four crew members is 9.2 liters per day (L/d) (assuming ˜1 kg/L density). However, to immediately begin operating the system 100 with the high-nitrogen waste would likely invite complications stemming from Free Ammonia (FA) and Free Nitrous Acid (FNA) inhibition, potentially resulting in perceived failure before fully evaluating the system 200. For example, AOB and NOB, the primary treatment consortia of the system 100, 200, can be inhibited by FA at concentrations as low as 8 and 0.08 mg-N/L respectively. For FNA, AOB and NOB can suffer inhibition at concentrations as low as 0.2 and 0.06 mg-N/L respectively. However, there is a lack of study into the maximum tolerance of FA and FNA and at nitrogen levels exceeding 1000 mg-N/L and for scenarios such as source separated urine.

Due to this knowledge gap, a phased approach was planned to allow for the consortia to acclimate increasing levels of nitrogen. The characteristics of each stage of this phased approach to testing the system 100 are shown below in Table 2. The phased approach can assess the capability of the system 100 to tolerate increasing strengths of urine and potentially at what concentration inhibition is observed.

More specifically, initial oxic and anoxic treatment assessment and validation was started with a simulated influent (synthetic waste) like that of domestic wastewater (Stages A-1 to B). That is, the main objective of Stages A-1 and A-2 was to assess and validate oxic zone performance and operation. The main objective of Stage B was to couple the anoxic and oxic zones and assess and validate the performance and operation with internal recirculation. Stage A-1 used ammonium bicarbonate dissolved into water at approximate municipal levels. Acetic acid was subsequently added to the feed mixture to provide a carbon source for dentification in the pre- and post-anoxic zones for Stage A-2, and internal recirculation was implemented in Stage B.

Stage B is followed by introducing increasing strengths of real urine until full strength is reached (Stages C to H). That is, the main objective of Stages C to H was to assess the system's performance and operation and acclimate consortia with increasing concentrations of urine to reach full strength. In further stages, treatment may be expanded to include simulated hygiene water. As inhibition is likely to occur as higher strengths of urine is introduced, dilution may help to reduce the FA and FNA concentrations, which can be achieved by the addition of hygiene waste stream. For example, in space applications, a crew member generates approximately 7.25 L/d of hygiene water from activities such as handwashing, showering, rinsing etc., and could dilute the urine and flush down to about 22% of its full-strength nature and reduce the likelihood of inhibition. Accordingly, in some embodiments, the feed tank 208 of the system 200 can include any or all of urine, flush water, and hygiene waste.

During this phased approach, multiple parameters were used for evaluation of system performance during each stage. Furthermore, it should be noted that any of these parameters may be evaluated by the control system 108 during operation of the system 100, 200 in some embodiments. As such, any sensors or method described herein may be incorporated into the sensor 130 of the system 100, 200, as described above. For example, COD (soluble) can be evaluated (e.g., via Hach Method 8000) to monitor the available organic substrate removed and utilized by the biological consortia (e.g., for denitrification). Total nitrogen (soluble), TN, can be evaluated (e.g., using Hach Method 10072) to track the levels of nitrogen and capture any species of nitrogen outside of ammonia and nitrate that may be produced. Ammonia-nitrogen (soluble), AN, can be evaluated (e.g., using Hach Method 10031) to track the levels of ammonia and indicate nitrification rates and ammonia consumption. Nitrate-nitrogen (soluble), NN, can be evaluated (e.g., using Hach Method 10020) to track the levels of nitrate and indicate nitrification rates. These nitrogen analyses were used to assess the system's capability to convert and remove nitrogen via nitrification and denitrification. pH can be evaluated (e.g., using an ion selective probe) to inform the current pH environment in each sample and provide necessary information to correct pH to an ideal range, if necessary. Oxidation reduction potential, ORP can be evaluated (e.g., using an electron sensitive probe) to indicate oxic or anoxic conditions for nitrifying and denitrifying consortia, respectively. Dissolved oxygen, DO, can be evaluated (e.g., using an oxygen sensitive probe) as an additional indicator of oxic or anoxic conditions for nitrifying and denitrifying consortia, respectively. Electrical conductivity, EC, can be evaluated (e.g., using a current sensitive probe) to monitor the ion content throughout the system. Turbidity was evaluated (e.g., using Mach Method 8237) as an indicator of effluent water quality. Transmembrane pressure was evaluated (e.g., using a pressure transducer) to monitor the performance and health of the filtration membrane 134.

TABLE 2
Characteristics of each stage of testing.

| Stage | A-1 | A-2 | B | C | D | E | F | G | H |
|---|---|---|---|---|---|---|---|---|---|
| Base Feed | Ammonium | Ammonium | | Urine (actual) and Flush | | | | | |
| Type | Bicarbonate | Bicarbonate w/ | | | | | | | |
| | | Carbon Source | | | | | | | |
| Influent | 46 | 46 | 46 | 46 | 450 | 1700 | 3500 | 5000 | 7061 |
| Nitrogen (mg- | | | | | | | | | |
| N/L) | | | | | | | | | |
| Influent COD | 0 | 70 | 70 | 70 | 693 | 2617 | 5388 | 7697 | 10870 |
| (mg/L) | | | | | | | | | |
| Influent | 0 | 44 | 44 | 44 | 431 | 1630 | 3355 | 4793 | 6769 |
| Carbon | | | | | | | | | |
| (mg/L) | | | | | | | | | |
| Volume (urine + | 1% | 1% | 1% | 1% | 6% | 24% | 50% | 71% | 100% |
| flush) as % | | | | | | | | | |
| of Total | | | | | | | | | |
| Influent | | | | | | | | | |
| Q (L/d) | 9.2 | 9.2 | 9.2 | 9.2 | 9.2 | 9.2 | 9.2 | 9.2 | 9.2 |
| HRT (d) | 12 | 12 | 12 | 12 | 12 | 12 | 12 | 12 | 1612 |
| Internal | OFF | OFF | ON | ON | ON | ON | ON | ON | ON |
| Recirculation | | | | | | | | | |
| (IR) | | | | | | | | | |
| Target | 14 | 14 | 14 | 28 | 28 | 28 | 42 | 101 | 101 |
| Duration of | | | | | | | | | |
| Stage (d) | | | | | | | | | |
| Cumulative | 14 | 28 | 42 | 70 | 98 | 126 | 168 | 269 | 370 |
| Duration (d) | | | | | | | | | |

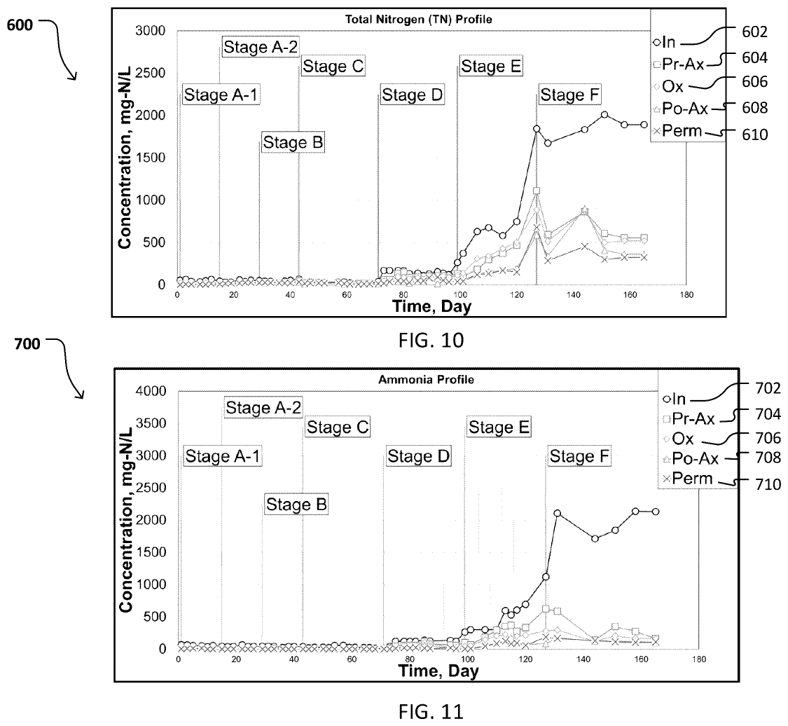

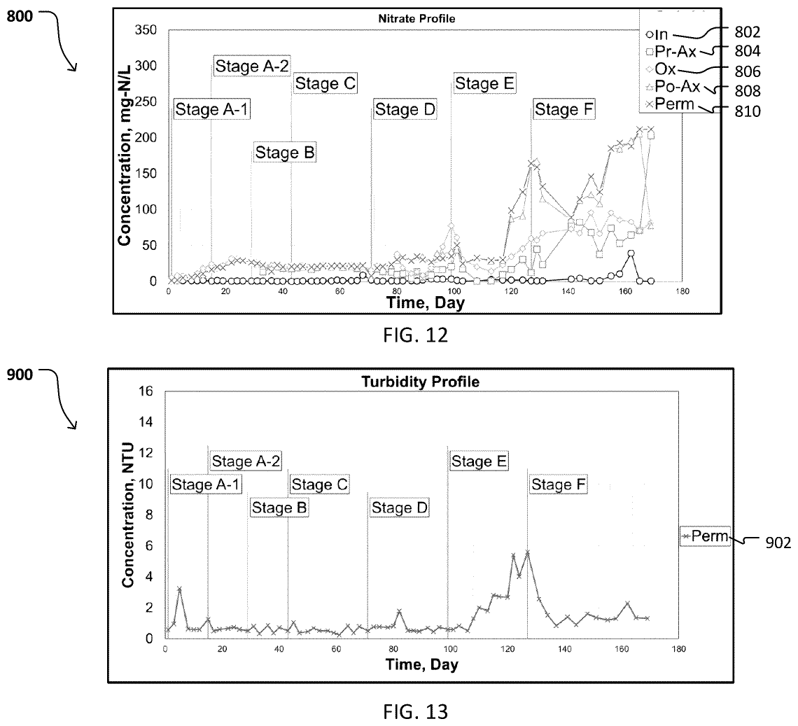

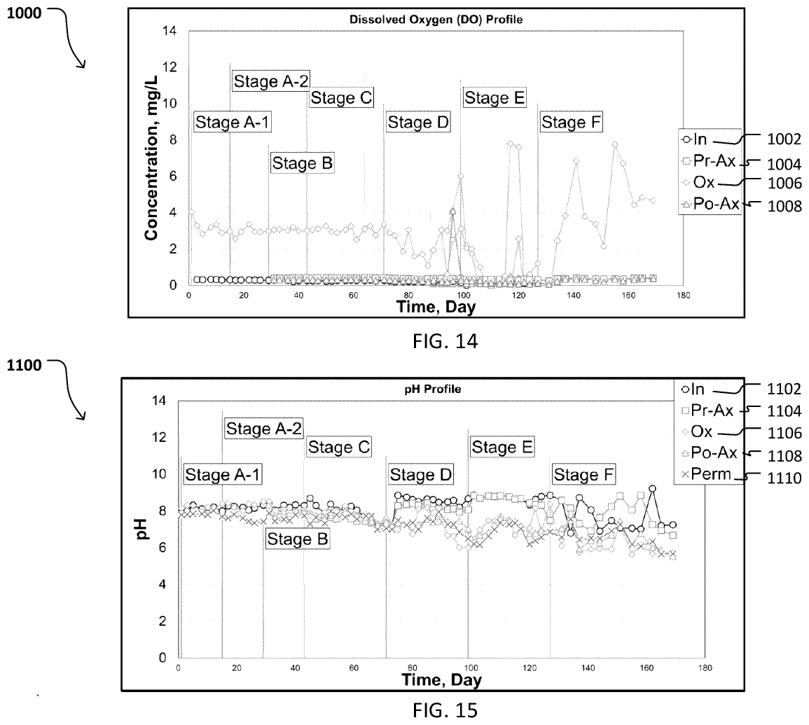

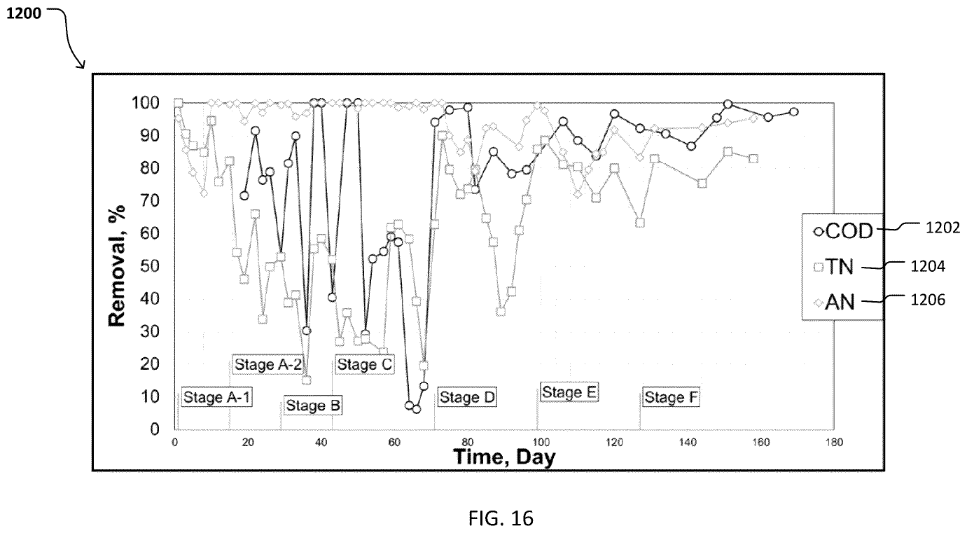

With reference to the phased approach and the results in Table 2, FIGS. 9-16 illustrate graphs of various parameters measured over time during operation of the system 100, measured from the influent, the pre-anoxic treatment zone, the oxic treatment zone, the post-anoxic treatment zone, and the permeate (or effluent). That is, FIG. 9 illustrates a graph 500 of a chemical oxygen demand (COD) profile of the system 100 over time, including measurements of the influent 502, the pre-anoxic treatment zone 504, the oxic treatment zone 506, the post-anoxic treatment zone 508, and the permeate 510. FIG. 10 illustrates a graph 600 of a total nitrogen (TN) profile of the system 100 over time, including measurements of the influent 602, the pre-anoxic treatment zone 604, the oxic treatment zone 606, the post-anoxic treatment zone 608, and the permeate 610. FIG. 11 illustrates a graph 700 of an ammonia profile of the system 100 over time, including measurements of the influent 702, the pre-anoxic treatment zone 704, the oxic treatment zone 706, the post-anoxic treatment zone 708, and the permeate 710. FIG. 12 illustrates a graph 800 of a nitrate profile of the system 100 over time, including measurements of the influent 802, the pre-anoxic treatment zone 804, the oxic treatment zone 806, the post-anoxic treatment zone 808, and the permeate 810. FIG. 13 illustrates a graph 900 of a turbidity profile of the system 100 over time, including measurements of the permeate 902. FIG. 14 illustrates a graph 1000 of a dissolved oxygen (DO) profile of the system 100 over time, including measurements of the influent 1002, the pre-anoxic treatment zone 1004, the oxic treatment zone 1006, and the post-anoxic treatment zone 1008. FIG. 15 illustrates a graph 1100 of a pH profile of the system 100 over time, including measurements of the influent 1102, the pre-anoxic treatment zone 1104, the oxic treatment zone 1106, the post-anoxic treatment zone 1108, and the permeate 1110. FIG. 16 illustrates a graph 1200 of a COD and nitrogen removal profile of the system 100 over time, including measurements of COD 1202, total nitrogen (TN) 1204, and ammonia-nitrogen (AN) 1206.

In addition to the results shown in FIGS. 9-16, Table 3 below summarizes influent/effluent water quality averages from the testing through Stage F. Note that influent value for turbidity exceeded a measurable range (>1000 NTU) and, thus, only effluent values are shown in Table 3.

TABLE 3
System influent/effluent water quality averages

| | Stage | | | | | | | | | | | | | |
|---|---|---|---|---|---|---|---|---|---|---|---|---|---|---|
| | A-1 | | A-2 | | B | | C | | D | | E | | F | |
| Sample | In. | Eff. | In. | Eff. | In. | Eff. | In. | Eff. | In. | Eff. | In. | Eff. | In. | Eff. |
| COD | 9 | 37 | 98 | 29 | 77 | 21 | 45 | 23 | 91 | 12 | 357 | 30 | 1259 | 67 |
| (mg/L) | | | | | | | | | | | | | | |
| TN | 50 | 6 | 44 | 21 | 46 | 25 | 26 | 15 | 155 | 47 | 808 | 215 | 1852 | 341 |
| (mg-N/L) | | | | | | | | | | | | | | |
| AN | 53 | 6 | 44 | 21 | 46 | 25 | 26 | 15 | 155 | 47 | 808 | 215 | 1852 | 341 |
| (mg-N/L) | | | | | | | | | | | | | | |
| NN | 1 | 7 | 1 | 25 | 1 | 21 | 2 | 20 | 2 | 29 | 1 | 69 | 6 | 159 |
| (mg-N/L) | | | | | | | | | | | | | | |

| | | | | | | | |
|---|---|---|---|---|---|---|---|
| Turbidity | 1.1 | 0.6 | 0.6 | 0.6 | 0.7 | 2.5 | 1.5 |

In view of the results shown in Tables 2 and 3 and FIGS. 9-16, Stages A1-E have displayed considerable success. The results showed a continuous decline in COD (FIG. 9), indicating organic substrate is being consumed, presumably for denitrification (and a small fraction for assimilation) as there was an average removal of 66% of COD. This was further supported by a reduction in TN (FIG. 10) and AN (FIG. 11) with an average removal of 65% and 94%, respectively, indicating denitrification is occurring and diatomic nitrogen is being off-gassed into the atmosphere. Some fraction may have off-gassed as ammonia however, since the pH was consistently lower than 9.3 (FIG. 15), most of the nitrified nitrogen would be present as ammonium and therefore it is likely to be a marginal fraction. Nitrification as also evident as an increase throughout the system and at the effluent composed, on average, 83% of the nitrogen content. This remaining nitrate can be valuable as a fertilizer source for crop production and hydroponics. The DO in the oxic zone was consistently around 3 mg/L (FIG. 14), an ideal level for nitrification, indicating a sufficient amount of mass transfer from the air diffusion stones such that the oxygen expired by the time it reached the pre-anoxic zone. Additionally, the drop in turbidity (FIG. 13) from an unmeasurable level (>1000) to a single digit demonstrated a significant retention of particulates by the membrane and that a high-quality effluent, rich in soluble nutrients was being produced.

In light of the above, urine offers a renewable source of nitrogen and other trace elements that can support sustainable crop production as well as water recovery. As no flight-ready bioregenerative technology exists, the systems and methods described herein can expand what is known about bioregenerative waste treatment and resource recovery in space applications. In addition to expanding the knowledge of space waste treatment, the present systems and methods offer alternative bioregenerative treatment to the traditional physical/chemical technologies that require constant consumable inputs and generate hazardous byproducts. Current bioregenerative technologies under development cannot treat urine directly, are not optimized for partial gravity habitats (PGH), or are still being optimized for maximum nitrogen removal. The present systems and methods may be optimized for early planetary bases (EPB) or PGH and serve as a hybrid alternative to currently utilized treatment technologies, supporting the resource recovery loop for treating all forms of waste. For example, the system's minimal need of consumable inputs and ability to remove 94% of the ammonia present and convert at least up to 83% of the remaining nitrogen into nitrate that can be used in fertigation applications, making it ideal for PGH applications. The waste processing methods and systems disclosed herein are designed to approach 98% water recovery for reuse, as well as the recovery of resources such as carbon and nitrogen from metabolic waste which can be used for in-situ food production, all while relying on minimal consumables (e.g., filters, chemical reagents) Accordingly, the technology of some embodiments can have an impact on sustainable urine treatment in space and on Earth.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

### EXAMPLES

### Example 1 Urine Conditioning

Due to the concentrated nature of the urine waste stream, particularly the high pH, nitrogen, and ion content, SAMBR's biological consortia may have been experienced inhibition from optimal performance. In response to this potential effect, a subsystem capable of improving the condition of the urine and flush waste stream was investigated to be coupled with SAMBR.

Initially an automated acid addition process was considered. Dosing the waste stream prior to entering the bioreactor would reduce the increase in pH resulting from urea hydrolysis. Preliminary tests indicated that a 6M HCl solution was capable of reducing and maintaining the pH of urine from 9.4 to 6.9. However, the mass of pure HCl required to continuously treat the urine generated by a crew of four for a 30-month mission was estimated to be almost 60 kg and therefore considered to be too great as it would mitigate the sustainability of the system. Several other technologies were considered including zeolite and electrodialysis. However, carbonation of the urine by bubbling carbon dioxide was selected for its generally non-hazardous properties, ubiquitous availability, and simplicity.

As hydrolyzed urine is characterized by a relatively higher pH (>9) than what typical biological treatment systems require (<8), the carbonation system should be able to reduce the pH of the urine to below eight. However, as carbon dioxide could off-gas in between the carbonation treatment and reaching the consortia present in SAMBR, this could result in a rebound of pH. As such the pH of the urine after carbonation should be considerably lower to account for the potential pH rebound and could be achieved by maximizing mass transfer, contact time, and treatment time.

### 1.1 Materials and Methods

### 1.1.1 Sample Collection

Samples were drawn using syringes directly from the testing apparatus and were stored in 50- and 15-mL conical polypropylene tubes at 4° C. All samples were typically analyzed within one week after being taken. Sample containers were soaked in a soap and disinfecting bath for at least one hour, rinsed with tap water, rinsed with distilled water, and dried prior to sample collection. Most analyses were performed in duplicate with triplicate readings, yielding six readings per sample unless indicated otherwise.

### 1.1.2 Sample Preparation and Storage

Samples for soluble analysis were subjected to centrifugation at approximately 3660 RPM for at least 15 minutes. After centrifugation, the supernatant was pipetted into a new container. Soluble samples were subsequently brought to ambient temperature for analysis if previously stored at 4° C. Due to the high strength the samples were diluted with deionized (DI) water to within range of the corresponding parameter and served as the sample to be analyzed within each parameter.

### 1.1.3 Chemical Oxygen Demand

Chemical Oxygen Demand (COD) is defined as the amount of oxygen necessary for the complete oxidation of carbon in organic matter and is commonly used to characterize wastewater strength. The COD measured for these samples examined the dissolved or soluble fraction of COD. COD analyses was conducted in accordance with Hach Method 8000 utilizing Hach COD HR dichromate digestion kits. A 2 mL sample was pipetted into the digestion vial with 2 mL of DI water pipetted into a separate digestion vial to serve as a blank calibration. The digested vial was inverted several times to mix the contents and heated in a COD reactor for two hours at 150° C. After the reaction time, the samples were cooled to room temperature, wiped clean, and concentration measured using a Hach DR/4000U spectrophotometer.

### 1.1.4 Ammonia-Nitrogen

Soluble ammonia nitrogen (AN) analyses were conducted in accordance with Hach Method 10031 and utilized Hach HR Ammonia Nitrogen kits. A 0.1 mL sample was pipetted into the vial with 0.1 mL of DI water pipetted into a separate digestion vial to serve as a blank calibration. Two reactive agent powder pillows of ammonia salicylate and cyanurate were added to each vial and inverted several times to mix the contents and set out to react for 20 minutes. After the reaction time, the sample was wiped clean and measured transmittance and correlated to a concentration using a Hach DR/4000U spectrophotometer. Only soluble analyses were conducted as total fractions are a source of interference and would have resulted in unreliable results.

1.1.5 pH

pH analyses were conducted using ion selective probes. Prior to and after analysis, the probes were rinsed thoroughly with DI water and dried. The pH reading was taken during a 5-10-minute window to allow for stabilization and when little drift was observed. Only single samples conducted for analysis, and singular readings taken due to the inherent nature of this method. Calibration of the pH probe was checked on a regular basis and recalibrated if necessary. When not in use, the probe was stored in a pH probe storage solution.

### 1.1.6 Alkalinity

Alkalinity analyses were conducted in accordance with titration color change method 2320 from the Standard Methods for the Examination of Water and Wastewater. 50 mL of sample was measured out in small beaker with a stir bar on a magnetic stir plate set at a low speed. A burette was filled with 0.02N of sulfuric acid as the titrant. 0.2 mL of Bromocresol Green indicator was added to the sample and allowed to mix. The sulfuric acid was slowly titrated into the beaker of sample (while still being stirred continuously) until a color change is observed and the color did not change further. The alkalinity is then calculated by Eqn. 1.1:

$$Alk = ( {V}_{t} \cdot {N}_{t} \cdot 50 , 000 ) / {V}_{s} \qquad Eqn . 1.1$$

$$where : Alk = Alkalinity as mg / L of {CaCO}_{3}$$

$${V}_{t} = mL of acid titrated into sample$$

$${N}_{t} = normality of acid titrated ( 0.02 )$$

$${V}_{s} = mL of sample ( 50 )$$

### 1.1.7 Urine Collection

Human urine was collected from consenting donors in specimen containers without any identifying markings or information. These specimen containers were anonymously placed in a designated collection site. The donations were combined, at random, into 5 L carboys to create a urine blend that was impossible parse out any identifying information regarding the donors. As the analyses conducted on any urine samples were solely related to water quality coupled with the anonymous donation and preparation methods, all data was completely de-identified with regards to donors.

### 1.2 Benchtop Investigation

### 1.2.1 Experimental Design and Plan

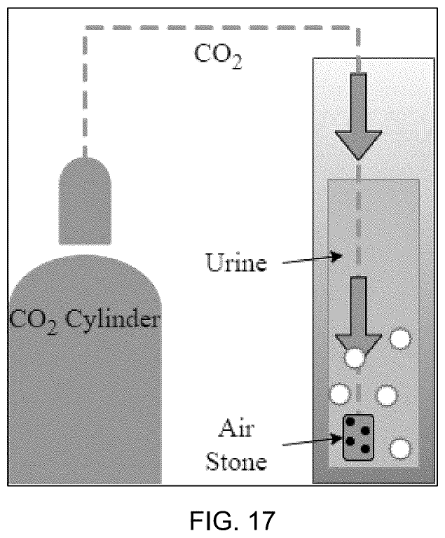

A series of benchtop experiments were conducted to assess the feasibility of carbonation to condition the pH of the urine for SAMBR. With the experiments and setup summarized in Table 4 and FIG. 17, respectively. A cylindrical container was filled with 0.5 L of hydrolyzed urine and a 15 mL sample was taken. Industrial-grade carbon dioxide was delivered to the urine through a fine diffusion air stone at the bottom of the container. The flowrate was controlled by a mechanical flowmeter. The urine was carbonated for one hour, after which the carbonation was stopped, and a second 15 mL sample was taken. The carbonated urine was left to rest for an additional 23 hours, for a total of 24 hours, and a third and final 15 mL sample taken. This experiment was conducted at three different volumetric flowrates of carbon dioxide: 1, 5, and 10 liters per minute (LPM). pH was the primary metric under consideration but COD, AN, and alkalinity were measured to analyze any other potential effects such as increasing alkalinity by carbonate species formation or soluble nitrogen reduction by ammonium bicarbonate precipitation.

As a control group, three containers of urine were setup: one that was left to sit without external inputs of any kind (stagnant), one that was stirred continuously with a magnetic stir bar and stir plate (agitated), and one that was subjected to aeration at a flowrate of 1 LPM using an identical fine diffusion air stone.

TABLE 4
Urine carbonation experimental setup.

| Time Sample | CO₂ Delivery | |
|---|---|---|
| Taken (hr.) | Rates Tested (LPM) | Controls |
| t = 0 | 1 | Stagnant |
| t = 1 | 5 | Agitated |
| t = 24 | 10 | Aerated |

### 1.2.2 Results and Discussion

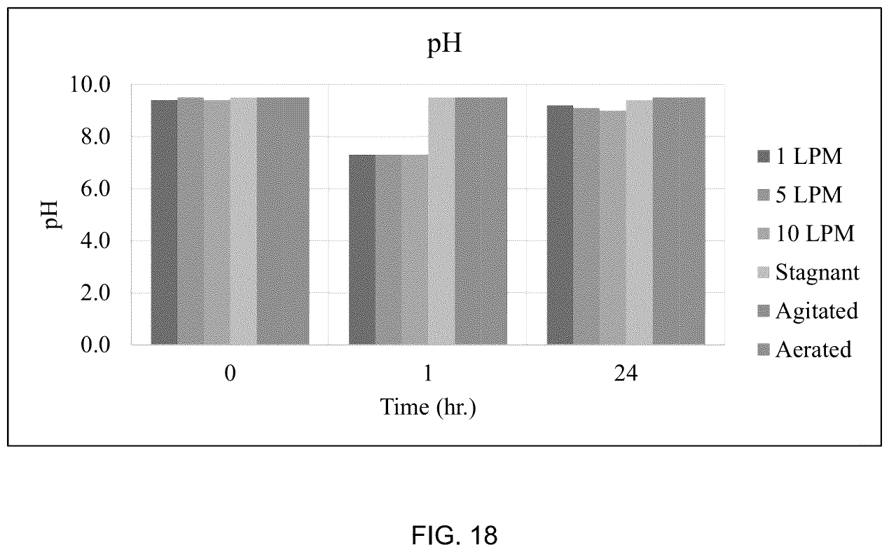

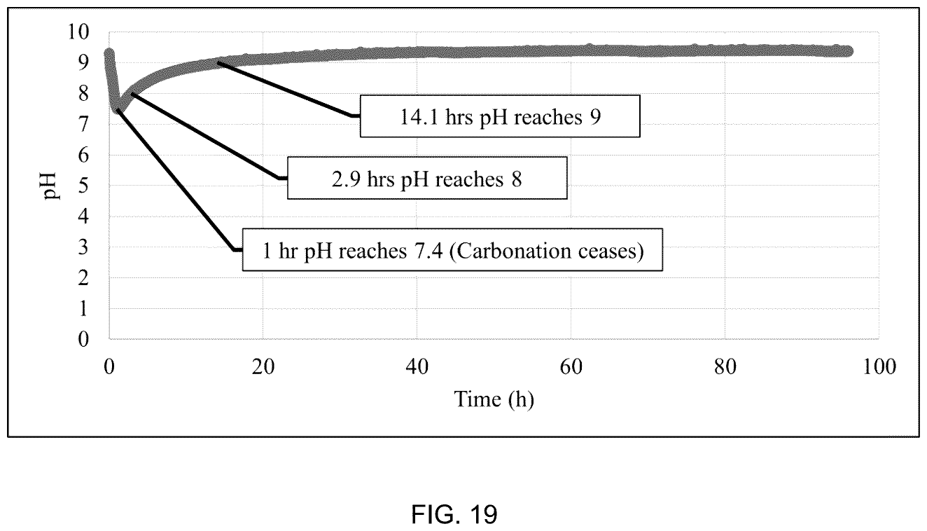

All three carbonation rates were capable of reducing the urine pH approximately from 9.5 to 7.5 which is in the optimal range for biological treatment (FIG. 18). The pH of all three of the controls were consistently around 9.5, supporting that the pH reduction is correlated to the introduction of carbon dioxide. However, at the 24-hour mark (23 hours after carbonation ceased) the pH of the carbonated samples had almost returned back to their original pH value. While the carbon dioxide appears to have dissolved, it seems to almost immediately begin to off-gas in a matter of hours. To better investigate the off-gassing behavior, the experiment was repeated at a 1 LPM carbonation rate with a continuous logging of pH and is displayed in FIG. 19. Immediately, after carbonation ceased, the pH began to rebound and appears to follow a logarithmic trend. At 1.9 and 13.1 hours after carbonation ceased the pH reached 8 and 9 respectively and eventually leveled off back to 9.5, indicating that all carbon dioxide had off gassed.

Though there is some variation in COD of the samples throughout the experiment, the variation is minimal and unlikely to be significantly impacted by the carbon dioxide. There is the possibility of effects not captured by COD such as breaking down complex organics and would not be detected as a change in COD but would require deeper investigation. The COD values of the carbonated samples are significantly lower than the control or what would be expected of hydrolyzed urine (˜10,000 mg/L). As the urine is not sterile, the decrease in pH of the carbonated samples to more ideal levels possibly restimulated biological activity and degradation of COD compared to the control samples.

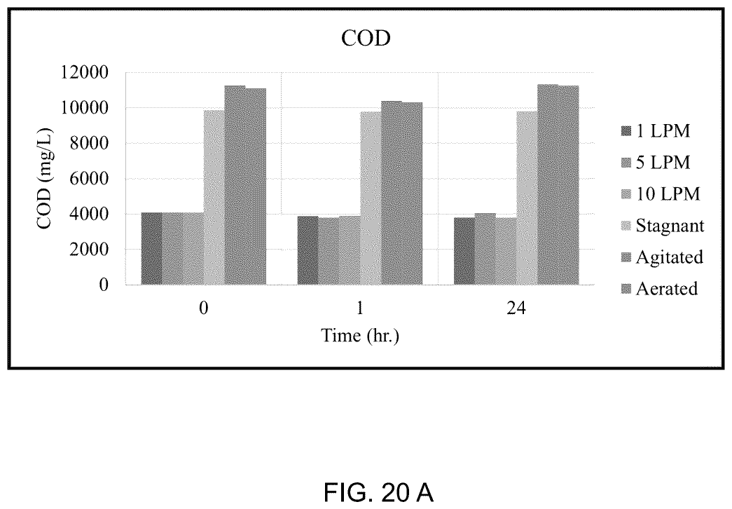

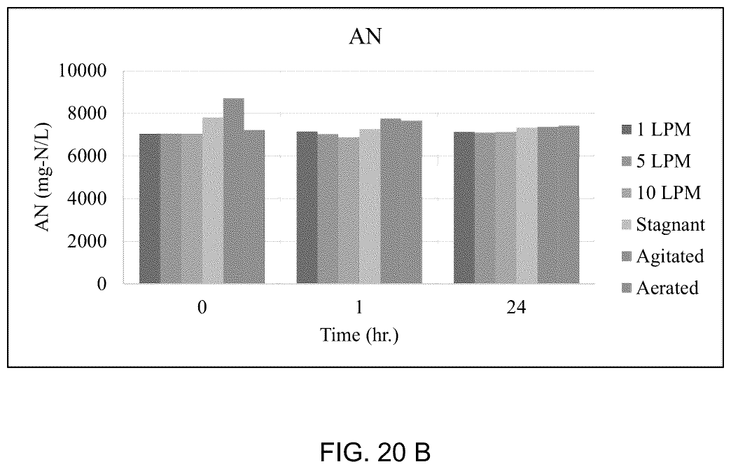

The effect of carbonation on the ammonia nitrogen species is not readily apparent as similarly to COD, there is minimal variation between all samples, with the exception of the agitated control sample which has a slightly higher starting concentration that declined throughout the experiment (FIG. 20). This could be attributed to the high pH that maintained the dominant species as ammonia (instead of ammonium at lower pH) which likely also off gassed as the containers were all sealed after carbonation but was accidentally left unsealed for the agitated sample.

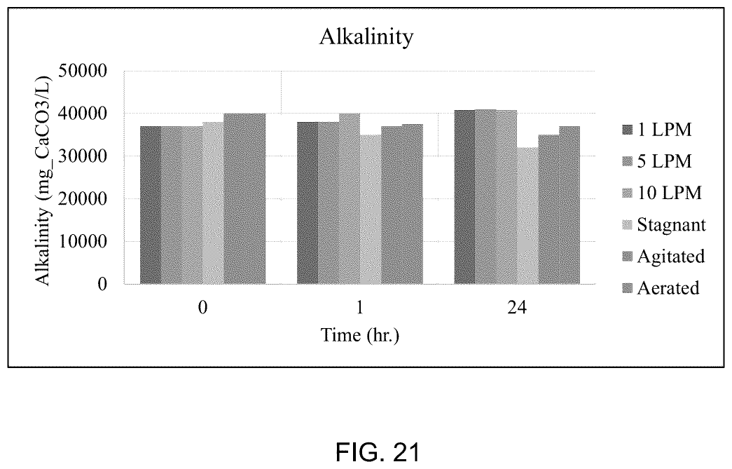

There did not appear to be any precipitation of any solids such as ammonium bicarbonate that would have resulted in a decrease in soluble ammonia nitrogen. Precipitation requires saturation of constituents and while at a high concentration, the combination of ammonium and carbonate species may not be at saturation. There is a slight increase in alkalinity of the carbonated species (FIG. 21) indicating some of the dissolved carbon dioxide converted to carbonate. The opposite seems to have occurred for the control samples as there is a slight decrease, indicating some existing carbonate species may have converted and off gassed.

While additional benefits, such as AN removal via precipitation, were inconclusive, the use of carbon dioxide was shown to be effective at reducing the pH of urine. However, the pH reduction effect is limited to a few hours and would require the immediate treatment of the urine by the SAMBR system.

### 1.3 Carbonation Column

### 1.3.1 Design and Development

A full-scale system would need to continuously maintain the reduced pH by continuously carbonating the urine and then deliver it to the SAMBR system on demand so that it is immediately introduced into SAMBR. Under ambient conditions, carbonating continuously at 1 LPM would require approximately 3 kg of carbon dioxide per day. The Baseline Values and Assumptions Document (BVAD, Anderson 2015, Table 3.22) lists the average carbon dioxide generated by a crew member as 1.04 kg per day, making the generation rate for a crew of four: 4.16 kg per day. The crew generation exceeds the demand to continuously carbonate, indicating this would be a sustainable source of carbon dioxide without the need to bring additional.

The design of the carbonation module needed to be compatible with ECLSS hardware design constraints, primarily in terms of dimensions. Simultaneously, the module needs to be optimized for maximum contact time and mass transfer. A cylindrical column of PVC pipe was fabricated with an inner column of small diameter PVC pipe to serve as a concentric baffle, termed as a “tube 'n tube” design, displayed in FIG. 5B.

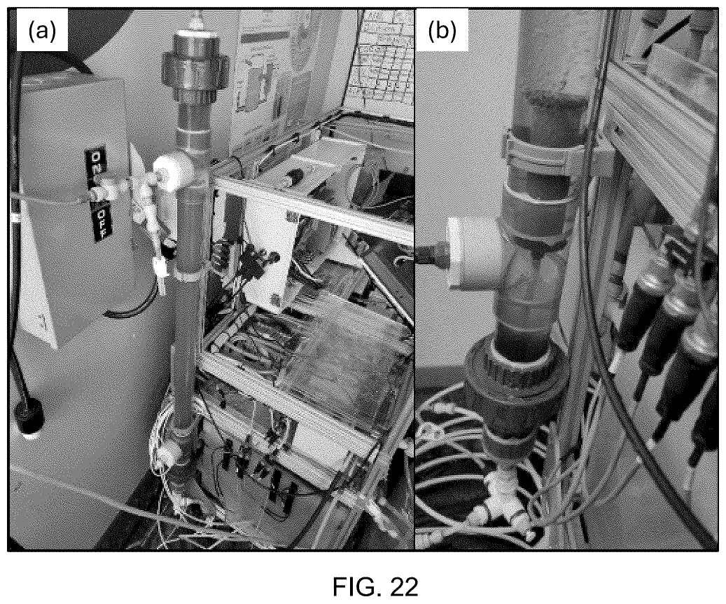

The urine/flush influent was fed through the top of the module, directly into the inner column. As more influent entered the column, hydrostatic pressure drove the influent out and around bottom of the inner column where it would rise to the top of the outer column and exit through a port near the top to enter the SAMBR system. Gas cylinders of carbon dioxide supplied the carbonation through a fine diffusion stone at the bottom of the inner tube. The fine bubbles of carbon dioxide rise, countercurrent to the influent, to the top of the inner column and out the top of the module. The excess carbon dioxide and stripped gasses were routed to the feed tank that provided the influent to the module, this was done to provide upstream carbonation to the influent even before entering the module and maximize the use of the carbon dioxide. The active volume of the column ranged between 1-2 L to allow for concentrated carbonation and quick delivery of the carbonated influent to the SAMBR system. A dye test confirmed the assumptions of this design, and the module was assembled and finalized (FIG. 22). The module was integrated into the SAMBR system during later stage testing and the performance of the module discussed in Example 3.

### Example 2 Hygiene Graywater Conditioning

Unlike the hygiene graywater onboard the ISS, data and information of future hygiene graywater is speculative and subject to change. Estimates regarding the inputs, generation rates, and characterization of hygiene graywater under EPB/PGH scenarios have been made. Hygiene facilities are expected to be established. However, water rationing, and the capabilities of these facilities have yet to be determined with any degree of certainty (Muirhead et al., 2023; Muirhead et al., 2022b). The most fundamental and necessary may only be available in initial missions, while capabilities such as shave and laundry may not be available until a more mature environment is achieved. Water availability will determine the volume, available frequency, and waste streams characteristics.

As the SAMBR technology is intended for EPB/PGH scenarios, the incorporation of these future waste streams needs to be investigated. To fit within the scope of this dissertation, the handwash and shower streams were assessed for their potential effects of incorporating hygiene graywater with SAMBR. The selection of the handwash and shower streams was justified as being more critical compared to oral and shave. The handwash and shower constitute a large fraction of the hygiene graywater waste streams compared to the oral and shave, while laundry may not be incorporated until much later. Additionally, the handwash and shower streams are planned to use a similar modified commercial surfactant blend termed, ISS No-Rise, currently used onboard the ISS, simplifying the ability to generate these ersatz streams.

The No-Rinse is a surfactant blend, potential for foaming within SAMBR were known to be a possibility and may be necessary to address. Preliminary testing confirmed that foaming was substantial and would result in foam escaping the SAMBR system. Foaming is a common problem even in terrestrial wastewater treatment and has been studied extensively (Vesga-Baron et al., 2022). One study examined the use of UV irradiation and ultrasonication of bulk foaming at a wastewater treatment facility in Mexico (Hernández-Romano et al., 2022). While UV was not observed to have any significant effect, ultrasonication was shown to be effective at reducing foam (Hernández-Romano et al., 2022). NASA has also previously invested research into use membrane filtration as a method of surfactant treatment (Cartinella et al., 2006). Similar to urine conditioning, an investigation to develop a conditioning subsystem capable of mitigating the foaming potential of the ISS No-Rinse. Literature has indicated that ultrasonication and membrane filtration have such a potential and were investigated further to condition the ISS No-Rinse for SAMBR.

### 2.1 Materials and Methods

### 2.1.1 ISS No-Rinse Preparation

Concentrated ISS No-Rinse was obtained from NASA's Johnson Space Center and stored at 4° C. in airtight containers when not in use. The concentrate was diluted with water to an approximate concentration of 0.5 g/L to achieve an ersatz handwash and shower formulation.

### 2.1.2 Sample Collection

Sample collection was conducted similar to the method described in section. 1.1.1 with the following alteration: any foaming that was generated in the ersatz was allowed to dissipate before the sample was collected. This was done as surfactants concentrate in the foam and would create a disparity in concentration distribution.

### 2.1.3 Sample Preparation and Storage

Sample preparation was conducted similar to the method described in section. 1.1.2 with the following alteration: any foaming that was generated in the ersatz was allowed to dissipate before the sample was prepared and stored. This was done for the same reason discussed in section 2.1.2.

### 2.1.4 Foaming Rate

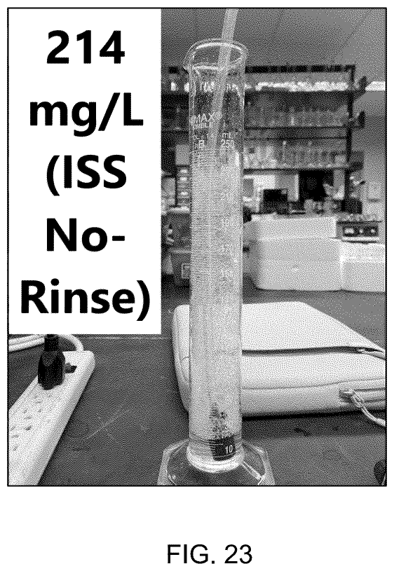

As foaming from the No-Rinse was determined to be problematic for SAMBR, a method to measure it directly was necessary. Through standard methods do exist, a custom method was developed that was informed by these existing methods. A 20 mL sample in a 250 mL graduated cylinder was subjected to aeration at a rate of 1 LPM (controlled by a mechanical flowmeter) with a fine diffusion stone. The volume of the foam and the time it took to reach it was recorded and was used to obtain a foaming rate in mL/s. The exact same equipment was used to test each sample after being thoroughly rinsed with deionized water. The setup for this method is shown in FIG. 23.

### 2.1.5 Chemical Oxygen Demand

COD analyses was conducted using the same method outlined in section 1.1.3.

### 2.1.6 Surfactant Calibration

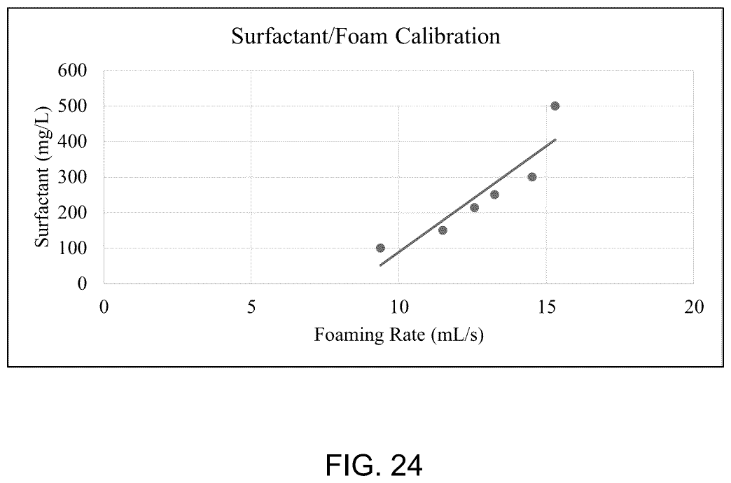

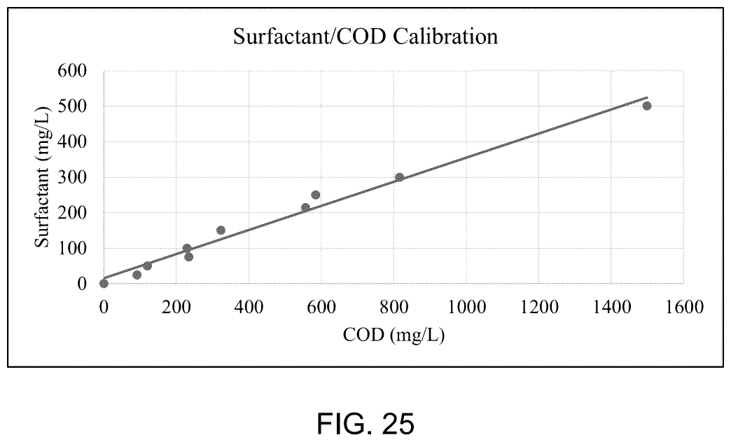

Most methods for analyzing and characterizing surfactants can be time consuming, complex, and require expensive equipment such as chromatography, spectroscopy, spectrophotometry, and tensiometers. As a simpler alternative, the foaming rate and COD were to estimate the surfactant concentration in the samples. This was done by creating a calibration between the foaming rate, COD, and surfactant concentration. From the manufacturers Safety Data Sheet (SDS) the combined ersatz handwash and shower was known to have an approximate surfactant concentration of 214 mg/L. Samples of varying concentrations were created and tested and graphed to create linear trendlines to obtain a calibration for surfactants against both foaming rate and COD. FIG. 24 shows the calibration data between surfactant concentration and foaming rate. Eqn. 2.1 shows the resulting linear equation for estimating surfactant concentration from foaming rate. With an R² value of ˜0.82, a relatively strong correlation between the surfactant concentration and foaming rate exists and can be used with a degree of confidence. Similarly, FIG. 25 similarly displays the calibration data and Eqn. 2.2 is the linear equation of estimated surfactant concentration and COD. A high R² value of ˜0.98 suggests a very strong correlation between surfactant concentration and COD and a good indicator of estimating surfactant concentration.

$${C}_{s} = 59.663 {r}_{f} - 507.65 \qquad Equation 2.1$$

$$where : {C}_{s} = estimated surfactant concentration ( mg / L )$$

$${r}_{f} = foaming rate ( mL / s )$$

$${C}_{s} = 0.3396 {C}_{COD} + 15.327 \qquad Equation 2.2$$

$$where : {C}_{COD} = COD concentration ( mg / L )$$

### 2.1.7 Transmembrane Pressure

To measure pressure differentials within the membranes used for this investigation, in line pressure transducers measured the pressure at the influent into the membrane, the concentrate that was recycled back, and the effluent that filtered through the membrane. Each transducer was individually calibrated, using a PVC tube connected to pressure gauge. A syringe was used to change the pressure and the corresponding voltage reading of the transducer at five different pressures. These five different readings were used to create a linear calibration used to calculate pressure. The pressure readings were recorded using a HOBO U30 automated data logging system. The transmembrane pressure (TMP), or the pressure difference between the two sides of the membrane that drives the filtration process is calculated by Eqn. 2.3.

$$TMP = \frac{{P}_{c} + {P}_{c}}{2} - {P}_{p} \qquad Equation 2.3$$

$$where : TMP = transmembrane pressure ( bar )$$

$${P}_{f} = feed pressure ( bar )$$

$${P}_{c} = concentrate ( retentate ) pressure ( bar )$$

$${P}_{p} = permeate ( effluent ) pressure ( bar )$$

The flux of a membrane is defined as the volumetric flowrate of liquid that passes through the membrane per the surface area of the membrane (Eqn. 2.4),

$$J = \frac{{Q}_{p}}{{A}_{m}} \qquad Equation 2.4$$

$$where : J = membrane flux ( L / {m}^{2} / hr . , LMH )$$

$${Q}_{p} = volumetric flowrate of permeate membrane effluent ( L / hr . )$$

$${A}_{m} = total membrane surface area ( {m}^{2} )$$

The specific flux (permeability) which is used to determine the integrity and effectiveness of the constructed membrane module is defined in Eqn. 2.5:

$${J}_{s} = \frac{J}{TMP} \qquad Equation 2.5$$

$$where : {J}_{s} = specific membrane flux ( L / {m}^{2} / hr . / bar , LMH / bar )$$

2.1.8 pH

pH measurement was conducted using the same method outlined in section 1.1.5.

### 2.1.9 Temperature

Temperature was measured with commercially available thermometers.

### 2.2 Benchtop Investigation

### 2.2.1 Ultrasonication

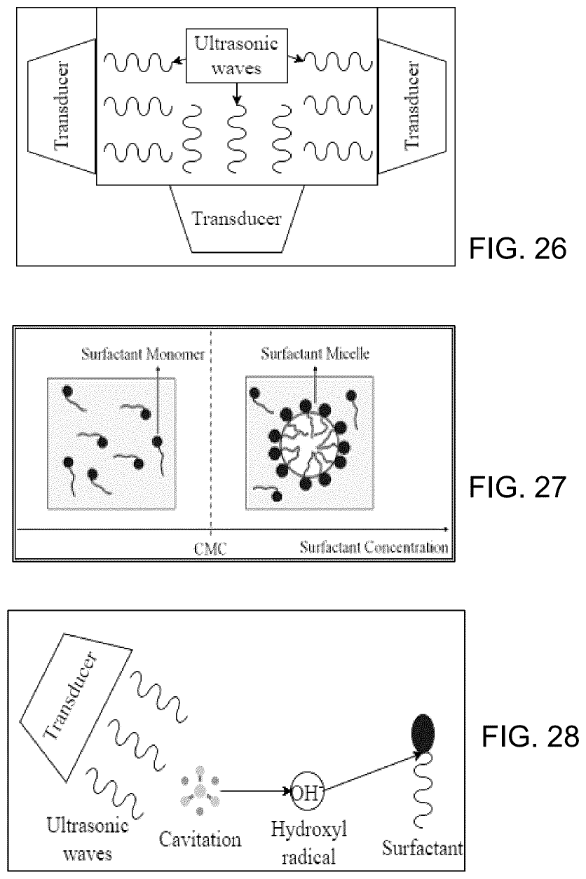

Fundamentally, sonication is the generation of sound energy typically to achieve disruption or agitation. Transducers convert the electrical input to high frequency mechanical vibrations by utilizing the piezoelectric effect (Allam et al., 2022; Sultanova et al., 2021). The high frequency waves are then often amplified to create ultrasonic waves directed at the target medium effect (Allam et al., 2022; Sultanova et al., 2021). The frequency is typically determined by the electrical signal and input to the transducer. In the case of a bath type system, transducers typically line the exterior sides and bottom of the bath and are covered by the external housing of the unit similar to that of FIG. 26.

Ultrasonic frequencies are typically considered anything over 20 kHz (Sajwan et al., 2018). In the case of the ultrasonic bath, the multi-directional waves create cavitation in the solution (Nie et al., 2021; Wang et al., 2018). These small, implosive bubbles momentarily create such drastic localized temperature and pressure that water dissociates into hydrogen and hydroxyl radicals as shown in Rxn. 2.1 (Nie et al., 2021; Wang et al., 2018). Both radicals have oxidizing potential but the hydroxyl radical's potential is greater and commonly used in Advanced Oxidation Processes (AOPs) to degrade organics, pathogens, and contaminants in wastewater treatment (Dong et al., 2022).

Water Dissociation: H₂O⇔H·+OH· (2.1)

As the input(s) required is typically just power, this makes it an ideal candidate for sustainable space applications. (Powell et al., 2021) previously proposed ultrasonic drying of fecal matter as a method of extracting water in space applications. The use of sonication for the treatment of surfactants has been extensively studied and shown to be effective when the surfactant concentration is below the Critical Micelle Concentration (CMC) (Dehghani et al., 2019; Jabariyan & Zanjanchi, 2012; Lin et al., 2016; Weavers et al., 2005). The CMC of a surfactant or blend of surfactants is the concentration at which surfactants form together with their hydrophilic heads directed outward and their hydrophilic tails tucked into the center. This collectively alters their properties and in the case of ultrasonication makes them significantly more resistant to inactivation. FIG. 27 visualizes the formation of micelles as surfactants reach CMC. FIG. 28 shows the theoretical chain effect of ultrasonication creating cavitation, consequently creating hydroxyl radicals that are capable of inactivating surfactant monomers.

As no conclusive CMC data of the ISS No-Rinse, including from the manufacturer, was available, experimental testing of ultrasonication was necessary to investigate its capability to inactivate the surfactants present at the typical concentration of ISS No-Rinse. (Lin et al., 2016) and (Dehghani et al., 2019) both subjected surfactants to sonication up to 120 minutes. To mimic this, ISS No-Rinse was subjected to sonication for 180 minutes with samples taken every 30 minutes. A commercial ultrasonic cleaning bath was used with the specifications and experimental conditions listed in Table 5.

TABLE 5
ISS No-Rinse ultrasonication specs and experiments.

| Ultrasonication Bath Specs | | Time Sample Taken (min.) |
|---|---|---|
| Active Volume (L) | 10 | 0 |
| Sonication Power (W) | 480 | 30 |
| Frequencies | 28/40 | 60 |
| Available (kHz) | | 90 |
| | | 120 |
| | | 150 |
| | | 180 |

While the foaming rate and surfactant correlation has a lower R² value it likely is a more accurate representation as it is possible that any inactivation of the surfactants by sonication (i.e., cleaving the surfactant monomer) may still result in a similar COD measurement. The foaming rate/surfactant correlation would likely capture this change.

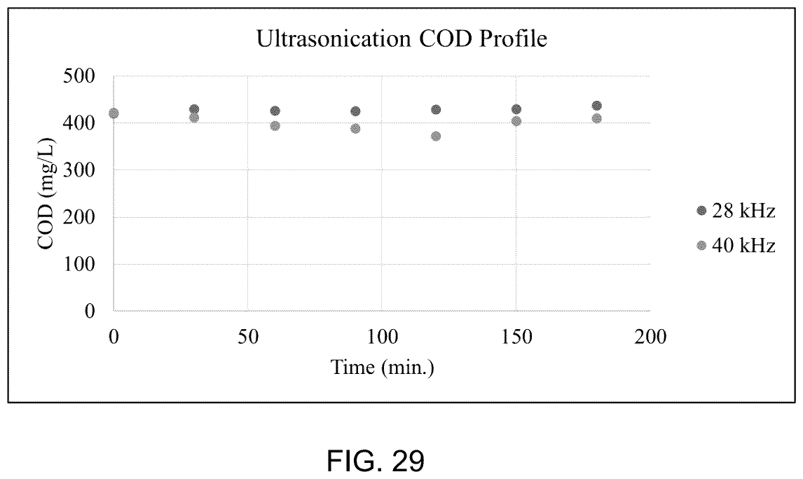

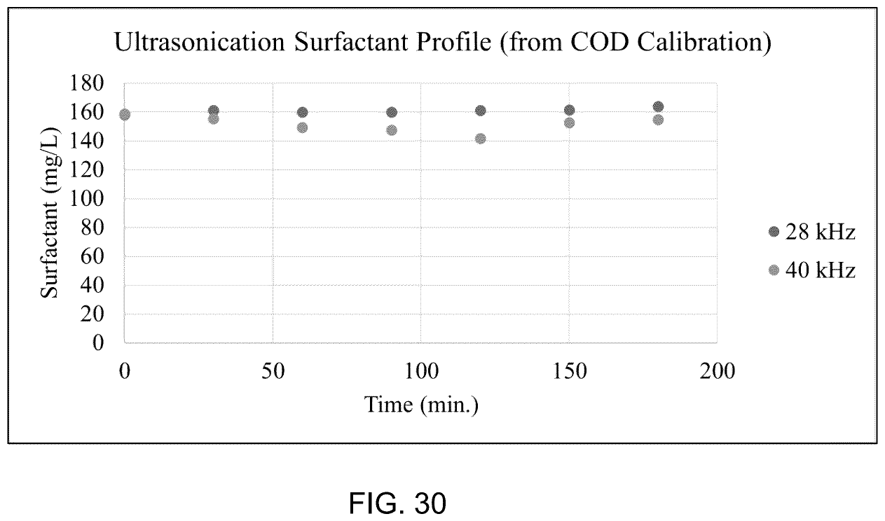

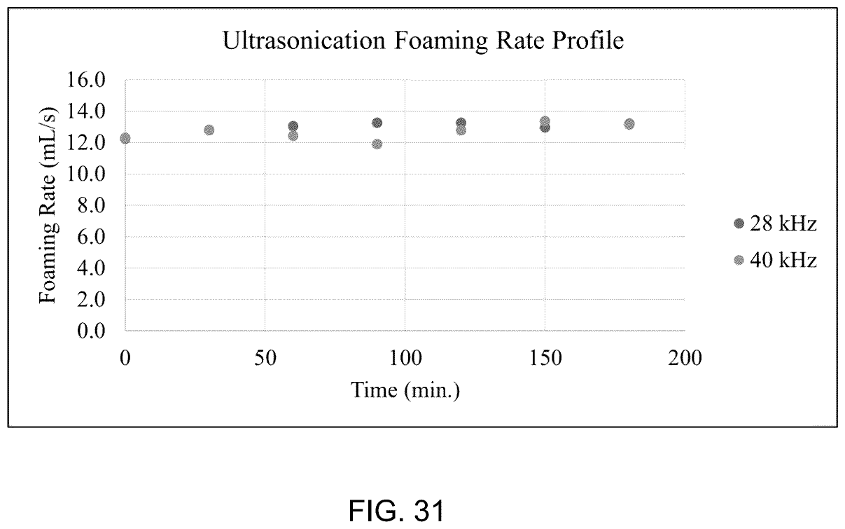

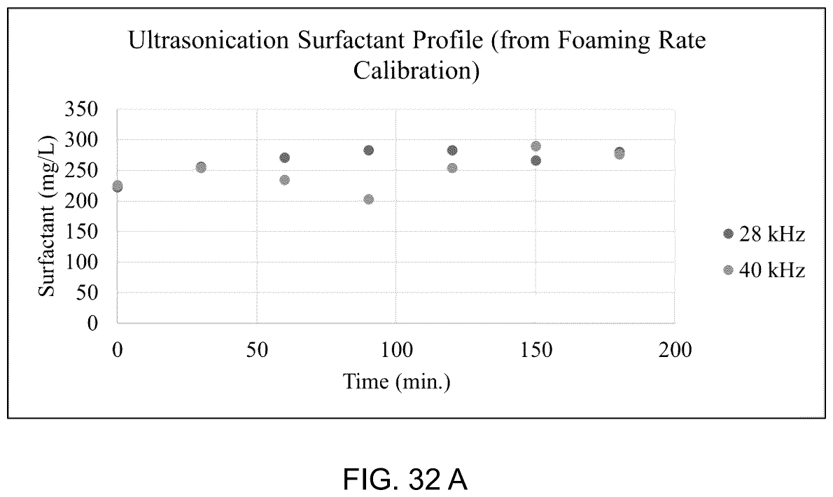

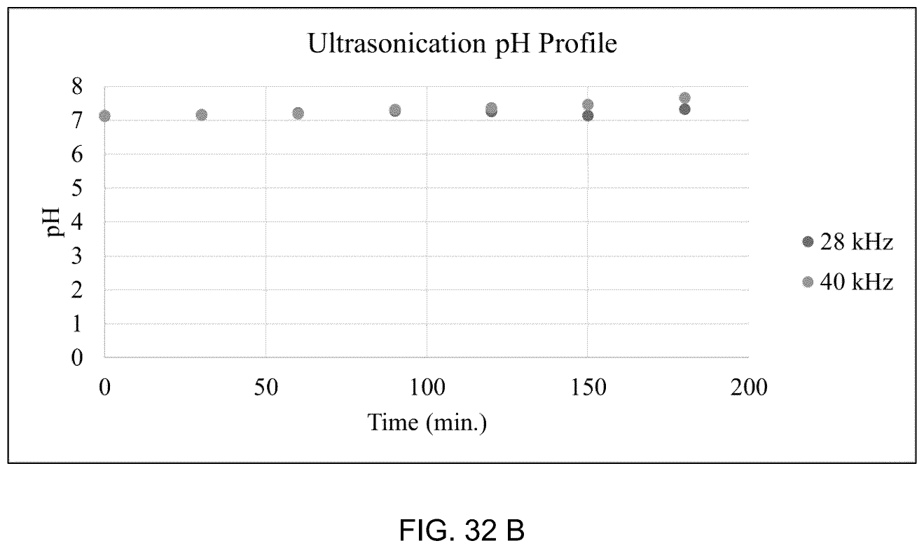

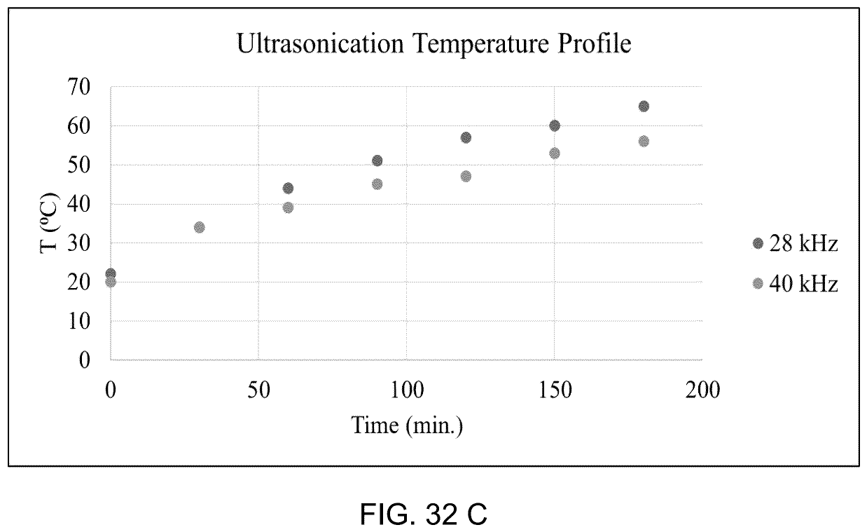

For the COD, foaming rate and correlating surfactant concentrations (FIGS. 29 and 30) there appears to be insignificant changes at 28 kHz indicating that ultrasonication at this frequency is ineffective. However, the lack of significant change could also be attributed to insufficient sonication power relative to the volume treated or the surfactant concentration is at or above the CMC resulting in micelles which are largely unaffected by sonication. At 40 kHz (FIGS. 31 and 32A), a slight dip in the middle of the experiment is observed for the COD, foaming rate and correlating surfactant concentrations returns to starting levels by the end of the experiment. Possible variations in the distribution of cavitation bubbles could result in a variable surfactant distribution and be reflected as a dip in the COD/surfactant estimation. This can lead to a more effective breakdown or modification of surfactant molecules, reflected as a dip in the COD/estimated surfactant concentration. After sonication ceased, the surfactants quickly redistribute, resulting in an apparent recovery of the COD/estimated surfactant concentration. This dip could also be attributed to variability or error inherent in the analytical process.

The pH remained relatively steady around 7.2 for 28 kHz but rose from roughly 7.1 to 7.7 for 40 kHz. (FIG. 32 B) The hydroxyl radical is more likely to react with contaminants but if the ISS No-Rinse is at or above the CMC, it may be unable to react with the micelles. The solution was prepared with deionized water (DI) which may result in little to no constituents available for the radical to react with. The hydrogen radical has the potential for a few different reactions such as forming hydroperoxyl radicals (Rxn. 2.2), hydrogen (Rxn. 2.3), or hydrogen peroxide (Rxn. 2.4). The consumption of these hydrogen radicals and the lack of available reactive species for hydroxyl radicals could potentially result in an increase in pH. This could have occurred under both frequencies but only at a great enough rate at 40 kHz to make a measurable difference.

Hydroperoxy Radical Formation: H·+O₂⇔HO₂· (2.2)

Hydrogen Formation: H·+H·⇔H₂ (2.3)

Hydrogen Peroxide Formation: H·+HO₂·⇔H₂O₂· (2.4)

The temperature rose steadily at both frequencies and is expected as the cavitation produced by ultrasonication would increase the temperature. (FIG. 32C) The temperature remains consistently higher at 28 kHz than at 40 kHz which may be attributed to the frequency. A lower frequency possesses a longer wavelength, which can lead to more effective pressure differentials. This can result in more vigorous and larger cavitation bubbles, leading to higher energy dissipation as heat.

The main metric to assess the change in surfactant and foaming potential was the foaming rate method developed for this experiment despite having a looser correlation compared to the COD as the foaming was a more direct measurement. For this experiment the COD method was potentially more subjective to interferences such as cleaved surfactant monomers still being captured by COD measurement. In either case there was minimal change observed in both methods, indicating that ultrasonication is ineffective at inactivating the surfactants in the ISS No-Rinse. The surfactants at the prepared ISS No-Rinse concentration are likely at or above the CMC and could be why no change was observed. The rise in temperature up to 65° C. could potentially be beneficial for the biological consortia in SAMBR as (Baghchehsaraee et al., 2008) found that activated had increased hydrogen production and growth yields at 65° C. compared to untreated activated sludge. The minor pH increase individually may not be problematic but coupled with the complications of the high urine pH it may be necessary to address if it were to be implemented. Further research into this would be necessary to find out to what extent the pH and possibly alkalinity would change with sonication. During testing, the ultrasonic bath emitted a rather loud and unpleasant noise that resulted in a noise dampening container placed over it when the system was operating. The nominal sound generation in the laboratory was measured to be 63 dB. When under operation the ultrasonication system was measured to be 90 dB and 72 dB when uncovered and covered at 12 inches, respectively. This is in line with noise generated by other ultrasonic devices which measured from 60-97 dB (Khirnykh et al., 1999). Aboard the ISS, astronauts are required to use ear protection when exposed to sounds exceeding 72 dBA during working hours and 49 dBA or less is desired during sleeping periods (Limardo et al., 2017). If such a device were to be implemented, efforts to dampen the noise generated would be necessary.

### 2.2.2 Membrane Filtration

The five primary scales of filtration are macrofiltration, microfiltration, ultrafiltration, nanofiltration, and reverse osmosis. Pores provide a physical barrier, based on size exclusion, to reject the desired constituents and selectively allow the effluent to pass through. FIG. 33 depicts the range of pore sizes that constitutes these types of filtrations and their corresponding filtration capabilities. Smaller pore sizes increase the rejection of smaller constituents and yield a higher quality effluent. However, with the smaller pore size, a larger driving force (i.e., TMP) is needed for the solution to permeate through the membrane and consequently requires more energy.

Macro-, micro-, and ultrafiltration often operate at a pressure generally up to five bar and are primarily composed of a polymeric substance (Wang & Wang, 2019). Generally used for primary treatment to remove larger constituents, these membranes are used as a pretreatment to reduce the loading for downstream nanofiltration and reverse osmosis membranes. Nanofiltration membranes operate at a slightly higher pressures ranging from two to ten bar, reject virtually all constituents barring ionic compounds, and utilize composite materials, cellulose, and acetate (Wang & Wang, 2019). Reverse osmosis, the smallest level of filtration, operate at high pressures on the scale of hundredths, resulting in a high energy demand, but retain salts and ions utilizing similar materials as nanofiltration membranes (Wang & Wang, 2019). Due to their filtration scale, they are largely used in desalination processes but generally require substantial pretreatment or additional processing including pulse flow or backwashing, to reduce loading.

Many different surfactants exist and therefore vary greatly in characteristics and size from just a few nanometers to hundreds. The formation of micelles produce a particle significantly larger than the individual monomer that it is composed of. For example, (Wang et al., 2013) found that polyfluorinated-2-dodecenyl (3-sulfate) propyl dimethyl ammonium (PDSPDA) formed micelles 25.45±3.74 nm in diameter, over 600% larger than individual monomer (˜4 nm). The high variation in surfactant size coupled with lack of comprehensive surfactant data of ISS No-Rinse makes it difficult to identify the appropriate scale of membrane filtration.

As nano- and ultrafiltration span the largest portion of potential surfactant size, these two were selected to investigate as additional methods to treat the surfactants and mitigate foaming in the SAMBR system. Table 6 summarizes the specifications (obtained from the manufacturer) of the pre-fabricated membrane modules used.

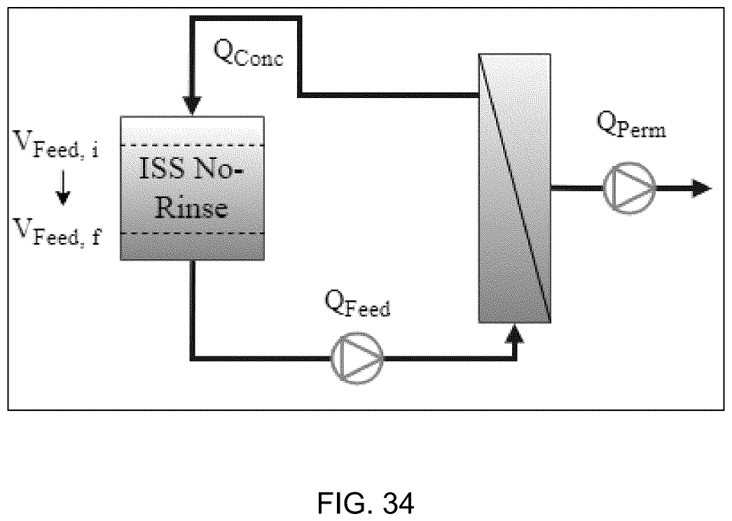

It was decided to test the membranes in batch operation for ease of setup and testing. A batch solution of ISS No-Rinse was prepared and ran continuously through the membrane until the approximate final concentration factor was achieved (FIG. 34). The concentration factor describes the concentration in the feed solution relative to how much solution has passed through the membrane and is defined by Eqn. 2.6.

TABLE 6
Specifications of membranes used in benchtop studies.

| Name | Pentair 33V Helix | Pentair HF RX300 |
|---|---|---|
| Filtration Type | UF | NF |
| Membrane Type | Tubular | Hollow Fiber |
| Avg. Pore Size (μm) | 0.03 | 0.002 |
| MWCO (Da) | 150,000 | 1,000 |
| Max TMP (bar) | 2.5 | 3 |
| SA (m²) | 0.055 | 0.113 |

$$C = \frac{1}{1 - Recovery} \qquad Equation 2.6$$

$$where : CF = concentration factor$$

$$Recovery = permeate volumetric flowrate / feed volumetric flowrate$$

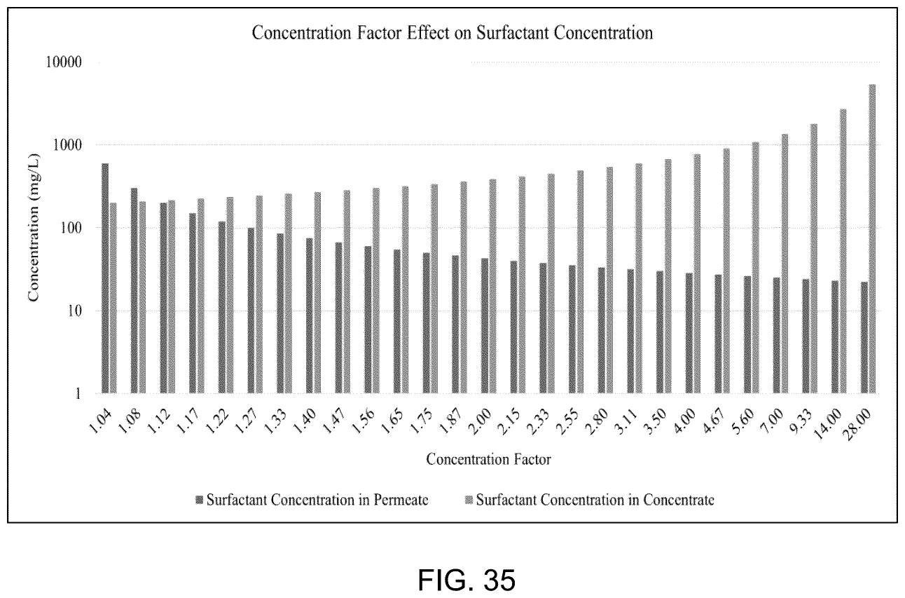

The target concentration factor of 28 was chosen based on the 28 L/d of handwash and shower generated by a crew of four. FIG. 35 displays the estimated surfactant concentration in the permeate and concentrate over various CFs. The surfactant concentrations were estimated assuming a membrane filtration of sufficient Molecular Weight Cut-Off (MWCO) for the surfactants present in the ISS No-Rinse. MWCO is determined by the lowest molecular weight solute the membrane is capable of rejection 90% of said solute. The incremental CFs were graphed over each liter of the 28 L generated each day. For example, with 1 L of the 28 L having permeated through the membrane, the resulting CF was 1.04 and then 1.08 for 2 L of 28 L and so on. During each filtration experiment, operation was temporarily paused to obtain samples approximately at CFs of 1, 7, 14, 21, and 28.

### 2.2.2.1 Ultrafiltration

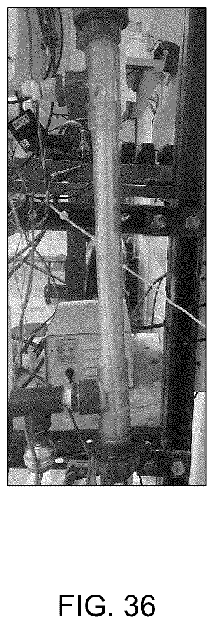

FIG. 36 Shows the testing setup for the UF membrane. A 4 L solution of the ISS No-Rinse was recirculated through the membrane with a permeation rate set to mimic the 28 L/d handwash and shower generated by a crew of four.

Transducers were used to measure the feed, concentrate, and permeate pressures of the membrane and prepared as described in section 2.1.7. Eqns. 2.7-2.9 are the resulting calibration equations.

$${P}_{feed} = 0.3805 {V}_{feed} - 1.139 \qquad Equation 2.7$$

$$where : {P}_{feed} = feed pressure of membrane ( bar )$$

$${V}_{feed} = voltage measured by pressure transducer at the feed of the membrane ( V )$$

$${P}_{concentrate} = 0.3585 {V}_{concentrate} - 1.0281 \qquad Equation 2.8$$

$$where : {P}_{concentrate} = concentrate pressure of membrane ( bar )$$

$${V}_{concentrate} = voltage measured by pressure transducer at the concentrate of the membrane ( V )$$

$${P}_{permeate} = 0.3805 {V}_{permeate} - 1.1164 \qquad Equation 2.9$$

$$where : {P}_{permeate} = permeate pressure of membrane ( bar )$$

$${V}_{permeate} = voltage measured by pressure transducer at the permeate of the membrane ( V )$$

Both correlations between foaming rate, COD, and surfactant are applicable in filtration as the removal of surfactants by filtration should be captured by both foaming and COD measurements. However, as the foaming rate/surfactant correlation has a lower R² value it is likely to have larger area and less reliable compared to the COD/surfactant correlation.

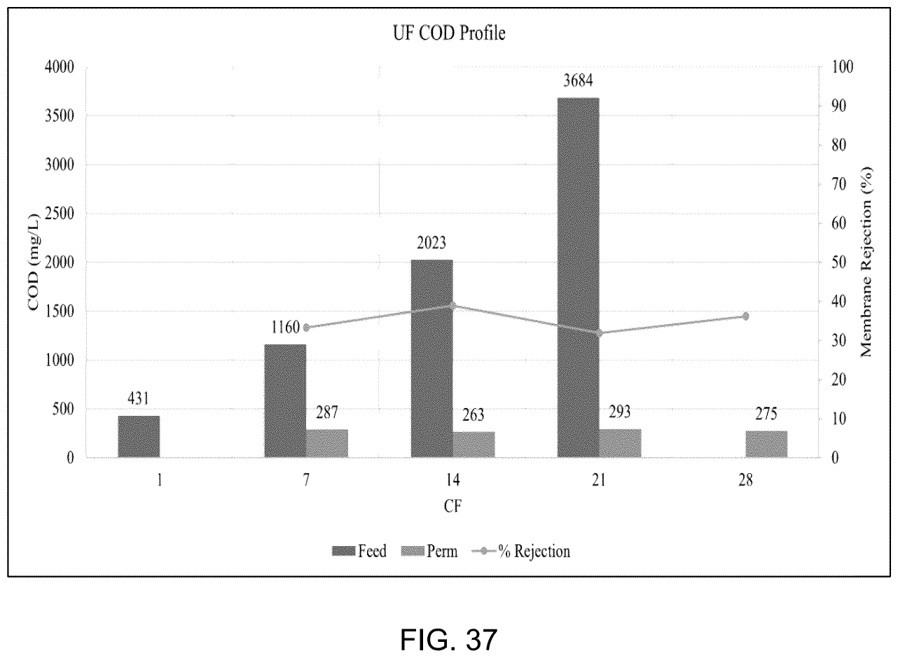

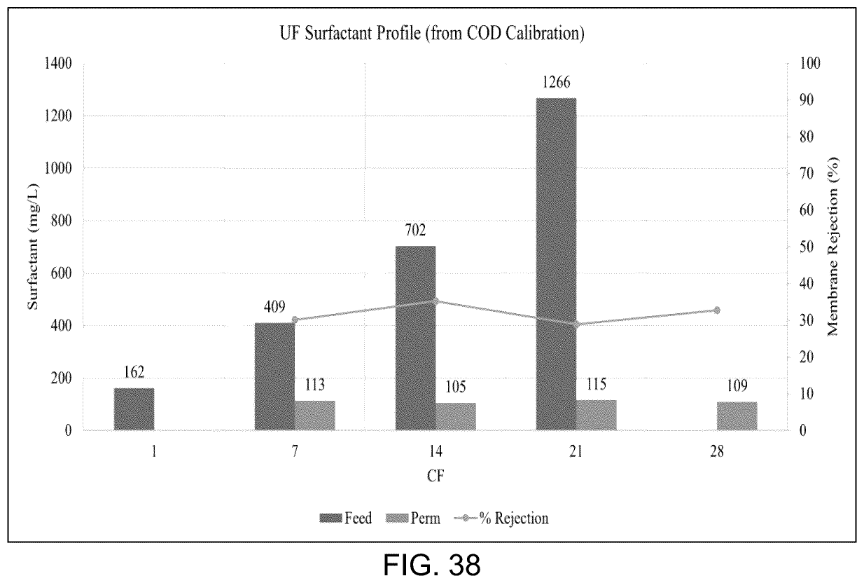

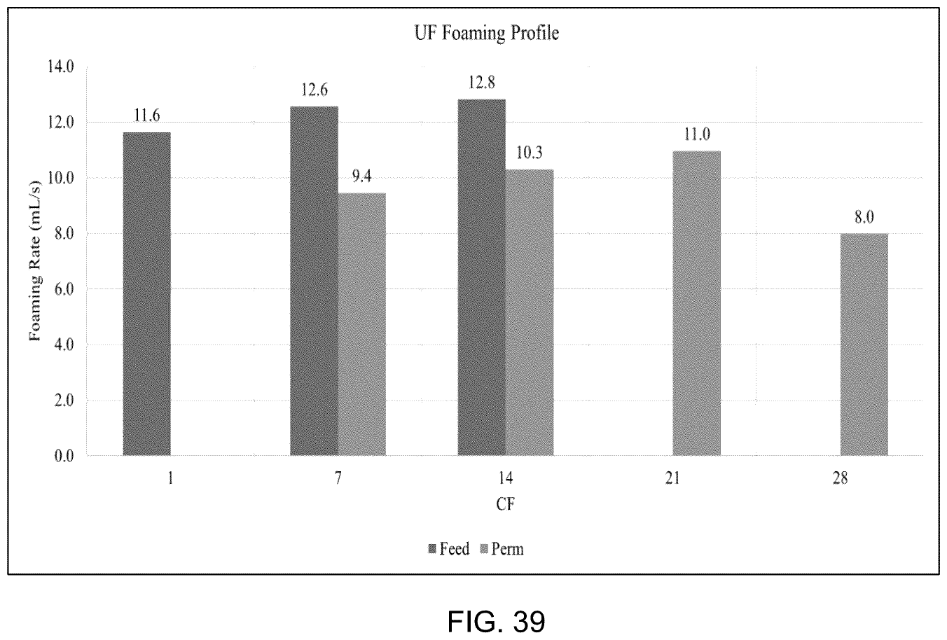

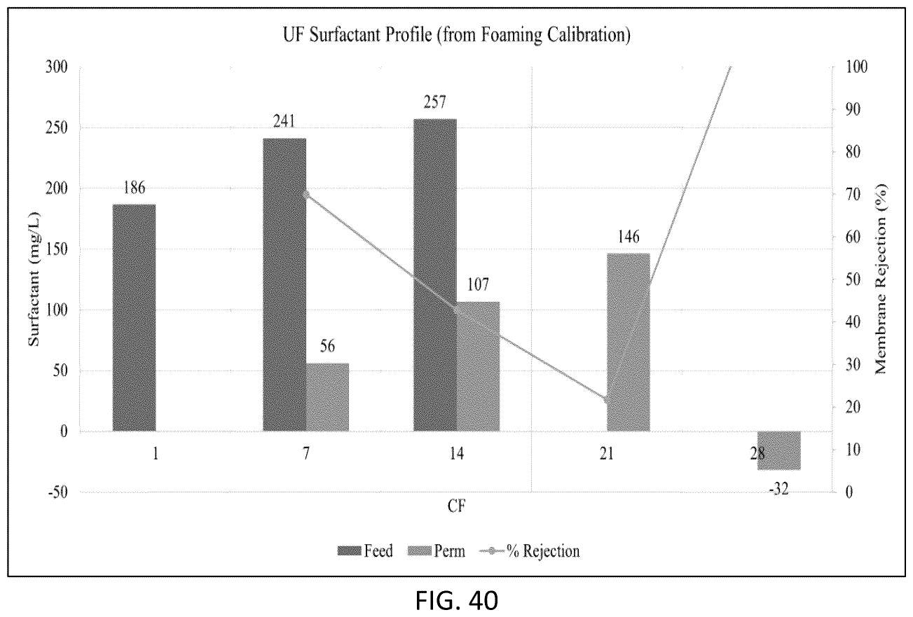

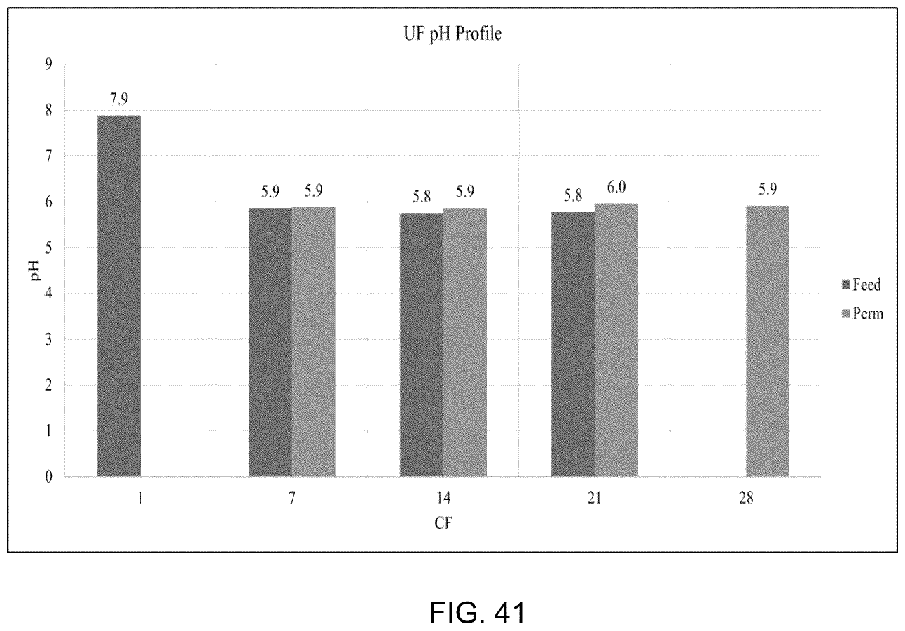

A reduction of COD and correlating surfactant concentrations is observed (FIGS. 37 and 38). The permeate sample tested at each CF is consistently lower than its counterpart feed sample which increases in concentration as the membrane reject (or concentrate) is recycled back into the feed tank. a reduction as the permeate from the membrane is consistently lower than the starting feed values at a CF of 1. A similar observation can possibly be gleamed from the foaming rate and correlating surfactant concentrations but there is considerably more error. At one point the correlation results in a negative surfactant concentration and % membrane rejection of greater than 100%, indicating that it is not as reliable in this experiment (FIGS. 39 and 40).

The initial pH (the pH of the feed sample at CF 1) is slightly basic at 7.9 (FIG. 41). However, the pH of both the feed and permeate at through the rest the sampling points consistently hover around a pH of 6. As surfactants are becoming more concentrated in the feed sample and consistently low in the permeate sample, this would suggest that the surfactants have little effect on the pH or that complementary effects that lower the pH occurred in both solutions. This could include volatile compounds initially present in the solution from the manufacturer that evaporated or reacted during the agitation that occurred in operation and lowered the pH. If exposure to air, prior to testing, was incidentally kept minimal, increased exposure to atmospheric carbon dioxide might lead to dissolution, alter the carbonate species, and lower pH.

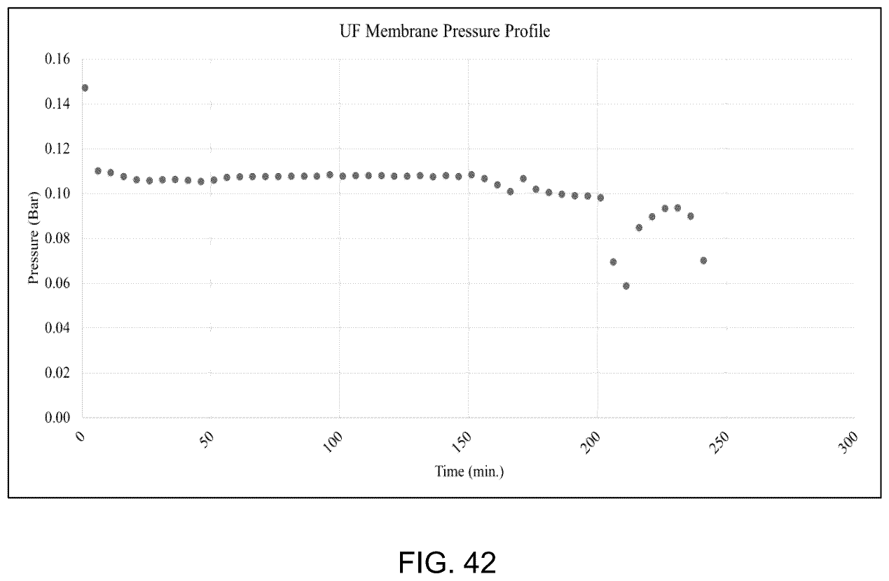

The TMP during operation averaged approximately 0.1 bar, demonstrating little strain on the membrane and minimal energy consumption. During some sampling events, the pressure logging system was forgotten to be paused and resulted in variable TMP drops observed in FIG. 42. The resulting flux and permeability of ˜21 LMH and 209 LMH/bar are well within manufacturer specifications and general operational industry standards. However, a safety factor should still be incorporated to account for fouling over time and variations in the crew generated waste. Increasing the surface area (mainly by lengthening the membranes or adding more membranes of said length and increasing the diameter of the module) to achieve a flux of 5-10 LMH should provide sufficient safety factor for continuous use on EPB/PGH scenarios.

The reduced concentration of surfactant metrics in the permeate indicates the UF membrane is capable of partial rejection of the surfactants, either as monomers or micelles, present in the ISS No-Rinse.

The highest MW ingredient, Disodium lauroampho diacetate (446 g/mol), listed in the ISS No-Rinse comprise an average 37% weight, relative to the surfactants. Considering that the membrane rejection of COD and correlating surfactant concentrations is about ⅓, the rejected solution is likely comprised primarily of Disodium lauroampho diacetate (446 g/mol). The produced permeate solution is consequently likely to be rich in the remaining lower molecular weight ingredients.

Despite the foaming reduction, sustained foaming was still observed, suggesting further investigation for UF is needed. Further testing, optimization, and possibly coupling with additional treatment may be necessary to achieve sufficient reduction for practical applications in SAMBR.

### 2.2.2.2 Nanofiltration

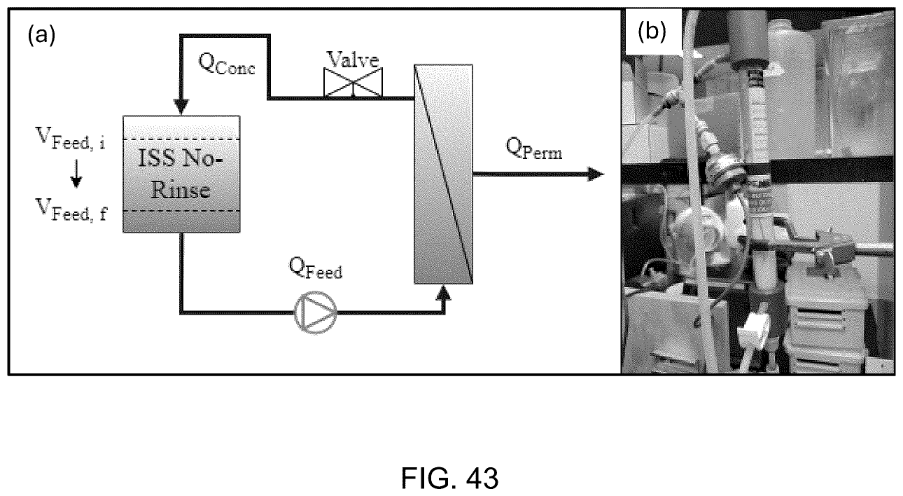

FIG. 43a Shows the testing setup for the NF membrane. A 0.5 L solution of the ISS No-Rinse was recirculated through the membrane with a permeation rate set to mimic the 28 L/d handwash and shower generated by a crew of four.

Transducers were used to measure the feed and concentrate pressures of the membrane and prepared as described in section 2.1.7. Eqns. 2.10-2.11 are the resulting calibration equations. FIG. 43b shows the difference in setup compared to FIG. 34

$${P}_{feed} = 0.3653 {V}_{feed} - 0.8253 \qquad Equation 2.1$$

$$where : {P}_{feed} = feed pressure of membrane ( bar )$$

$${V}_{feed} = voltage measured by pressure transducer at the feed of the membrane ( V )$$

$${P}_{concentrate} = 0.4351 {V}_{concentrate} - 1.2651 \qquad Equation 2.11$$

$$where : {P}_{concentrate} = concentrate pressure of membrane ( bar )$$

$${V}_{concentrate} = voltage measured by pressure transducer at the concentrate of the membrane ( V )$$

Historical operation of this research has relied on the use of a second pump to drive filtration by drawing out the permeate. However, for the testing of the NF membrane, no secondary pump was used. Instead, filtration was driven by positive feed side pressure of the membrane, with a valve at the concentrate line to control said pressure. Permeate pressure was left open to ambient conditions and a gauge pressure of 0 bar was used for Pₚₑᵣₘₑₐₜₑ.

Similarly to the UF, both correlations between foaming rate/surfactant and COD/surfactant are applicable in filtration has the removal of surfactants by filtration should be captured by measurements. However, as the foaming rate/surfactant has a lower R² value it is likely to have larger area and less reliable compared to the COD/surfactant correlation.

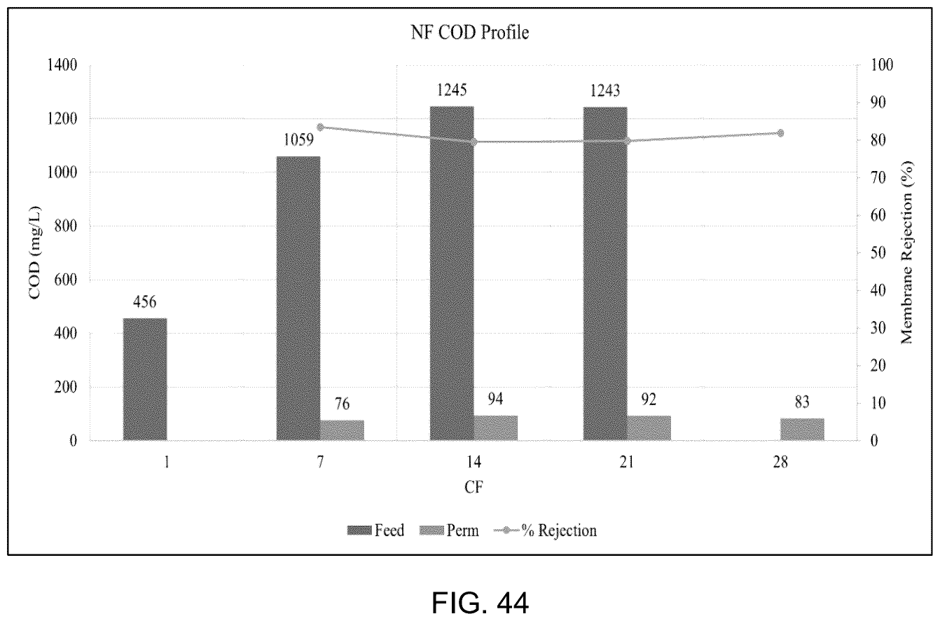

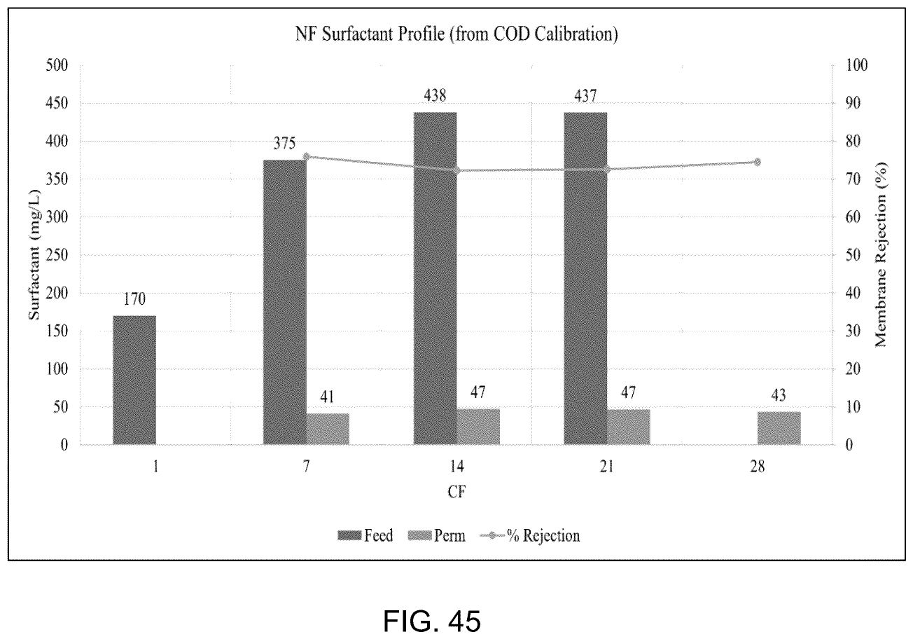

Compared to UF, a larger reduction of COD and correlating surfactant concentration is observed (FIGS. 44 and 45). The permeate sample tested at each CF is consistently low, hovering around 86 and 45 mg/L of COD and correlating surfactant respectively. The feed continuously increases in concentration as the membrane reject (or concentrate) is recycled back into the feed tank but seems to level out around 1244 and 437 mg/L of COD and correlating surfactant respectively.

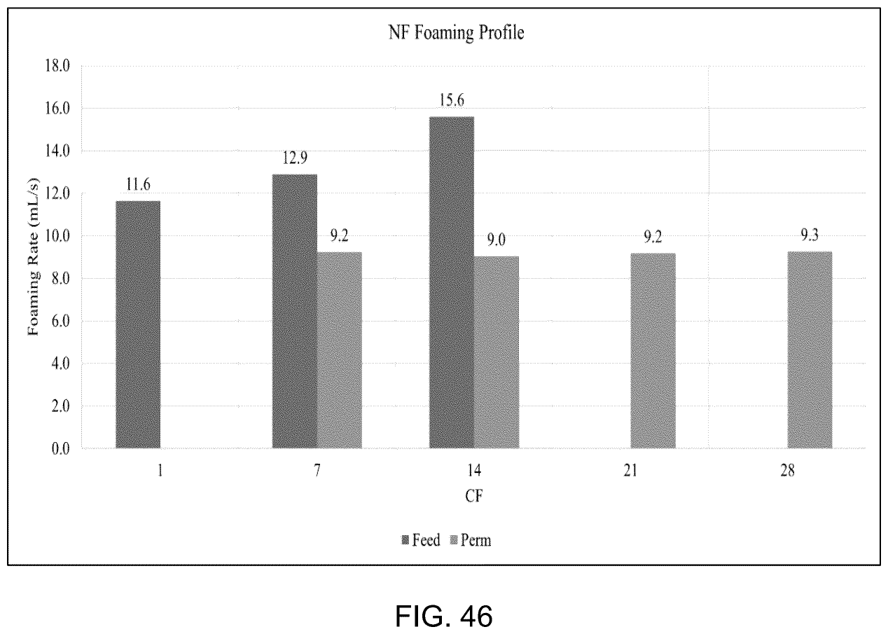

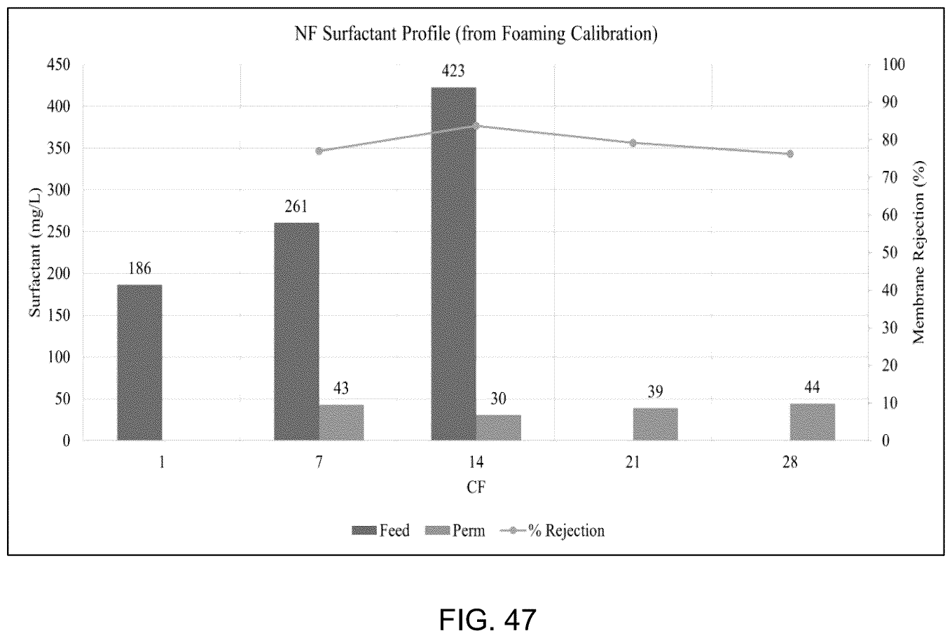

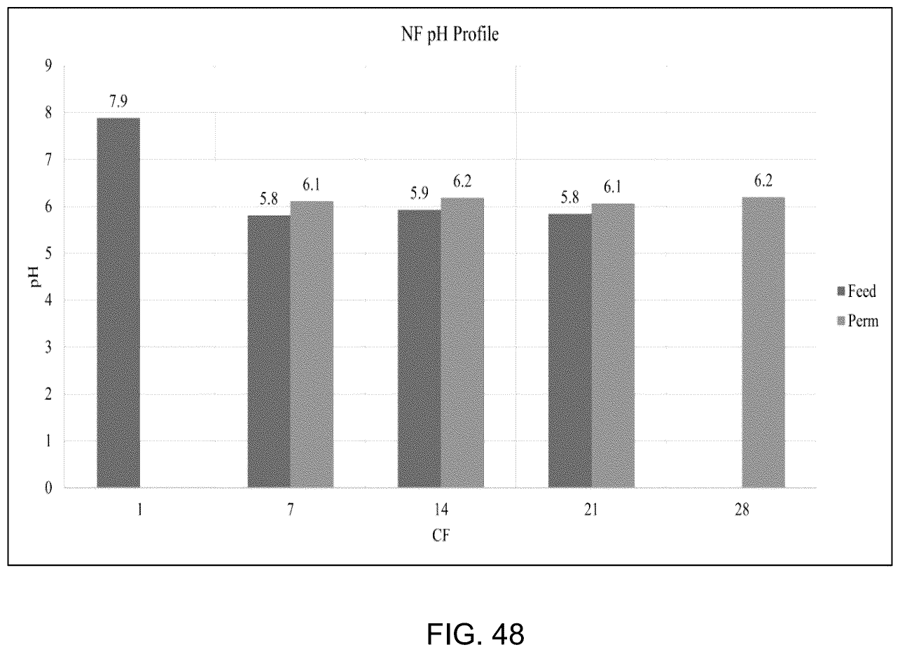

This is further supported by the foaming rate and correlation surfactant concentration (FIGS. 46 and 47). An increase in foaming rate/surfactant is observed in the feed with a low and steady profile for the permeate. It is worth noting that the foaming rate of the measure permeate samples did not capture the foaming's visual appearance. There was a much smaller degree of foaming observed that was not sustained but with the bubbles collapsing nearly as quickly as they were generated.

The pH profile was almost identical to that of the UF test, with the initial pH (the pH of the feed sample at CF 1) being slightly basic at 7.9 (FIG. 48). This is followed by a consistently lower pH (around 6) in both the feed and permeate. Both tests were operated in the same manner and were attributed to volatile compounds evaporating and/or air exposure causing these changes in both tests.

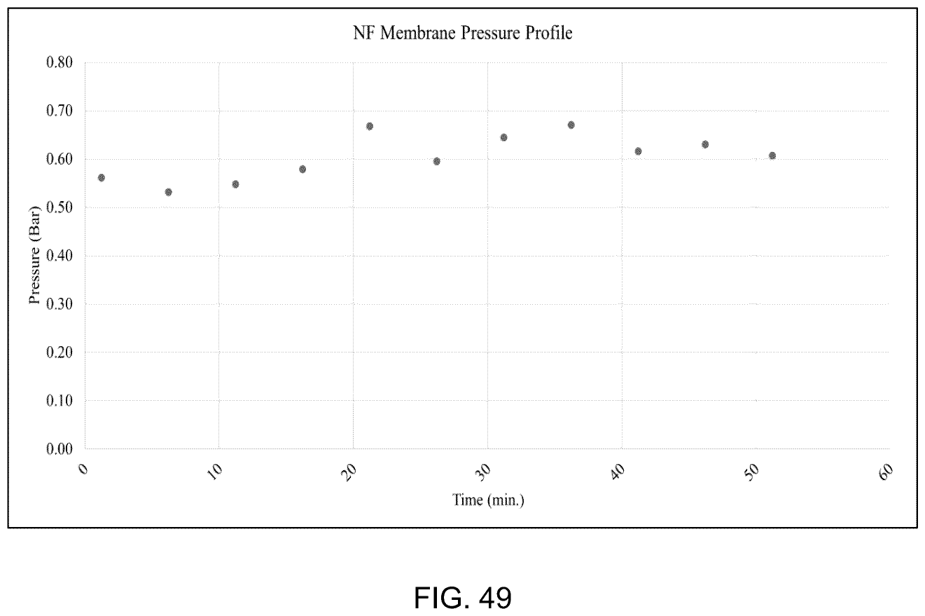

The TMP average approximately 0.6 bar, an increase in strain compared to the UF membrane, but is to be expected given the smaller pore size (FIG. 49). The batch filtration was run at a flowrate equivalent to the 28 L/d of ISS No-Rinse generated by a crew of 4 and resulted in a flux and permeability of ˜8 LMH and 13 LMH/bar respectively. The flux is within the manufacturer's specifications (<25 LMH) but the suggested operational permeability of 10 LMH/bar was exceeded. The high permeability suggests the membrane was strained. For full scale integration, a custom designed NF membrane would be necessary to increase the SA and decrease the flux with an appropriate safety factor.

The NF membrane is capable of significant rejection of the surfactants present in the solution. This is supported by a reduced concentration of foaming rate, COD, and correlating surfactant concentrations in the permeate while the feed continuously increased in concentration. This partial rejection suggests many surfactants, either as monomers or micelles, of the ISS No-Rinse large enough to be rejected by UF membrane.

The three highest molecular weight ingredients, Disodium lauroampho diacetate (446 g/mol), Sodium trideceth sulfate (STS) (435 g/mol), and Cocamidopropyl betaine (CAPB) (342 g/mol), listed in the ISS No-Rinse comprise an average 74% weight, relative to the surfactants. Considering that the membrane rejection of surfactant (from COD) is also about 74%, the rejected solution is likely comprised primarily of these three. The produced permeate solution is consequently likely to be rich in the remaining lower molecular weight ingredients.

Since visual observation of the foaming rate of the samples indicated it was that the generation was non sustained, the NF treated solution may be suitable for treatment in SAMBR without creating foaming overflow in the system. Further investigation to scale and integrate the membrane with SAMBR could prove to be a sufficient stand lone treatment for foaming reduction.

### 2.3 Discussion

The presence of surfactants in the ISS No-Rinse were determined to raise concerns regarding foaming within SAMBR. This presented a unique challenge to mitigate foaming caused by said surfactants. A review of literature revealed an array of potential technologies suitable for such an application. Ultimately, ultrasonication, ultrafiltration, and nanofiltration were down selected to as the most promising and worthy of further investigation. Benchtop experiments were carried out to assess the feasibility of each one with the results summarized in Table 7.

The observed capability of ultrasonication to reduce the surfactant concentration and the foaming rate in the ISS No-Rinse solution was not observed. Analysis revealed that at both 28 and 40 kHz, there were insignificant changes in COD, foaming rate, and correlating surfactant concentrations, hence showing no effectiveness. The lack of observed change indicates the surfactant concentration was likely at or above the critical micelle concentration (CMC). A rise in temperature, up to 65° C., was observed, likely due to cavitation, may benefit the biological consortia in SAMBR by potentially increasing hydrogen production and growth yields. The considerable noise generated, and the slight pH increase remain further points of investigation for integration with SAMBR.

Ultrafiltration demonstrated potential in reducing surfactant concentrations, as evidenced by reductions in COD and corresponding surfactant concentrations in the permeate samples. Efficient operation and scale is indicated by the low TMP and flux with minimal membrane strain. However, sustained foaming in the permeate indicates the need for further optimization or additional treatment steps for SAMBR integration. The analysis suggests UF membranes partially reject high molecular weight surfactants, making UF useful for reducing surfactant load before further treatment.

Nanofiltration proved most effective, significantly reducing COD, foaming rate, and surfactant concentrations in the permeate samples. Its ability to reduce surfactant concentrations to levels not sustaining foaming make it most suitable for integration with SAMBR. However, a custom design of the membrane would be necessary to incorporate significant safety factor into the SA to reduce the strain.

TABLE 7
Foaming mitigation technologies performance summary.

| | Ultrasonication | Ultrafiltration | Nanofiltration |
|---|---|---|---|
| Surfactant | Minimal | 32% | 74% |
| removal (as | | | |
| COD) | | | |
| Surfactant | Minimal | 63% | 82% |
| removal (as | | | |
| foaming rate) | | | |
| TMP (bar) | N/A | 0.1 | 0.6 |
| Notes | Power is only input | Minimal strain on | Moderate strain on |
| | Literature indicates | membrane would | membrane. Custom design |
| | only effective when | minimize the need for | is needed to minimize |
| | below surfactant | replacement membranes. | fouling and replacements |
| | CMC | Sustained foaming still | needed. No sustained |
| | | observed despite | foaming observed after |
| | | surfactant removal. | treatment. |

### Example 3. SAMBR Design and Operation

The SAMBR system was designed and operated as a hybrid bioregenerative alternative treatment system for urine, flush, and graywater waste streams generated by the initial crew sent out for long term habitation missions. Starting from initial concept design, SAMBR was scaled to a pilot technology for preliminary testing. The design and fabrication investigated the ability for the treatment system to be created while fitting into the constraints (primarily volumetric) required for ECLSS technology development. Assessment of SAMBR's performance was primarily monitored through water quality testing of samples taken throughout the system. The execution of this major research thrust provided insight into SAMBR's ability to tolerate high strength waste, optimizing treatment, and conversion of contaminants, nutrients, and gain an understanding of the fate of constituents of interest throughout SAMBR.

### 3.1 Materials and Methods

### 3.1.1 Sample Collection

Sample collection was conducted similar to the method described in section. 1.1.1.

### 3.1.2 Sample Preparation and Storage

Sample preparation was conducted similar to the method described in section. 1.1.2.

### 3.1.3 Bioreactor Inoculation

Waste Activated Sludge (WAS) was collected from the South Cross Bayou Advanced Water Reclamation Facility in St. Petersburg, FL. The sludge was sieved to remove any debris and macro-particulates. Based on initial solids analysis the sludge was diluted with water to achieve a solids content of approximately 1%.

The SAMBR reactor was filled with ˜110 L of sludge including added packing media added. At this stage the reactors are inoculated and prepared for operation.

### 3.1.4 Urine Collection

Urine collection was conducted similar to the method described in section. 1.1.7.

### 3.1.5 Chemical Oxygen Demand

COD measurements were conducted similar to the method described in section. 1.1.3.

### 3.1.6 Total-Nitrogen

Total Nitrogen (TN) analyses measured the total concentration of nitrogen species (organic N, ammonia, nitrate, etc.) present in the sample. Soluble TN analyses were conducted in accordance with Hach Method 10072 and utilized Hach HR Total Nitrogen kits. A reactive agent powder pillow of persulfate was added to the vials. A 0.5 mL sample was pipetted into the vial with 0.5 mL of DI water pipetted into a separate digestion vial to serve as a blank calibration. The vials were inverted several times to mix the contents and heated in a COD reactor for 30 minutes at 150° C. After the reaction time, the samples were cooled to room temperature. The contents of a reagent A powder pillow were added to each vial, inverted to mix, and let sit to reactor for three minutes. This process was repeated with a reagent B powder pillow and let react for two minutes. 2 mL of this digested vial was pipetted into a reagent C vial, inverted to mix, and let sit to react for five minutes. Lastly, the vials was wiped clean and concentration measured using a Hach DR/4000U spectrophotometer. Only soluble analyses were conducted as total fractions are a source of interference and would have resulted in unreliable results.

### 3.1.7 Ammonia Nitrogen

AN measurements were conducted similar to the method described in section. 1.1.4.

### 3.1.8 Nitrate Nitrogen

Nitrate analyses measure the total nitrate concentration present in samples. This was conducted in accordance with Hach Method 10020 using Hach Nitraver X High Range test kits. A 1 mL sample was pipetted into the vial and then inverted 10 times to mix. The vial was wiped clean and used to serve as a blank calibration. The contents of a reagent B powder pillow were added to each vial, inverted to mix, and let sit to react for five minutes. Lastly, the vials were wiped clean, and concentration measured using a Hach DR/4000U spectrophotometer.

3.1.9 pH

pH measurements were conducted similar to the method described in section. 3.1.5.

### 3.1.10 Oxidation Reduction Potential

Oxidation Reduction Potential (ORP) analyses were conducted using an electron sensitive probe. Prior to and after analysis, the probes were rinsed thoroughly with DI water and dried. The ORP reading was taken during a 15-20-minute window to allow for stabilization and when little drift was observed. Only single samples conducted for analysis and singular readings taken due to the inherent nature of method for this analysis. Calibration of the probe was checked on a regular basis and recalibrated if necessary. When not in use the probe was stored in an ORP probe storage solution.

### 3.1.11 Dissolved Oxygen

Dissolved oxygen analyses were conducted using an oxygen sensitive probe. Prior to and after analysis, the probes were rinsed thoroughly with DI water and dried. The reading was taken during a 5-10-minute window to allow for stabilization and when little drift was observed. Only single samples conducted for analysis, and singular readings taken due to the inherent nature of this method. The probes used came with a factory calibration and was checked on a regular basis and recalibrated if necessary. When not in use, the probe was stored in a DO probe storage solution.

### 3.1.12 Electrical Conductivity

Electrical conductivity analyses were conducted using an ion sensitive probe. Prior to and after analysis, the probes were rinsed thoroughly with DI water and dried. The ORP reading was taken after a few minutes to allow for stabilization and when little drift was observed. Only single samples conducted for analysis and singular readings taken due to the inherent nature of method for this analysis. The probes used came with a factory calibration and was checked on a regular basis and recalibrated if necessary. When not in use, the probe was stored dry as instructed by the manufacturer.

### 3.1.13 Turbidity

Turbidity analyses were conducted in accordance with Hach Method 8237. A compatible cuvette cell was filled with the sample. The cell was wiped clean and measured turbidity using a Hach 2100Q spectrophotometer. Calibration of the spectrophotometer was checked on a regular basis and recalibrated if necessary. Effluent turbidity was the only sample measured as the rest of the samples were beyond the range of the spectrophotometer.

### 3.1.14 Transmembrane Pressure

Transmembrane pressure measurements were conducted similar to the method described in Example 2 but with the following calibration equations used for the pressure transducers in SAMBR:

$${P}_{feed} = 0.4131 {V}_{feed} - 1.2183 \qquad Equation 3.1$$

$${P}_{concentrate} = 0.4034 {V}_{concentrate} - 1.1903 \qquad Equation 3.2$$

$${P}_{permeate} = 0.4108 {V}_{permeate} - 1.2249 \qquad Equation 3.3$$

### 3.2 Design and Fabrication

### 3.2.1 Process Design

One of the main treatment objectives for SAMBR was to convert and remove the high levels of nitrogen inherently present in urine. A suspended activated sludge system was developed that was informed primarily from MLE and 4-stage Bardenpho processes. FIG. 4B shows the process diagram of SAMBR. The influent (In) was pumped into an initial anoxic zone, termed pre-anoxic (Pr-Ax) where the influent was mixed with a nitrate rich stream from the downstream recirculation. Aeration delivered via fine diffusion stones provided oxygen to create an oxic zone (Ox) and encouraged nitrification of ammonia. The oxic zone was kept to about half the size of the anoxic zones which allowed for the oxygen to expire sufficiently and created a post anoxic zone (Po-Ax) where an IR pump recirculated a portion of the stream at a rate approximately four times the influent flowrate. The IR stream returned nitrate back to the pre-anoxic zone for further denitrification. A high flow pump fed the treated effluent into the UF membrane with the rejected concentrate returned back to SAMBR. A pump connected to the permeate side of the membrane created a pressure differential to drive the filtration process. The permeate was collected into a product column for sampling before exiting as the final effluent. The gases produced were mainly denitrified nitrogen, carbon dioxide, and excess oxygen which off-gassed into the atmosphere. Traditional activated sludge systems have a clarifier for solids removal and retention. The settled solids are removed as Waste Activated Solids (WAS) with a portion recycled back into the system. In a similar fashion, a solids wasting pump was installed near the end of the treatment process for removing accumulated solids, though it was never needed throughout the course of operation.

### 3.2.2 Hardware and Software Design

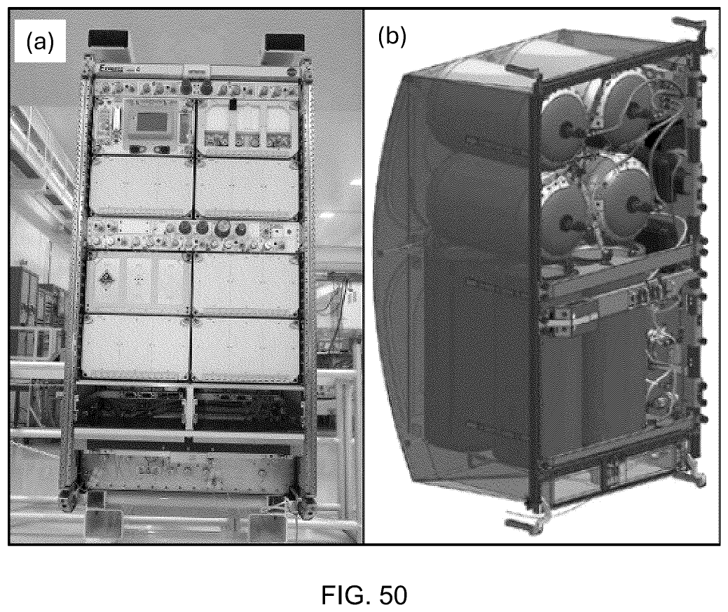

Design challenges primarily stemmed from optimizing reactor geometry for optimal performance and incorporating an automated control and monitoring scheme. SAMBR's design was developed over several iterations to optimize its application and operation in varying space environments, primarily EPB/PGH scenarios. The system's housing was based on NASA's EXPRESS rack and designed to be compact, easily accessible, and modular for easy integration for possible flight demonstration (EXpeddite the PRocessing of Experiments to Space Station (EXPRESS) Rack Payloads Interface Definition Document, 2013). The EXPRESS rack system is the most current and appropriate as no future form factors have been officially announced and, as a NASA standard, any future form factor will likely be derivative of the EXPRESS rack to ease hardware transition. While intricately comprised of many fragments, the active volume of the EXPRESS rack is composed of two shelves and powered drawers each that can be configured with the powered drawers at the bottom like in FIG. 50 or in between each of the system shelves.

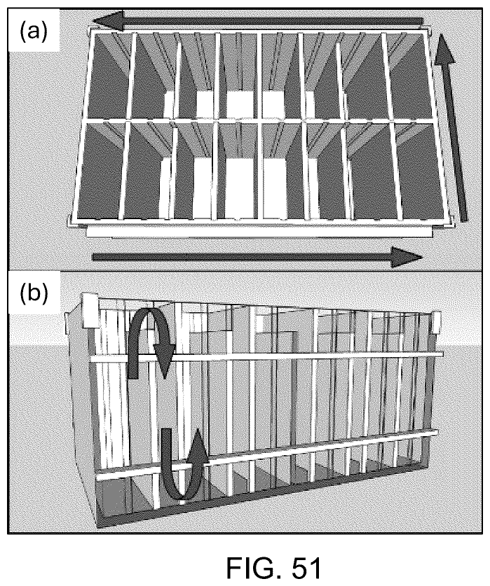

For the allotted volume in an EXPRESS rack, a single rectangular baffled tank was chosen as it was deemed to be the most optimal for utilization of the geometry and volume (FIG. 51). Multiple slots allowed for easy reconfiguration of baffle spacing desired and further contributed to the system's modularity. The total active reactor volume ranged from 100-110 L and was primarily sized on the desired retention time and the urine, flush, and graywater waste streams generated by a crew of four, an estimated 38 L/d (Muirhead et al., 2022b).

Liquid level sensors maintained a proper volume and overflow sensors in each quadrant paused the system when the liquid level became too high. Additional pumps were installed in a short loop to provide sampling and monitoring points of each zone in the system. An aeration pump was operated at approximately 10 LPM and ran to diffusion stones in the oxic zone. The membrane module consisted of multiple tubular (5.2 mm diameter), ultrafiltration, polyvinylidene fluoride (PVDF) membranes from Pentair with an average pore size of 0.03 μm and an approximate active surface area of 0.31 m². Clear PVC piping and fittings were used to construct the housing for the membranes. This clear PVC provided direct observation of the membrane and allowed the membrane to be monitored for any biofilm growth or anomalous changes.

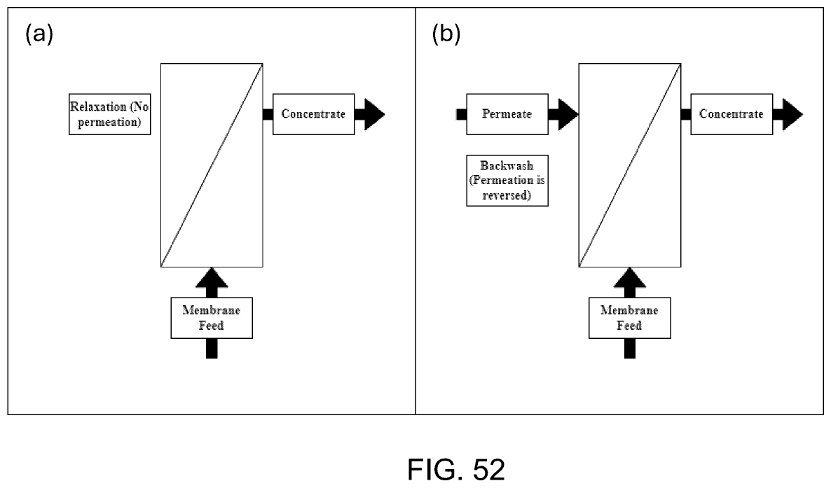

To mitigate fouling of the membrane, it was subjected to physical relaxation and backwashing at regular intervals during operation. For relaxation the permeate pump was temporarily paused. During this time, the membrane feed continued to cycle through the membrane. The high-flow membrane feed pump created a strong cross flow velocity that extricated foulants caked onto the membrane. For backwashing, the permeate pump was reversed, which consequently reversed the flow through the membrane. The flow reversal ejects many of the particulates clogging the pores and restores active membrane surface area. These methods were run for three minutes for relaxation and for 15 seconds for backwashing after 15 minutes of operation. FIG. 52 shows how the membrane was operated during these events.

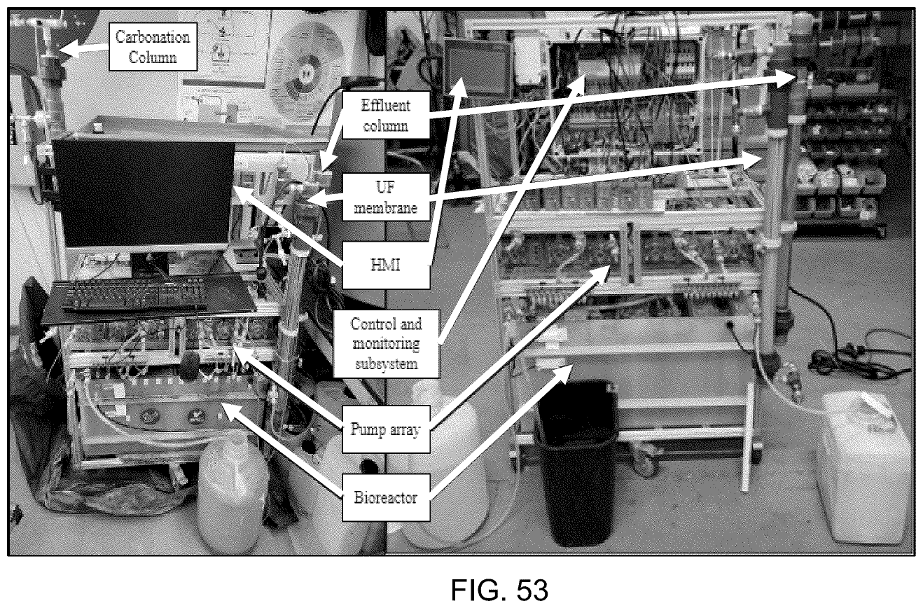

The ending result was a dynamic system that is easily modified to become compatible with the future ECLSS requirements (FIG. 53). As technology advances, the system can be easily modified and expanded upon to evolve its capabilities. Adaptation and safety were cornerstones that guided the approach when SAMBR was fabricated as the projected criteria currently used will inevitably vary as future missions evolve. A robust control and monitoring system ensured that nominal operational parameters were maintained and enacted several safeguards whenever anomalies arose to prioritize crew health and safety in long term habitation missions.

### 3.3 Experimental Plan

As previously stated, the core objective of SAMBR was to convert and remove the high levels of nitrogen found in urine. With an estimated urine and flush generation of 2 and 0.3 kg/CM-day respectively, the estimated nominal hydraulic loading for four crewmembers is 9.2 L/d (assuming ˜1 kg/L density) (Muirhead et al., 2022a). However, to have immediately begun operating SAMBR with the high-nitrogen waste would have possibly resulted in complications stemming from Free Ammonia (FA) and Free Nitrous Acid (FNA) inhibition. If such inhibition had occurred early on, it might have resulted in perceived failure before SAMBR was fully evaluated. AOB and NOB, some of the primary treatment consortia of SAMBR, can be inhibited by FA at concentrations as low as 8 and 0.08 mg-N/L respectively (Pourbavarsad et al., 2022). For FNA, AOB and NOB can suffer inhibition at concentrations as low as 0.2 and 0.06 mg-N/L respectively (Pourbavarsad et al., 2022). However, there is a lack of study into the maximum tolerance of FA and FNA and at nitrogen levels exceeding 1000 mg-N/L and for scenarios such as source separated urine (Pourbavarsad et al., 2022). Due to this knowledge gap, a phased approach, summarized in Table 8, was favored to allow for the consortia to acclimate increasing levels of nitrogen. The beginning of this approach verified the fundamental principles that were used to develop SAMBR, including design, operation, and treatment. As operation progressed through each stage, the biological consortia in SAMBR was challenged to tolerate increasing strengths of urine until full-strength urine and flush was achieved. Initially, a synthetic waste of ammonium bicarbonate (stage A-1) and acetate (stage A-2) was introduced at levels similar to that of domestic wastewater. These stages validated the performance and operation of the oxic zone and nitrification process. During the initial stages, the IR was not active, and samples of the anoxic zones were collected. Implementing the IR and engaging the anoxic zones followed in stage B and similarly validated the anoxic zones and denitrification process. Stage B was followed by replacing the synthetic influent with real urine and flush at increasing strengths of real urine until full strength was reached (stages C to H-2). The known potential for inhibition from high levels of nitrogen and resulting high pH led to the creation of testing full strength urine with AcOH dosing (H-1) and carbonation (H-2) that assessed the capability of these conditioning processes to aid in creating more ideal conditions for the biological consortia.

[symbol]

BR operation schedule.

| | Preliminary | Evaluation | | Experimental | | | | | |
|---|---|---|---|---|---|---|---|---|---|
| | A-1 | A-2 | B | C | D | E | F | G | H [symbol] |
| [symbol] pe | Synthetic: | Synthetic: | | Urine (actual) and flush | | | | | Ur [symbol] |
| | ammonium | ammonium | | | | | | | (a [symbol] |
| | bicarbonate | bicarbonate + | | | | | | | do [symbol] |
| | | carbon source | | | | | | | wi [symbol] |
| | | (acetate) | | | | | | | A [symbol] |
| | | | | | | | | | an [symbol] |
| [symbol] g-N/L) | 46 | 46 | 46 | 46 | 450 | 1700 | 3500 | 5000 | 70 [symbol] |
| [symbol] D (mg/L) | 0 | 70 | 70 | 70 | 693 | 2617 | 5388 | 7697 | 11 [symbol] |
| | 0 | 0.65 | 0.65 | 0.65 | 0.65 | 0.65 | 0.65 | 0.65 | 0. [symbol] |
| [symbol] /d) | 0.4 | 0.4 | 0.4 | 0.4 | 4 | 16 | 32 | 46 | 65 [symbol] |
| [symbol] g (g/d) | 0 | 1 | 1 | 1 | 6 | 24 | 50 | 71 | 10 [symbol] |
| [symbol] action of urine | 1% | 1% | 1% | 1% | 6% | 24% | 50% | 71% | 10 [symbol] |
| [symbol] as % of total | | | | | | | | | |
| | 9.2 | 9.2 | 9.2 | 9.2 | 9.2 | 19.2 | 9.2 | 9.2 | 9. [symbol] |
| | 12 | 12 | 12 | 12 | 12 | 12 | 12 | 12 | 12 [symbol] |
| [symbol] rculation (IR) | OFF | OFF | ON | ON | ON | ON | ON | ON | O [symbol] |
| [symbol] stage(d) | 14 | 14 | 14 | 28 | 28 | 28 | 42 | 101 | 62 [symbol] |

[symbol]

indicates data missing or illegible when filed

### 3.4 Results, Discussion, and Critical Analysis

Throughout the course of the long-term operation of SAMBR, several events occurred that are worth noting.

TMP was automatically recorded continuously, and the data extracted from the logging system. However, upon startup an IT error occurred that resulted in a lack of recorded data for TMP until late into stage C.

A few days into operation of stage G and the corresponding increase in urine strength, it was discovered that much of plumbing that delivered air to the diffusion stones in the oxic zone had disconnected from the air stones. Without the connection, air was delivered in much larger bubbles with less surface area. The plumbing was addressed partway into stage G and proper aeration was reestablished.

A 152-day stand-by operation was enacted between stages H-1 and H-2. During this period, the system was maintained but not fed influent or produced permeate through the UF membrane. Aeration was continuously provided to the oxic zone during this time in the same manner during active operation. This event provided a unique opportunity to assess SAMBR's ability to maintain an active consortia without a constant influx of substrate as might be necessary for space travel.

### 3.4.1 Chemical Oxygen Demand

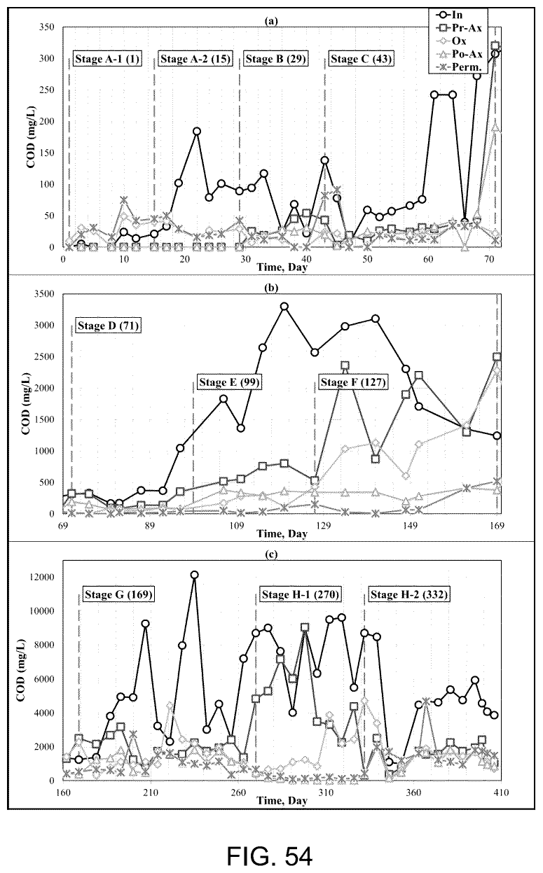

The COD analysis (FIG. 54) across the operational stages displays SAMBR's ability to effectively remove organics present despite variations in the feed waste. A progressive reduction of COD was observed through each zone and across all stages of testing. The initial stage of A-1 did not include any added COD resulting in only already present organics in the initial inoculum to be captured in the analysis. The lack of initial added COD allowed for a baseline value of present organics to be established and consequently allow for wash out of any remnant artifacts from the inoculum. Additionally, as the consortia was initially only provided nitrogen (as ammonium bicarbonate), this encouraged nitrification as nitrogen would need to be used as the electron donor in place of organic carbon. In each of the subsequent stages there is an increase in COD resulting from the increased strength of the feed, with the exception of stage H-2 which on average is lower than the H-2. The donated urine was stored in containers and allowed to hydrolyze so that the nitrogen would already be present as ammonia when fed into the system for nitrification (Liu et al., 2008). As the storage containers were reused, a variety of hydrolyzed urine blends was created and in turn created some biological activity as biofilms were observed in the containers during the later stages of testing. The inadvertent development of this biological activity is attributed to the large variation of COD in the influent and decreased presence of COD in H-2 relative to the prior stages. Despite the large variations in the feed, including in the same stages, SAMBR consistently reduced COD with removal ranging from 29% to 73% with an average removal of 75%. Even when challenged by the stand-by operation and high-strength stages, COD removal occurs across all treatment zones, indicating an active and robust consortium is present.

### 3.4.2 Nitrogen

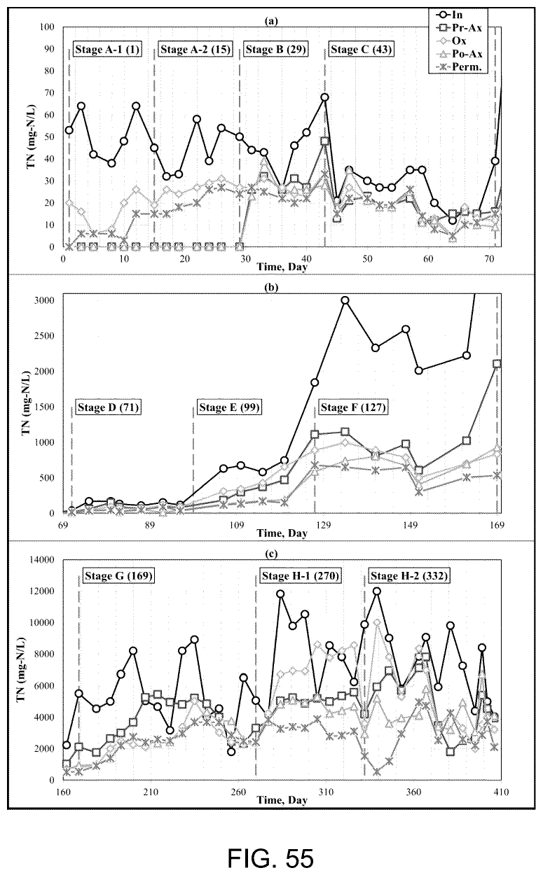

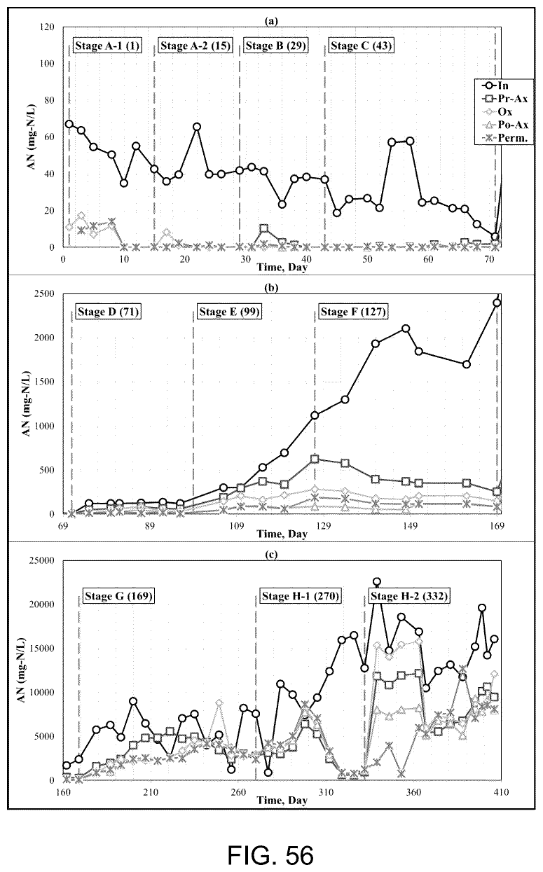

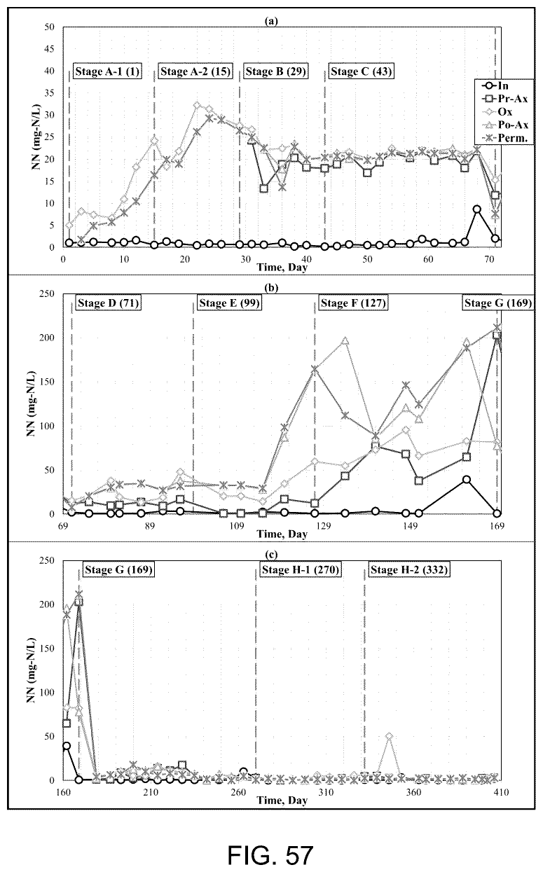

TN measurements captured the presence of ammonia, nitrate, nitrite, and organic nitrogen components. As the urine in the influent was allowed to hydrolyze for considerable durations, much of the urea had been converted to ammonia. Though not explicitly discussed, nitrite was infrequently measured to check for accumulation but was always found to be at non-detectable levels. The remaining species, ammonia and nitrate, are believed to be the two predominant present throughout the system and is largely supported by comparing TN levels (FIG. 55) to the combined levels of AN (FIG. 56) and NN (FIG. 57). In most instances the AN and NN comprised a majority of the TN, leaving a relatively small fraction remaining to be unconverted organic nitrogen and even lesser nitrite. However, in the later stages of H-1 and H-2 the AN concentration is greater than the TN by several thousand mg-N/L on multiple occasions, an obvious impossibility. The reason for the observed anomaly is believed to be attributed to method interference. The method states that a large presence of nitrogen-free organic constituents can interfere with the accuracy of the method but does not specify a quantitative concentration at which interference begins or to what extent. The nature of this interference with the method would explain why this phenomenon was not observed in the earlier stages when nitrogen-free organic compounds were less concentrated. The AN of the influent reached the maximum observed concentration of 22,610 mg-N/L. The highest nitrogen concentration in urine was reported to be almost 14,000 mg-N/L during a review of literature. As the urine-based influent for SAMBR is slightly diluted to represent flush water, a value ˜60% higher than the known literature is unexpected. Excess CO₂ and stripped gasses from the carbonation column were routed to the feed tank to provide additional, upstream conditioning and maximize utilization of the CO₂. A possible inadvertent effect was increased liquid evaporation which would result in concentration of the constituents in urine.

Similarly to the COD profile, a progressive reduction of TN was observed through each zone and across all stages of testing. The initial stages show an initial washout of legacy nitrogen present in the inoculum followed by utilization of the incoming nitrogen. The reduction of TN and AN combined with increasing NN concentrations verified the occurrence of nitrification and denitrification in the oxic and anoxic zones as designed. The switch to urine did not appear to have a significant impact as the occurrence of nitrification and denitrification continued to be evident and continued with increasing urine strength up to 50% in stage F. Up to stage F, conversion of ammonia ranged from 85% to 99% with an average of 93%. Removal of TN ranged from 40% to 86% with an average of 64%.

The discovery and observed effect of the disconnected aeration plumbing coincides with the transition to stage G by a matter of days. The coincidence of these two events make it difficult to parse out the source of the observed effects in stage G. NN concentration rapidly decreased to single digit concentrations, indicating minimal nitrification activity. Once the aeration plumbing was restored, the system was operated nominally for the rest of stage G to see if nominal nitrification activity could be reestablished. During stage H-2, additional inoculum was added to the oxic zone to aid in reinvigorating nitrification and is marked by the spike in nitrate. The recovery strategy only temporarily increased nitrification followed by a return to minimal activity.

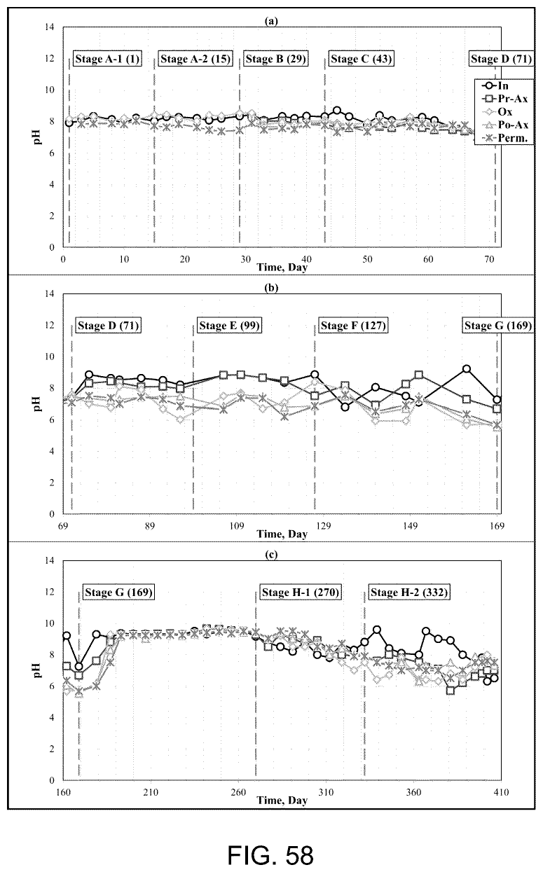

Though nitrification activity did not return to optimal levels, the trend of nitrogen reduction continued into the later stages. Considering the low presence of nitrate, not all of the subsequent disappearance of the nitrogen could be attributed to biological treatment. The universal pH rise (FIG. 58) in SAMBR that started in stage G led to a shift in the ammonia-nitrogen species. With a pKa of ˜9.25 for the ammonium/ammonia species and the system pH reaching as high as 9.6 (FIG. 58), a majority of the AN species was now present as ammonia, NH₄, instead of ammonium, NH₃⁺. The shift in ammonium/ammonia gave the ammonia an increased propensity to volatilize out of solution. The volatilization is believed to have contributed to the removal of nitrogen without the corresponding increase in NN, associated with nitrification, observed in these late stages.

Despite the minimalistic presence of nitrification, biological treatment is still evident by the continued reduction of COD. Regardless of the variations of biological treatment the membrane provides an absolute barrier and constant treatment, retaining biomass and rejecting particulate constituents.

3.4.3 pH

The pH remained relatively constant in the initial stages, varying from 7.5-8.3 for stages A-1 to C, a nominal range for activated sludge (Baldwin & Campbell, 2001). When nitrification was strongly active, the pH in the oxic zone and those downstream of it became more neutral and even mildly acidic in some instances, reaching a pH as low as 5.5. As hydrogen ions are released during the nitrification process, a decrease can be observed as was in these stages of SAMBR. The continued release of hydrogen ions likely led to the observed deviation where In and Pr-Ax remained neutral to mildly basic while Ox, Po-Ax, and Perm. trended down. The coinciding transition to stage G and aeration event resulted in rise in pH of the system to approximately 9.5. The pH management strategies implemented in stages H-1 and H-2 proved to be effective, gradually returning the pH to a more neutral level and creating a more ideal environment for the consortia.

### 3.4.4 Oxidation Reduction Potential

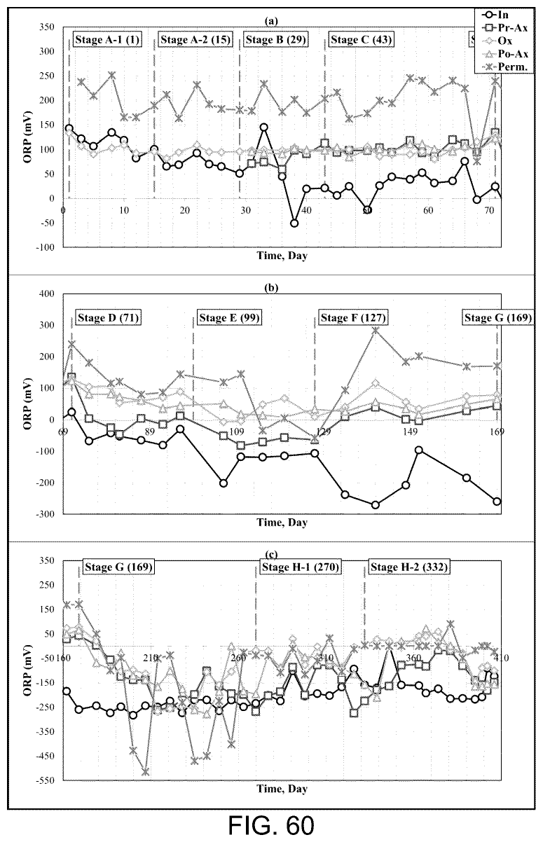

ORP measurements gave an indication of how oxidative or reductive the zones in SAMBR were. For the oxidation of ammonia to nitrate (nitrification), a positive measurement is expected while the reduction of nitrate to nitrogen (denitrification) should result in a negative measurement. The expected measurements for the oxic conditions were generally what was observed in the initial stages (FIG. 60) with consistently positive ORP measurements. The anoxic zones were weakly positive due to the events described in section 5.4.4. The ORP of the permeate was consistently the highest, due to the retention of reducing constituents by the membrane.

In the later stages the anoxic zones became more established as reducing environments but were later joined by the oxic zone and permeate as the feed strength increased and the aeration event in stage G. The aeration restoration and pH management strategies had a positive effect on the oxic zone and permeate, returning them to neutrally positive ranges.

### 3.4.5 Dissolved Oxygen

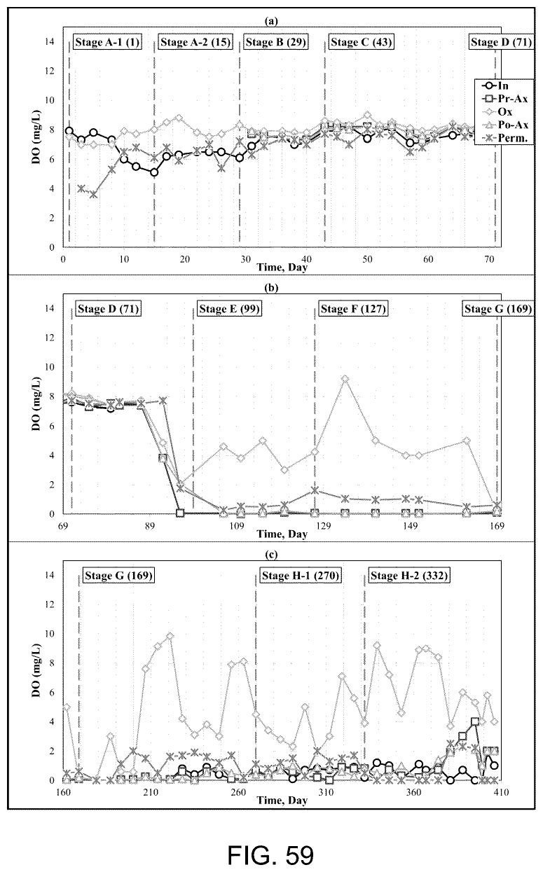

High levels of DO (FIG. 59) were present across the entire system at initiation, nearing saturation (assuming STP for water). Between collection and inoculation, the inoculum was stored and aerated in carboys, creating the initially high DO. The air pump continuously provided aeration at 10 LPM, maintaining the high DO. As nitrification can occur at DO levels less than 1 mg/L (Stenstrom & Poduska, 1980), the aeration was systemically adjusted until optimal aeration was achieved such that the moderate levels were only measured in the oxic zone. Optimizing air delivery reduced excessive aeration and power consumption. The aeration was modified by adjusting the valves of air manifold, downstream of the air pump, which connected to each diffusion stone. The breakthrough was achieved in stage D and delivered enough oxygen to maintain aerobic conditions but significantly expired by the time it reached the anoxic zones.

Despite the high levels of DO measured in the anoxic zones during the initial stages, nitrogen removal was consistently observed, indicating denitrification was still occurring. Though the measured DO was high, it is unlikely to be uniform with depth. Without the turbulent aeration provided in the oxic zone, the consortia stratified and was predominantly present near the bottom where DO level were lower. This stratification allowed them to carry out denitrification in the apparent presence of higher DO levels.

### 3.4.6 Electrical Conductivity

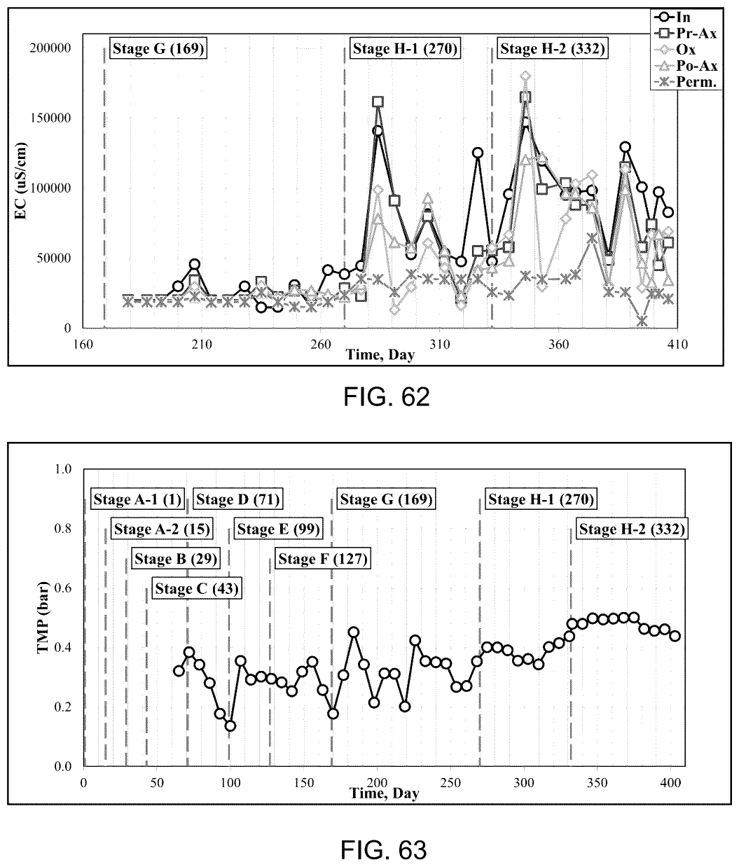

EC measurements were incorporated into the late stages, G, H-1 and H-2, following the events of stage G. The EC values measured gave an indication of the salinity, total dissolved solids (TDS), and ultimately the system's ionic strength. Stage G displayed a mostly consistent EC around 22,000 uS/cm but increased with the transition to full-strength urine in stages H-1 and H-2. The observed increase was accompanied with increased variability as the EC ranged from 51,000 to 180,000 uS/cm. The EC profile over time is shown in FIG. 62.

### 3.4.7 Turbidity

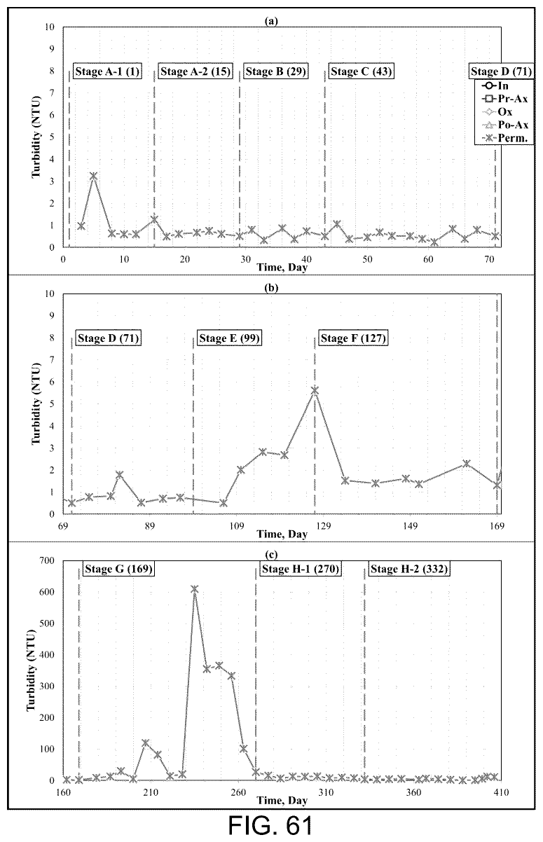

The turbidity, an indicative measure of clarity, of the permeate was almost consistently single digits and averaged out to below NTU in most instances as can be seen in FIG. 61. The membrane proved to be effective as an absolute barrier to particulate retention. The switch and subsequent increased strength of urine introduced a slight increase in value and variability but was still maintained to single digit values. The sharp increase in turbidity observed in stage G could be attributed to the formation of precipitants such as struvite and species of phosphates. Though the UF membrane rejects particulate constituents, the ions that comprise such precipitants pass through and have the capacity to precipitate post-filtration. As the pH recovered in stages H-1 and H-2, turbidity returned to previously nominal levels just as quickly. Though not reported, the turbidity of the influent was attempted to be measured on several occasions, however at each occurrence it measured beyond the range of the meter (>10000 NTU). The production of measurable turbidity from the membrane is a significant improvement.

### 3.4.8 Transmembrane Pressure

TMP ranged from 0.27 to 0.48 bar, averaging out to 0.33 bar. Far below the manufacturer listed max of 2.4 bar, the membrane separated the treated effluent from the reactor contents without overloading the membrane as can be observed in FIG. 63. Given that the membrane was designed to be with safety factor to allow for shock loading and gradual fouling, the TMP was expected to be low. The data logging system was initially set to record data at intervals on the scale of seconds. However, the interval captured a lot of dynamic noise from the relaxation and backwashing events. The sampling interval widened, capturing and averaging wider sets of measurements, resulting in variation for stages H-1 and H-2.

### 3.4.9 Critical Analysis

SAMBR displayed considerable success when it was challenged to treat a urine dominated, high-strength influent, with Table 9 summarizing the treatment and performance through each stage. SAMBR was capable of COD fed into the system at all stages of testing, averaging 93% removal at full strength (FIG. 54). Prior to the events of stage G, a large fraction of the ammonia was nitrified with an average conversion of 91% (FIG. 56). Given that the pH (FIG. 58) was consistently below the 9.25 pKa of the ammonium/ammonia equilibrium, there is presumed to be minimal ammonia volatilization. Evidence of nitrification occurring was further supported by increasing levels of nitrate in the system, as high as ˜250 mg-N/L were observed (FIG. 57). A majority of the nitrogen present in the effluent was predominantly nitrate, further supporting that minimal ammonia escapes untreated. TN measurements (FIG. 55) support evidence of N removal via denitrification with an average TN removal of 76%.

Following the integration of influent conditioning for full-strength urine, pH returned to acceptable levels. Decreases in total nitrogen and ammonia was still observed but due to the minimal nitrate levels, it is unclear to what degree of removal is attributed to treatment, volatilization, and other such losses. The coinciding events of transitioning to stage G and temporary aeration loss make it difficult to dissect the causality of the cascading effects.

The temporary lack of aeration could have shifted the oxic zone to anoxic conditions from which the nitrifying consortia was unable to re-dominate. The increase in ammonia likely contributed to the resulting increase in pH high pH (>9), and jointly exceeded the tolerance threshold of the consortia, resulting in significant inhibition. If the mitigation of nitrification was solely due to nitrogen inhibition, the highest N concentration the consortia was able to tolerate was ˜3000 mg-N/L, significantly above known tolerance studies of the past.

The work of TTU was identified to have the most compatible research for comparison. TTU has conducted multiple studies regarding biological treatment systems, primarily based on MABR technology, for space applications. Some of the studies cover operation and evaluation of their systems over multiple years, proving to be well established. Table 10 summarizes the comparisons of TTU's NDX (Jalalieh et al., 2021) and UMABR (Hooshyari et al., 2023; Jackson et al., 2022) systems against SAMBR during stage F and H-2.

The NDX system treated a wide variety of waste streams beyond just urine and flush, with no requirement for pH management. The lack of recycle flow(s), single stage treatment, and minimal aeration requirement make NDX's operation relatively simple and energy efficient. However, it's small scale (sized for <1 CM), volumetric inefficiency, and comparatively lower N conversion to previous studies identify areas for future optimization.

Like SAMBR, the UMABR was primarily designed for urine treatment and also used real human urine in its evaluation. Taking the urine directly into the MABR eliminates intermediate storage tanks, reducing mass and volume considerations. Membrane delivery of air to the biofilm ensures efficient aeration and optimal energy consumption. The main goal of the UMABR was organic removal and nitrogen conversion, which then was sent to a distillation vessel in order to achieve any kind of nitrogen removal. The coupled distillation unit experienced nitrogen carry over and decomposition of HNO₂ leading to the addition of an acid trap between the two systems to mitigate this. The lifespan of the acid trap has not been evaluated. Brine and solids produced during distillation are stored in the vessel as they accumulate.

The preliminary evaluation of SAMBR was focused to just urine+flush and has not yet incorporated other waste streams into its treatment scope. SAMBR's aeration and filtration operations comprise a majority of its energy consumption and have not yet been optimized. Though the projected life of the membrane is estimated to last multiple years (based on the experimental TMP data), it is one of the few consumables in the system. Due to the inevitable fouling spares and replacements would eventually be required. However, the membrane provides several advantages including retaining and concentrating biomass, decoupling SRT and HRT, and is typically a more compact system.

In terms of performance SAMBR, during stage F, had similar organic removal as both the NDX and UMABR systems but less so during stage H-2 due to aforementioned events. The DOC and COD measurements are strongly correlated and are both commonly used as measurements of available organic substrate, but a direct comparison would require testing both metrics in all three systems to develop a custom correlation. SAMBR, during stage F, outcompeted both systems in terms of nitrogen treatment, achieving significantly higher conversion and removal. Further evaluation would be needed for a confident comparison of nitrogen treatment between these systems and SAMBR during stage H-2 because, as stated before, it is unclear what degree the change in nitrogen is attributed to treatment due to minimal nitrate concentrations to support the presence nitrification occurring.

SAMBR's conversion and removal of nitrogen coupled with substantial organic removal when challenged with high-strength waste even in comparison to literature highlight its robust ability to handle stress. With a compact footprint and minimal consumables, SAMBR can be easily configured to meet the mass and volume restrictions of space travel. Though further evaluation is necessary to primarily optimize energy consumption and nitrogen tolerance, SAMBR has proven to be a competitive technology for sustainable treatment of waste streams during long-habitation missions.

TABLE 9
SAMBR influent/effluent water quality averages.

| | | In. | Eff. | In. | Eff. | In. | Eff. | In. | Eff. | Eff. | | | |
|---|---|---|---|---|---|---|---|---|---|---|---|---|---|
| Day, | | COD | | TN | | AN | | NN | | Turb. | In. | Eff. | TMP |
| Operation | Stage | (mg/L) | | (mg-N/L) | | (mg-N/L) | | (mg-N/L) | | (NTU) | pH | | (bar) |
| 1 | A-1 | 7 | 37 | 52 | 7 | 54 | 7 | 1 | 6 | 1.2 | 8.1 | 7.9 | N/A |
| 15 | A-2 | 87 | 30 | 44 | 20 | 44 | 1 | 1 | 23 | 0.7 | 8.2 | 7.6 | |
| 29 | B | 69 | 15 | 44 | 23 | 38 | ND | 1 | 22 | 0.6 | 8.3 | 7.6 | |
| 43 | C | 110 | 29 | 28 | 17 | 29 | ND | 1 | 21 | 0.6 | 8.0 | 7.6 | 0.31 |
| 71 | D | 393 | 15 | 128 | 42 | 107 | 12 | 2 | 26 | 0.8 | 8.4 | 7.2 | 0.28 |
| 99 | E | 2283 | 47 | 658 | 143 | 456 | 67 | 1 | 48 | 2.0 | 8.7 | 6.9 | 0.27 |
| 127 | F | 2335 | 119 | 2334 | 563 | 1664 | 136 | 8 | 137 | 2.3 | 7.9 | 6.9 | 0.29 |
| 169 | G | 4881 | 986 | 5489 | 2470 | 5370 | 2445 | 1 | 21 | 146.8 | 9.2 | 8.7 | 0.31 |
| 270 | H-1 | 7691 | 222 | 7667 | 3205 | 10084 | 4032 | ND | 1 | 12.4 | 8.5 | 8.9 | 0.38 |
| 332 | H-2 | 4813 | 1668 | 7864 | 2841 | 15200 | 5916 | 1 | 2 | 4.3 | 8.3 | 7.3 | 0.48 |

*Influent value exceeded measurable range (>1000 NTU). Only effluent value is shown.

TABLE 10
Comparison of SAMBR to similar technologies.

| | NDX (Jalalieh et al., | UMABR (Hooshyari et al., | | SAMBR Stage |
|---|---|---|---|---|
| Name | 2021) | 2023; Jackson et al., 2022) | SAMBR Stage F | H-2 |
| Base | Biological system | MABR | MBR | MBR |
| Technology | (unspecified) | | | |
| Primary | N conversion N removal | N conversion Org. C | N conversion N removal | N conversion N |
| Function(s) | Org. C removal | removal | Org. C removal | removal Org. C |
| | | | | removal |
| Biological | Nitrification | Nitrification | Nitrification | Nitrification |
| Mechanisms | Denitrification Anammox | | Denitrification | Denitrification |
| Design Scenario | EPB/PGH | EPB/PGH | EPB/PGH | EPB/PGH |
| Crew size | <1 | 2 | 4 | 4 |
| Active | 42 | 114 | 100-110 | 100-110 |
| Treatment | | | | |
| Volume (L) | | | | |
| HRT (d) | 21-53 | 25 | 11 | 11 |
| Influent Medium | Urine + Flush + | Urine + Flush | Urine (50%) + Flush | Urine + Flush |
| | Humidity Condensate + | | | |
| | Hygiene + Laundry | | | |
| pH Management | No | Yes | No | Yes |
| Influent N | 590-740 | 6000-7000* | 1,120-3,000 | 10,480-22,610 |
| (mg-N/L) | | | | |
| N conversion | 60-72% | 50% | 83-95% | 40-96%** |
| | | | (Avg: 91%) | |
| N removal | 49-66% | N/A | 63-85% | 25-96%** |
| | | | (Avg: 76%) | |
| Org. C removal | 93% (DOC) | 90% (DOC) | 70-99% (COD) | 60-95% (COD) |
| | | | (Avg: 93%) | (Avg: 72%) |

| | | | |
|---|---|---|---|
| Advantages | High SRT | No intermediate | Compact and |
| | Efficient aeration | storage | volumetrically |
| | No recycle flows | Efficient aeration | efficient |
| | Single stage system | Supported by prior | Absolute |
| | | long-term studies | retention of |
| | | | suspended solids |
| | | | and pathogens |
| | | | Decouple SRT and |
| | | | HRT |
| | | | Process and |
| | | | control are |
| | | | easily |
| | | | modified |
| | | | Resistant to shock |
| | | | loading |
| Limitations | Volumetrically | Coupled with static | Aeration and |
| | inefficient | distillation to | filtration |
| | Small scale | achieve N and ion | operations need to |
| | Lower N | removal | be optimized to |
| | conversion | Phosphoric acid | minimize energy |
| | compared to | trap needed prevent | consumption |
| | prior studies | N carryover and | Membrane fouling |
| | | HNO₂ | Max tolerance to N |
| | | decomposition | inhibition needs |
| | | N trapped in acid is | further investigation |
| | | wasted | |
| | | Brine/solids | |
| | | accumulate/ | |
| | | stored in | |
| | | distillation | |
| | | unit | |

*Range estimated from figure in publication as numerical data was not provided.
**Includes possible volatilization

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system comprising:
a bioreactor configured to receive a waste stream; and
a membrane filter fluidly coupled to the bioreactor,
wherein the bioreactor comprises at least one anoxic treatment zone and at least one oxic treatment zone,
wherein the membrane filter is downstream of the at least one anoxic treatment zone and the at least one oxic treatment zone.

2. The system of claim 1 further comprising a carbonation unit fluidly coupled to the bioreactor upstream of the at least one anoxic treatment zone and the at least one oxic treatment zone,
wherein the carbonation unit comprises a source of CO₂ and a column where a stream of CO₂ from the source of CO₂ mixes with the waste stream before the waste stream enters the bioreactor.

3. The system of claim 2, wherein the carbonation unit is configured to adjust a pH of the waste stream to less than 8 before entering the bioreactor.

4. The system of claim 2, wherein the carbonation unit is further configured to remove carbon dioxide from a biogas using urine.

5. The system of claim 1, wherein the at least one anoxic treatment zone and the at least one oxic treatment zone comprise microorganisms.

6. The system of claim 1, wherein the at least one oxic treatment zone comprises ammonia oxidizing bacteria and nitrite oxidizing bacteria.

7. The system of claim 1, wherein the at least one anoxic treatment zone comprises bacteria expressing nitrate reductase, nitrite reductase, nitric oxide reductase, and nitrous oxide reductase.

8. The system of claim 1, wherein the at least one anoxic treatment zone and the at least one oxic treatment zone includes a first anoxic treatment zone, an oxic zone, and a second anoxic treatment zone.

9. The system of claim 8, further comprising an internal return line, wherein the internal return line fluidly couples the first anoxic treatment zone with the second anoxic treatment zone.

10. (canceled)

11. (canceled)

12. (canceled)

13. (canceled)

14. The system of claim 1, further comprising a treatment unit coupled to the bioreactor upstream of the at least one anoxic treatment zone and the at least one oxic treatment zone, wherein the treatment unit comprises a filtration unit, a sonication unit, or a combination thereof.

15. The system of claim 2, further comprising a treatment unit coupled to the bioreactor upstream of the at least one anoxic treatment zone and the at least one oxic treatment zone, wherein the treatment unit comprises a filtration unit, a sonication unit, or a combination thereof.

16. The system of claim 15, wherein the filtration unit is configured to perform microfiltration, ultrafiltration, nanofiltration, or a combination thereof.

17. The system of claim 15, wherein the filtration unit is configured to remove more than 20% of a surfactant in the waste stream.

18. A method of waste processing comprising:
flowing a waste stream through a bioreactor comprising at least one anoxic treatment zone and at least one oxic treatment zone, wherein the at least one anoxic treatment zone and the at least one oxic treatment zone comprise microorganisms; and
flowing the waste stream from an outlet of the bioreactor through a membrane filter.

19. The method of waste processing of claim 18, wherein the waste stream comprises a first waste stream and a second waste stream, and wherein the method further comprises pretreating the first waste stream by carbonation before the first waste stream enters the bioreactor, wherein the first waste stream is carbonated by mixing with CO₂.

20. The method of waste processing of claim 19, further comprising removing carbon dioxide from a biogas using urine from the first waste stream.

21. (canceled)

22. (canceled)

23. The method of waste processing of claim 19, further comprising returning a concentrate from the membrane filter back to the bioreactor.

24. The method of waste processing of claim 19, further comprising flowing the first waste stream through a buffer zone in the bioreactor prior to the at least one anoxic treatment zone.

25. (canceled)

26. The method of waste processing of claim 18, wherein the waste stream comprises a first waste stream and a second waste stream, and wherein the method further comprises conditioning the second waste stream by flowing the waste stream through a treatment unit before the second waste stream enters the bioreactor, and wherein the treatment unit comprises a filtration unit, a sonication unit, or a combination thereof.

27. (canceled)

28. (canceled)

29. (canceled)

30. A method of waste processing comprising:
flowing a waste stream through a carbonation unit that mixes the waste stream with carbon dioxide;
flowing the waste stream from the carbonation unit through a first anoxic treatment zone in a bioreactor;
flowing the waste stream from the first anoxic treatment zone through an oxic treatment zone in the bioreactor;
flowing the waste stream from the oxic treatment zone through a second anoxic treatment zone in the bioreactor; and
flowing the waste stream from the second anoxic treatment zone through a membrane filter.

31. (canceled)
